(19) United States
(12) Patent Application Publication
(10) Pub. No.: US 2026/0281813 A1
(43) Pub. Date: Sep. 17, 2026

(54) SYSTEM AND METHOD FOR ESTABLISHING A USER CONTROLLED AND MANAGED SERVICE INSIDE A HOSTING NETWORK

(71) Applicant: Huawei Technologies Co, Ltd., Shenzhen (CN)

(72) Inventors: Nimal Gamini Senarath, Ottawa (CA); Remziye Irem Bor Yaliniz, Ottawa (CA); Mohamed Faraj Moftah Alzenad, Ottawa (CA)

(21) Appl. No.: 19/651,357

(22) Filed: Apr. 17, 2026

Related U.S. Application Data
(63) Continuation of application No. PCT/CN2024/098965, filed on Jun. 13, 2024.
(60) Provisional application No. 63/591,230, filed on Oct. 18, 2023.

(51) Int. Cl. H04W 28/084; H04W 8/18

(52) U.S. Cl. CPC H04W 28/084; H04W 8/18

(57) ABSTRACT

Embodiments of the present application relate to a system and a method for establishment of a user controlled and management (UCM) service inside a network using a digital representative of a user (D-User). An example method includes receiving a request for establishing a UCM service, the request including a UCM service type. The method also includes establishing the UCM service according to the UCM service type, and informing a User Equipment (UE) of the user that the UCM service is established and that communication sessions related to the UCM service can be initiated.

### CROSS-REFERENCE TO RELATED APPLICATIONS

This application is a continuation of International Patent Application No. PCT/CN2024/098965, filed on Jun. 13, 2024, which claims the benefits of U.S. Provisional Application No. 63/591,230, filed on Oct. 18, 2023, the disclosures of which are hereby incorporated by reference in their entireties.

### TECHNICAL FIELD

The present disclosure pertains to a field of data communications and in particular to a method, an apparatus, and a system to instantiate, maintain and provide user-controlled and managed services to digital representatives of entities, such as users, in a digital world.

### BACKGROUND

Public land mobile networks (PLMNs) are designed to provide connectivity services to users or other types of entities and their User Equipment (UEs). The concept of user centric networks (UCNs) improves user network experience by dynamically adapting a network structure to individual user contexts.

Future networks may become more and more ‘user-centric’ as users or other types of entities require or demand more ownership and control over their services and their privacy, i.e., these future networks are expected to provide increased user empowerment. UCNs may be designed in a way for entities to have more control over services provided by a network or more control over the network providing these services to these entities.

Future networks must also be able to support new network infrastructure capabilities, suitable for cloud computing applications that are being deployed on a large scale. Future networks should be able to support the use of large-scale artificial intelligence (AI) models, data anonymization, blockchain technologies, etc., which have made significant progress in the last years.

In addition, future networks, including enhanced-5G and 6G networks, should also be designed to support new applications and services, including AI and data sensing services, which are widely used not only in industrial applications, but also by individuals. These applications enable more global and open collaboration between different entities, and future networks should be designed to provide or improve data confidentiality and reliability, standardization, and rapid application deployment.

As the real world is controlled more and more with the help of the digital realm, and as a more precise control over real-world systems is needed, digital twins have been created to provide digital representations of real-world entities. Those digital twins can represent any type of entity, including objects, such as engines, cars, robots; infrastructures, such as cities and factories, but also users themselves. Replicating users in the virtual world presents additional challenges compared to objects or infrastructures, as the confidentiality and integrity of user data is paramount.

All these factors are driving research of future network architecture, including, for example, 6G networks. Therefore, improvements in communication networks are desirable.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure may provide a method allowing the instantiation and operation of Digital Entities (DE or D-XX), which may also be referred to as representatives, replicas or digital twins, of real-word entities, or real entities. A digital entity may comprise both the physical components (memory, processors, network cards, ports, etc.) and one or more of the software components required to enable the digital entity to communicate with other components, external or internal to the network hosting the digital entities.

In the present application, a Digital Entity, also referred to as DE, D-XX, DE module or D-XX module, corresponds to a representation of any entity, including, for example, assets, processes, systems, digital worlds, organizations, or users. A Digital Entity may be a virtual representation or replica of a real-world object, person or process that can be used to simulate their behaviors in order to better understand and predict their operation in real life. Digital Entities may be linked to real data sources, collected from sensors, and other information sources from their environment. The Digital Entities may be updated in real time to reflect the original, real-world versions. The Digital Entities may be interconnected and may communicate and influence one another such that entire systems may be replicated.

A Digital Entity replicating a physical entity or a collection of physical entities may be referred to as a Digital Representative (D-Rep or D-Rep module). A Digital Entity replicating a more complex system, such as an organization or a plant, and comprising several D-Reps, may be referred to as a Digital Infrastructure (D-Inf). Digital Entities replicating users, including for example animals and humans, can be referred to as D-Users. Particularly, the present application describes methods to instantiate and operate digital entities, including for example D-Users, to provide services to a real entity. The real entity can correspond to, be associated with, or be controlled by a user, referred to as a digital entity customer. The digital entity can act on behalf of the real entity for specific operations.

A digital entity can provide various entity controlled and managed services to the real entity and methods are provided to make the digital entity ready to establish any entity controlled and managed service inside the digital entity, advantageously ensuring proper operation of the digital entity while preserving privacy of the information related to the real entity. The method and system allow overcoming security and privacy issues that can arise from creating digital instances on an open or untrusted network.

Particularly, the present application describes methods to instantiate and operate digital entities, including for example D-Users, to provide services to a real entity. The real entity can correspond to, be associated with, or be controlled by a user, referred to as a digital entity customer. The digital entity can act on behalf of the real entity for specific operations.

A digital entity can provide various entity controlled and managed services to the real entity and methods are provided to make the digital entity ready to establish any entity controlled and managed service inside the digital entity, advantageously ensuring proper operation of the digital entity while preserving privacy of the information related to the real entity. The method and system allow overcoming security and privacy issues that can arise from creating digital instances on an open or untrusted network.

When the digital entity is a digital user (D-User), the D-User can provide various user controlled and managed (UCM) services to the user and methods are provided to make the D-User ready to establish any UCM service inside, advantageously ensuring proper operation of the D-User while preserving privacy of the information related to the user. The method and system allow for overcoming security and privacy issues that can arise from creating digital instances on an open or untrusted network.

In some embodiments, a basic D-User is created and a secure connection to the user is prepared so that the user can establish the UCM services. In some embodiments, the D-User is created inside a trusted network. In some embodiments, the D-User is created inside an untrustworthy network. In addition, in the untrusted case, this application provides methods to create the hosting platform to avoid the hosting network getting access to user data, user operations or the information about the external servers the D-User access using the network.

The current metaverse or digital world (DW) applications use different digital representatives. Privacy preservation is required for the digital entities as well as the digital worlds (DW) application operations. In particular, the DW operations need to be protected from the hosting networks. Therefore, the hosting platforms discussed herein can be used for providing in-network DWs as well.

In the context of the present disclosure the expression ‘user-centric management and control (UCM)’ services is used to indicate the services that can be offered by networks to control and manage the user services according to the present disclosure. The proposed UCM design type facilitates the ability of a digital entity customer, via a UE, to control services and their features provided by a network, or to manage the network components that provide these services and features to the UE. These services are termed user controlled and managed (UCM) services in the context of the present disclosure.

In the context of the present disclosure the expression “User-Controlled and Managed (UCM)” services is used to indicate the services that can be offered by networks to control and manage the user services according to the present disclosure. A proposed UCN design type facilitates the ability of a UE to control services and their features provided by a network, or to manage the network components that provide these services and features to the UE. These services are termed user controlled and managed (UCM) services in the context of the present disclosure.

The present disclosure, which relates to UCM services provided within networks, can advantageously be implemented networks, such as in a 6G network architecture, helping in building a network architecture that supports new services which could be developed/deployed by 3rd parties, that uses a more open ecosystem to open door to technical capable 3rd parties, and that enables better trustworthiness management.

This application provides a network operator a method to provide a wide variety of user controlled and managed (UCM) services using a digital representative (D-XX) of entities, such as users represented by D-Users, inside a network.

In a first aspect, a method for establishing User Controlled and Managed (UCM) services for a user using a digital representative (D-User) of the user inside a hosting network is provided. The method comprises receiving a request for establishing a UCM service, the request including a UCM service type, the UCM service corresponding to a service provided by the hosting network using the D-User; establishing the UCM service according to the UCM service type by configuring at least one function inside the D-User required for rendering the UCM service; and informing a User Equipment (UE) of the user that the UCM service is established and that communication sessions related to the UCM service can be initiated.

In possible embodiments, the D-User comprises at least one D-User function inside the D-User. The at least one D-User function may be a control function and/or a data plane function. The step of configuring at least one function inside the D-User may comprise configuring said at least one the D-User function.

In some embodiments, the UCM service type is associated with a UCM service blueprint which indicates how to configure the at least one function.

In some embodiments, the at least one function comprises an existing function inside the D-User. The method further comprises creating one or more new functions and associated interfaces inside the D-User, the new functions being required to render the UCM service, and configuring the one or more new functions according to the UCM blueprint.

In some embodiments, the method further comprises creating one or more new network functions and associated interfaces inside the hosting network but outside the D-User, and configuring the one or more new network functions according to the UCM blueprint.

In some embodiments, the request is sent by the UE or by the D-User and received by a control plane function of the hosting network.

In some embodiments, the hosting network verifies a subscription profile of the user or of the D-User to authorize the establishment of the UCM service.

In some embodiments, the method comprises recording a UCM service subscription in the subscription profile of the user or of the D-User in the hosting network to enable the user or the D-User to obtain the UCM service from the hosting network.

In some embodiments, the D-User is hosted in a hosting platform of the hosting network, at least some of the one or more new functions being created by a hosting platform (HOP) function orchestrator.

In some embodiments, the D-User is hosted in a hosting platform of the hosting network, at least some of the one or more new functions being created by the D-User.

In some embodiments, the method comprises creating a data path between the D-User and at least one of a User Equipment (UE) and a node external to the D-User, for rendering of the UCM service.

In some embodiments, the method further comprises a step of instantiating the D-User in the hosting network, either at the time of the request or prior to the request.

In some embodiments, creating the D-User inside the hosting network comprises creating a secure link between the User Equipment (UE) of the user and the D-User to provide the UCM service or one of UCM service functions of the UCM service.

The secure link can be established in one or more of the data plane or control plane.

In some embodiments, the request is sent by the UE and is received by the D-User, a secure communication link already existing between the UE and the D-User prior to establishing the UCM service, the D-User already having access to UCM services that can be offered and corresponding UCM blueprints.

In some embodiments, the request is encrypted with a key created for communication between the D-User and the UE and the user can make the request directly from the D-User so that the network is not aware of the content of the message used for the request. In some embodiments, the message comprising the user request may have a Privacy preserving level which indicates what privacy level is needed for the UCM service. For example, different privacy levels can be: (1) that the UCM service has to be established so that the network is not aware of the data contained in the user communication sessions but aware of the entities (e.g. DN) the user is communicating with; (2) that the network is aware of both the content in the user communications as well as the entity the user is communicating with; (3) that the network is not aware of both the content in the user communications as well as the entity the user is communicating with; and (4) that the network is aware of both the content in the user communications as well as the entity the user is communicating with.

In some embodiments, the method further comprises adding a privacy preserving level ID (PPL) to the messages sent from the UE to the hosting network and/or the D-User in UCM service request message and communication sessions related to the UCM service.

In some embodiments, the D-User is hosted in a Trusted Execution Environment (TEE) isolated from the hosting network.

In some embodiments, the at least one function comprises an existing function inside the D-User, the method further comprising: creating one or more new functions required for the UCM service and associated interfaces inside the D-User, and configuring the one or more new functions according to the UCM blueprint.

In some embodiments, the one or more new functions are created by a local D-User function orchestrator.

In some embodiments, the D-User requests the hosting network to create and/or configure the network functions required to establish the UCM service to the D-User.

In some embodiments, the method further comprises assigning a UCM service identifier (ID) to the UCM service so that the UCM service ID is included in packets exchanged between the UE and the hosting network and/or the D-User in communication sessions related to the UCM service.

In some embodiments, informing the User Equipment (UE) that the UCM service is established includes informing the UE of data packet format to be used and software needed to operate the UCM service.

In some embodiments, the method comprises a step of preparing, by the hosting network, the UCM service blueprints, said preparing being performed prior to receiving the request and including: determining UCM service functions required within the hosting network for the UCM services; determining privacy requirements for the UCM service functions and associated data; and determining configuration requirements for already existing network functions. The method of claim 2 or 21, wherein the UCM service blueprints are stored in a UCM service blueprint storage made available by the hosting network to the D-User.

In some embodiments, the method comprises the hosting network broadcasting available UCM service types to inform the UE prior to receiving the request.

In some embodiments, the method further comprises provisioning hosting network resources to provide required Quality of Service (QoS) for the UCM service.

In some embodiments, the UCM services include at least one of: home network, equipment, health and alarm control; authentication of users for allowing service access; authorization for using personal data; and privacy-preserving payment exchanges with 3rd parties.

In some embodiments, the UCM services include at least one of: a capability to dynamically obtain special network features according to dynamic needs; a capability to define special services; UE traffic routing control within network UPFs; and service quality map acquisition.

In some embodiments, the UCM services include at least one of:
advertisement and spam blocking; TCSP acceleration using a proxy; local data caching and pre-fetching; privacy-oriented source address and identification modification;
content or data sharing; user traffic processing; and support for user equipment artificial intelligence (AI) applications.

In some embodiments, the UCM services include providing network resources and services acquisition.

In some embodiments, the UCM services include at least one of: D-User AI services for providing interactions with UE; and networking AI services.

In some embodiments, the UCM services include at least one of:

service acquisition from neighbouring UE; and network support for Anything-as-a-Service (XaaS) services.

According to an aspect, there is provided a tangible, non-transitory memory having recorded thereon instructions to be carried out by one or more processors to carry out a method as defined in any one of the previous paragraphs.

According to an aspect, there is provided a system for establishing user controlled and managed (UCM) services for a digital representative of a user (D-User) inside a hosting network, the system comprising: one or more processors; tangible, non-transitory memory storing instructions executable by the one or more processors to: receive a request for establishing a UCM service, the request including a UCM service type, the UCM service corresponding to a service provided by the hosting network using the D-User; establish the UCM service according to the UCM service type by configuring at least one function inside the D-User required for rendering the UCM service; and inform a User Equipment (UE) of the user that the UCM service is established and that communication sessions related to the UCM service can be initiated.

According to an aspect, there is provided a system for instantiating a digital entity inside a hosting network, the system comprising: one or more processors; the tangible, non-transitory memory defined above.

According to another aspect, there is provided an apparatus, wherein the apparatus comprises a processor and a memory storing one or more instructions that is capable of being run on the processor, and when the one or more instructions are run, the apparatus is enabled to perform any of the methods described herein.

According to another aspect, there is provided an apparatus, wherein the apparatus comprises a function or unit to perform any of the methods described herein.

According to another aspect, there is provided a computer readable storage medium, comprising one or more instructions, wherein when the one or more instructions are run on a computer, the computer performs any of the methods described herein.

According to another aspect, there is provided a non-transitory computer-readable medium storing instruction the instructions causing a processor in a device to implement any of the methods described herein.

According to another aspect, there is provided a device configured to perform any of the methods described herein.

According to another aspect, there is provided a processor, configured to execute instructions to cause a device to perform any of the methods described herein.

According to another aspect, there is provided an integrated circuit configure to any of the methods described herein.

Other features, aspects, and advantages of the present disclosure will become more apparent upon reading of the following non-restrictive description of specific embodiments thereof, given by way of example only with reference to the appended drawings. Although specific features described in the foregoing summary and in the following detailed description may be described with respect to specific embodiments or aspects, it should be noted that these specific features may be combined with one another unless explicitly stated otherwise herein.

### BRIEF DESCRIPTION OF THE DRAWINGS

FIG. 1 shows a block diagram of a UE, 3GPP network elements and a data network interconnected through VUE interfaces, in accordance with embodiments of the present disclosure.

FIG. 2 shows a possible architecture of a network for a digital world, in accordance with embodiments of the present disclosure.

FIG. 3 shows a schematic illustration of a communication system, in accordance with possible embodiments of the present disclosure.

FIG. 4 shows a schematic illustration of a communication system, in accordance with other possible embodiments of the present disclosure.

FIG. 5 shows a schematic illustration of an electronic device and of a base station, in accordance with possible embodiments of the disclosure.

FIG. 6 shows a schematic illustration of modules of an electronic device, in accordance with possible embodiments of the disclosure.

FIG. 7 shows a block diagram of a network system, in accordance with possible embodiments of the present disclosure.

FIG. 8 shows an exemplary system architecture including a Hosting Platform (HOP) and HOP creation functions, in accordance with possible embodiments of the present disclosure.

FIG. 9 shows a Hosting platform and HOP creation functions, in accordance with embodiments of the present disclosure.

FIG. 10 is a diagram showing a HOP functional architecture including D-User creation functions, according to a possible embodiment.

FIG. 11 shows D-User creation functions in various network domains.

FIG. 12 shows a flow chart of a UCM service establishment with hosting network permission, in accordance with possible embodiments of the present disclosure.

FIG. 13 shows a flow chart of a UCM service establishment, in accordance with possible embodiments of the present disclosure.

FIG. 14 shows a life cycle of a D-User, in accordance with some embodiments of the present disclosure.

FIG. 15 shows operational states of a D-User, in accordance with some embodiments of the present disclosure.

### DETAILED DESCRIPTION OF ILLUSTRATIVE EMBODIMENTS

### 6.1. Disclaimers and Term Interpretation

In the following description and figures, same reference numbers refer to similar elements of the application. Furthermore, to not unduly clutter the figures, it is possible that a figure may not contain all the reference numbers of the elements found in the figure. It is also possible that some elements or components may be referenced in only one figure. The element thereby referenced can easily be inferred in the other figures shown. The embodiments, geometrical configurations, materials and/or dimensions shown in the figures or described in the present disclosure are only indicative, and show possible embodiments, presented as examples, and should not be interpreted as limiting of the application.

One or more systems described herein may be implemented in computer programs executing on processing devices, each comprising at least one processor, a data storage system (including volatile and non-volatile memory and/or storage elements), at least one input device, and at least one output device. The term “processing device” encompasses computers, servers and/or specialized electronic devices which receive, process and/or transmit data. “Processing devices” are generally part of “systems” and include processing means, such as microcontrollers and/or microprocessors, CPUs or are implemented on FPGAs, as examples only. For example, and without limitation, the processing device may be a programmable logic unit, a mainframe computer, server, a personal computer, a cloud-based program or system, a laptop, a personal data assistance, a smartphone, a wearable device, or a tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with one or more storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory may be chosen according to the desired use, whether it should retain instructions, or temporarily store, retain or update data. Steps of the proposed method are implemented as software instructions and algorithms, stored in computer memory and executed by processors.

The terms “a”, “an” and “one” are defined herein to mean “at least one”, that is, these terms do not exclude a plural number of items, unless stated otherwise. In the present disclosure, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

Terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

The present disclosure provides a method to instantiate and operate a digital entity, which can be a digital user, inside a network to provide services to the user wherein the digital entity can act on behalf of the real entity for certain operations. The network can be a wireless network segment (e.g. RN, CN, WIFI), or a data network (DN).

When the digital entity is a user, the D-User may provide various user controlled and managed (UCM) services to the user and methods are provided to make the D-User ready to establish any UCM service inside ensuring proper operation while preserving privacy.

In some embodiments, a basic D-User is created and a secure connection to the user is prepared so that the user can establish the UCM services. In some embodiments, the D-User is created inside a trusted network. In some embodiments, the D-User is created inside an untrustworthy network. In addition, in the untrusted case, this application provides methods to create the hosting platform to avoid the hosting network getting access to user data, user operations or the information about the external servers the D-User access using the network. Further, the digital representatives (D-Reps) used in the network and network operations may require privacy preservation. In particular, digital world operations, discussed in greater detail below, may need to be isolated from the hosting networks. Therefore, the hosting platforms discussed in this application here can be used for providing in-network digital worlds as well.

The current metaverse or digital world (DW) applications use different digital representatives and privacy preservation is required for the D-Reps as well as the DW application operations. In particular, the DW operations need to be protected from the hosting networks. Therefore, the hosting platforms discussed herein can be used for providing in-network DWs as well. DWs can be considered as consisting of D-Users, various D-Reps such as D-Infs and various other applications such as VR and AR applications. These are commonly termed D-XX modules in this document.

### 6.2. User Equipment (UE) and Virtual User Equipment (VUE)

In the context of the present disclosure, the term ‘UE’ may represent a combination of a network access device (NAD) and a user personal device (UPD). Also, in the context of the present disclosure, a VUE is a digital entity located in the network and represents both the NAD and the UPD. UCM services may be provided by deploying the VUE by at least one network node of the network. The user applications and user data can be considered as higher layer components of the UE. These higher layer components may be considered to be the UPD. The UE can use its applications in the NAD to facilitate UCM services. A VUE may have different functionalities depending on the UCM service types it provides. In the context of the present disclosure, the term VUE type is a VUE having functionalities that can provide specific types of UCM services. The VUE may be deployed at different segments of the network (e.g., RAN, CN, mobile edge computing node (MEC), etc.) in a hierarchical manner to support various UCM services for UEs. The VUE may represent a particular UE and facilitate certain actions on behalf of the UE to support applications and services engaged throughout the network. There may be different types of VUEs providing different types of UCM services. Not all UEs may require user empowerment and therefore, a VUE or a UCM service may be provided as an add-on feature to the UE. A UE, requiring a particular UCM service, may have to subscribe to a particular VUE type or a UCM service (a VUE type may be configured to provide multiple UCM services). Subscription may be done by the UE contacting the mobile network operator's (MNO's) service desk or through an application provided in the UE, in which case the UE may send a special request to the network. The network may request a VUE creation function (VUCF) in the network to instantiate the VUE. Instantiation of the VUE may include the instantiation of at least one NF belonging to the VUE and its required interfaces. In one embodiment, the instantiation of the VUE may include the instantiation of a VUE-M (VUE manager) which has the capability of instantiating other NFs and interfaces belong to the VUE. There may be multiple VUEs located in different parts of the network (e.g., in different parts of a 3GPP network) and in data networks (DNS). In some embodiments the VUE creation request may be made by another, already existing, VUE. In some embodiments, instantiating the VUE may include instantiating NFs and respective interfaces associated with a VUE type.

When a VUE is created (generated) it may be created with a VUE-Manager (VUE-M), other Network Functions (i.e., UPFs and CPFs) and a database. Creation of the VUE may include engagement of a virtualized infrastructure and a VUE-M. The VUE-M may use the virtualized infrastructure to instantiate the other network functions and the interfaces, necessary for the requested VUE type. The infrastructure may be part of the hosting network, or it may be a hardware platform provided by a third party vendor, as a trusted executive environment. In some embodiments, instantiating the VUE may include instantiating NFs and respective interfaces associated with a VUE type.

The VUE instantiation may include instantiation of functions together with interfaces required for the requested UCM features in the network, which may be a wireless network. With the required interfaces in place, the VUE may interact with the network on behalf of the UE to engage the requested UCM features without direct interaction between the UE and the functions in the access network, for example, over an air interface when the UE is a wireless device.

### 6.3. X-centric Network Architecture

Many new trends trigger considerations and design of 6G or other future wireless networks, including: new network infrastructure capability, e.g., cloud natured/friendly infrastructures that are broadly deployed; new relatively matured techniques, e.g., AI large-scale models, data de-privacy, block chain, etc. that have made significant progress and significantly impact on the entire society and human life; new apps and services, e.g., AI services, Data (sensing) services, digital world services, etc. that are broadly applied in industry/business and used by individual customers; more global, open and collaborative operation trends, i.e., a more open and more collaborative operation mode is becoming common practice in many fields. New expectations and stricter requirements on future networks also drive rethinking and development of new generations of wireless networks. These requirements may include: increased privacy and trustworthiness, simplified standardization of data and exchanges, rapid deployment of digital environments.

The proposed network architecture described herein, which may apply to future networks, is an X-centric architecture, which means that is it centered on objects and users, and is therefore a cloud-native, Service Based Architecture (SBA), to support the delivery of services for different types of entities, where any object or entity may be provided as a service.

Consequently, the proposed network architecture, which may be adapted to future networks, may support new services which can be developed or deployed by 3rd parties. The proposed network architecture can be adapted to allow communications and exchanges with technical capable 3rd parties, and may be adapted to enable trustworthiness management.

### 6.4. D-User as Digital Representative of a User

In the context of the present disclosure, a Virtual User, also referred to as a D-User or D-User module, is a digital representative of a user instantiated and maintained inside a network, which becomes a “hosting network”. A D-User is a special case of a Digital Entity (DE or D-XX). Since one or more D-Users may be stored and maintained inside the hosting network, a D-User can closely interact with the hosting network and/or other digital entities maintained in the hosting network, in order to provide the “real” user with more control over services obtained from the hosting network, i.e., the D-User may allow for improved user empowerment. The network services may be provided by the hosting network as added services and may be referred to as User Controlled and Managed (UCM) services. In possible embodiments, a D-User module may be a standalone code section or segment that includes different functions and routines, or that provide different services, according to a predetermined structure.

There may be different levels of control and management given to a user, i.e., empowerment levels. An empowerment level refers to the degree of authority, autonomy, and control granted to a user. The present disclosure provides different empowerment levels, including, for example:
User-defined service capability, i.e., user may define the services the user needs;
User may manage/control behaviors or features of the services provided by the hosting network;
The hosting network may be designed such that each user is served with a specific part of the network (e.g., exclusive logical slice) and have a certain control on it;
Services may be provided considering the user's context (e.g., user in the loop, user context is used for dynamic network functionality/operation modifications);
User device(s)/networks may become part of the network, e.g., UE as BSs/relays, drone BSs/relays, application servers;
User becomes a producer/provider of services to the network, e.g., AI service, neighbour information, video services, BS service provided by a user device or drone BS;
A D-User inside the network can interact with the hosting network to provide or facilitate these services. For this purpose, the D-User may include control plane functions, data plane functions (also referred to as user plane function), data storage, and required internal and external interfaces.

### 6.5. User Equipment, 3GPP Network and Data Network

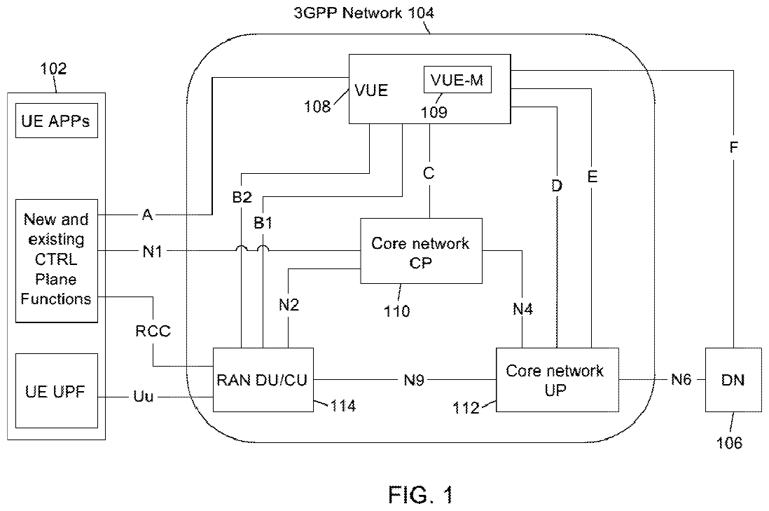

FIG. 1 illustrates an example of interfaces of a D-User.

FIG. 1 shows a block diagram of a UE 102, a communications network (e.g. a 3rd Generation Partnership Project (3GPP) network) 104 and a data network (DN) 106 interconnected to each other through VUE interfaces (also referred to as reference points), in accordance with embodiments of the present disclosure. The network 104 may include a VUE 108, a VUE-M 109, a core network (CN) control plane (CP) 110, a core network user plane (UP) 112 and a RAN distributed unit (DU)/central unit (CU) 114. In the embodiment of FIG. 1, VUE operations may require several control plane and data plane interfaces between the UE 102 and elements of the network 104, and between elements of the 3GPP network 104 and the DN 106. The required interfaces may depend on the type of UCM services, facilitated by the VUE. A given interface may be used only by some UCM services. In addition to the interfaces that are defined in 5G standards, additional interfaces or additional messaging over the existing interfaces may be required for VUE deployment and operation. Several interfaces may be required for operation of the VUE 108. In the context of the present disclosure, an interface may be referred to as a reference point and vice versa.

VUE-UE control plane reference point (A)—Interface A shown in FIG. 1 is mainly for UE to VUE control plane messaging, transparent to the network. The interface A may be configured to synchronize, between the UE 102 and the VUE 108, the UE data (e.g., UE context, location), to provide authentication, authorization, and information in relation to the connections between the VUE and UE, data packet formats and any new UCM protocol data unit (PDU) session initialization. Depending on the UCM service, synchronization of a high-volume data flow may require a logical data plane connection between the UE 102 and the VUE 108. The data plane connection may be established by the network, for example, via a Uu interface and a B2 interface, in response to a request from the VUE 108 or the UE 102. For this purpose, the UE 102 may send control plane messages to the VUE 108 through the VUE-UE control plane reference point A interface. NFs in the network (or at least one NF in the network) may be configured to interact with the UE to obtain a user context.

VUE-RAN control plane interface (B1)—Interface B1 is used for certain UCM services such as, for example, when the VUE 108 requires specific radio access network (RAN) technologies or features. The VUE 108 may use this reference point to make such requests. In addition, this logical link (interface B1) may be used for direct UE functionality authentication, which is similar to an access and mobility-management function (AMF) functionality.

VUE-RAN data plane interfaces (B2)—For some UCM applications, interface B2 may be used to direct UE traffic to and from the VUE 108, transparent to the hosting network (Core Network or RAN). The N9 and N4 reference points may be used for the same purpose.

VUE-CN control plane reference point I—The CN CP 110 may have a single entry reference point (interface C) to a VUE control plane engaged to set up connections, authentication, authorization and accounting (AAA), policy update handling and lifecycle management of network functions at the VUE 108.

VUE CPF—CN UPF reference point (D) interface—Interface D is used by certain types of UCM services that enable VUE CPFs to control CN UPFs for routing and data processing purposes if the network operator allows certain level of control on certain UPFs. The D reference point interface may also be used for monitoring UE traffic related information (e.g., resource usage, quality of experience (QoE), different flows routing to different processing functions, UPFs or DNs). NFs in the network (or at least one NF in the network) may be configured to obtain the user traffic/data for internal processing.

VUE-CN data plane reference point I interface—Interface E is for UCM services when there is a requirement for certain data processing at the VUE 108 or when certain data has to be terminated or started at the VUE 108. In this case user traffic originated by the UE 102 or the DN 106 is diverted to the VUE 108 using this interface. NFs in the network (or at least one NF in the network) may be configured to obtain the user traffic/data for internal processing.

VUE-DN data plane reference point (F) interface—Interface F is to send and receive data directly between the VUE 108 and DN 106. The interface is required only for certain UCM services.

There are numerous options for defining reference points for interactions between different VUE control plane functions (CPFs) and different CN CPFs. For example, a standard may define a number of reference points for the interactions between a specific VUE CPF to a specific CN CPF. It is also possible that a single reference point may be defined for all control plane communications between the VUE 108 and each network domain (e.g., VUE or CN).

In addition to already described reference points, a number of 5G network reference points (e.g., in 23.501, 3GPP), for example, N1 and N2, may have to be modified to include UCM functionality and support required messaging for the VUE 108 and for UCM services.

N1 reference point between the UE 102 and an access and mobility management function (AMF). In addition to the relevant functions defined in the 3GPP TS 23.501 standard for this reference point, to support a VUE or a UCM service, the N1 reference point may be used to convey the VUE policy and parameters (including VUE service authorization) from the CN (e.g., AMF) to the UE 102, and convey the VUE 108 and UCM interaction capabilities to the CN CPF (e.g., AMF). Furthermore, establishment of a sync channel and an initial authentication procedure between the VUE 108 and the UE 102 may be done via the N1 reference point. The sync channel establishment and authentication may be done by the AMF following a request from a session mobility function (SMF).

N2 reference point defines a link between a RAN and the CN (e.g., the AMF). In addition to the relevant functions defined in 3GPP TS 23.501, the N2 reference point, configured to support VUE and UCM services, may convey VUE policies and parameters (including a VUE service authorization) from the AMF to the RAN (or a next-generation radio access network (NG-RAN)).

Uu reference point between the UE 102 and the RAN, is configured to support UCM functionality and may provide additional quality of service (QoS) bearers for specific UCM services and sync channels.

### 6.6. Trusted Execution Environment (TEE) of Processor for Hosting D-Users

A TEE is a secure area of a main processor which provides code and data integrity for the applications running inside the TEE. Examples of processors which provide such capabilities include the Intel SGX™ or AMD SEV™ processors. In the TEE, applications can securely store and process data which cannot even be detected by the operating system of a processing device or UE. For example, some systems, such as Intel SGX, may work by creating a secure area of memory, called an enclave, where an application can run. This enclave may be protected by a set of cryptographic keys that are unique to the application and the system it is running on. An enclave may also be considered as a virtual machine (VM) as it may be operated on a separate CPU located in the protected part of the operating system of the hosting network. When an application is executed thereon, the application is sealed inside the enclave, where it can run securely without fear of interference from other processes or from the operating system.

Additionally, TEEs may include a feature called “remote attestation”, which allows a remote party to verify the integrity and security of an enclave, thus providing a way to trust the enclave. Remote attestation may work by allowing a remote party to send a request to the enclave, asking the enclave to provide proof of its identity and integrity. Integrity may refer to the quality of data, functions and/or applications being accurate, consistent, and unaltered. The enclave may then respond by providing a cryptographic signature that may be based on the enclave's unique identity and a set of measurements of the enclave's code and data. The remote party may then verify the signature using a public key provided by the enclave. If the signature is valid, the enclave is authentic and has not been tampered with, allowing the remote party to trust the enclave and its data. The container may thus be protected by a cryptographic key, isolating the container from the Operating System (OS) managing the TEE, the cryptographic key being required to access the Digital Entity (DE) hosted in the HOP in the container. In possible embodiments, the container may receive an attestation request by a remote device and provide the cryptographic key to the remote device based on a unique identifier of the content or the functionality of the container, to attest authenticity of the container. A remote device may be any processing device that this outside the HOP or the hosting network, and that may need to access contents of a Digital Entity hosted in the HOP. For example, a remote device can be a User Equipment that may need to access an application executed by the digital representative of the user, i.e. the D-User.

In possible embodiments, the proposed method and system may provide for the creation and maintenance of Digital Entities, such as D-Users or D-Reps, inside a TEE, such that even the hosting network may not be able to access the Digital Entity data, including user data or codes (i.e. applications) used by the Digital Entity. In possible embodiments, the entire platform hosting the digital entities, the HOP, may be instantiated in a TEE, such that the HOP and the Digital Entities managed in the platform are isolated by their hosting network. A TEE may correspond to a Confidential Computing Environment (CEE) located inside the HN. In possible embodiments, a user or a customer using the HOP functions or the Digital Entity functions (such as D-User or D-Rep functions) may need to verify that the program codes (software) inside the HOP and the program codes (software) representing each Digital Entity consists of standard or expected codes which do not allow either the HN functions or any external entity to access or tamper with these codes. For this purpose, a remote attestation of the program codes, software or applications executed in the HOP may be provided.

According to possible embodiments, since the HN may be installing the HOP and the initial functions required to create the Digital Entities, such as D-Reps, users requesting the creation of the Digital Entities and/interacting with the Digital Entities may require a guarantee that the Digital Entities, the HOP or the hosting network cannot present a breach in privacy.

Therefore, a method may be provided for allowing users and/or customers to verify the program codes and applications used by the Hosting Network and/or HOP, according to a standard process. According to a possible embodiment, users may be provided with means to upload the program codes of the functions to the Digital Entity and/or instantiate those functions inside the Digital Entity. However, users may not be able to develop such program codes on their own and may need to obtain the program codes from a vendor. In order for the user to verify the legitimacy and credentials of a given functionality, program codes may be standardized and standard testing methods may be provided. Test methods may be standardized as well. Independent organizations testing the program codes may have the authority to certify program codes as certified or approved. Users may thus have access to certified program codes when they need the program codes to be executed in the Digital World provided by the Hosting Network.

In other embodiments, the certification may be done by the user or customer directly, using a testing program, which can perform remote attestation of program codes running in the HOP and/or Digital Entities. A program code or software to be executed by a Digital Entity may be provided with a cryptographic signature, such as a hash of the program code. The user may be able, via a testing program or software, to verify the hash of the program code.

A possible issue may be that, even if a user has installed a certified version of an application or of a function inside a Digital Entity (such as a D-Rep or a D-User), the application or function already created inside the Digital Entity by the HOP or by the Hosting Network may not be credible or certified. In this case, functions such as the Digital Entity Manager (D-Rep-M) and HOP functions (HPFs) may need to be tested for credibility/authenticity.

According to a possible embodiment, certified TEE vendors may be trusted to use certified program codes for the instantiation or creation of the HOP and Digital Entities hosted therein. According to another embodiment, a TEE vendor may be required to install only certified versions of those program codes so that when a user undergoes remote attestation of the program code inside the container, the signature of the container and/or program codes may be obtained and verified by a trusted authority, such as an approved 3^{rd} party organization certified to validate the certified signatures. The User Equipment (UE) may verify authenticity of the container by providing a cryptographic key to a 3^{rd} party device. In return, the 3^{rd} party device can provide at least one of: the container; contents inside the container; and functionalities of the container to confirm the authenticity of the container. A 3^{rd} party can act as an authentication entity, which may verify the authenticity of the contents of the HOP. A 3^{rd} party device can be a server controlled and managed by the authentication entity.

Consequently, two types of standardized functions may be required, a first certified function for the HOP, and a second certified version for the Digital Entities, such as D-Reps, which may be verifiable using standard tests.

In possible embodiments, and in the context of the present application, a TEE can be preconfigured or preinstalled with specific program codes which may enable the TEE to perform some of the following functions:
Automatically create (or self-create) certified versions of Digital Entities inside the TEE according to blueprints provided beforehand when requested to create a Digital Entity by a Hosting Network Function (HNF). The creation of the Digital Entities may include providing a secure key and a physical entity address (such as a MAC or IP address) to establish secure communications between the Digital Entities (such as D-Reps) and the physical entity. A “certified version” of a Digital Entity may be a Digital Entity blueprint, corresponding to a standard description kept inside the TEE. The blueprint may correspond to an approved version certified by a standard organization;
Provide functions inside the HOP, such as HOP management functions (HMF), to control access from outside HOP to internal functions of the HOP;
Allow a limited number of operations to be performed when requested by an HNF. These limited number of operations can comprise the creation or deletion of Digital Entities, resource assignment for the Digital Entities, establishment of links with physical entities.

Once a secure communication link is established between a Digital Entity and the physical entity, the physical entity may be able to attest the HOP and Digital Entity program codes as credible or certified ones, that is, untampered or unaltered by the HN or by any other entity. In order to ensure integrity of the HOP, the physical entity may obtain a state of the current program code of the HOP, and may verify the HOP program code with the TEE provider to ensure the authenticity and/or credibility of the HOP program code. A remote attestation service may be provided by the TEEs, comprising for example a hash of the code used by the HOP and the D-Rep).

After remote attestation, the physical entity may request the network services needed and the HOP can facilitate providing the network service requirements when requested by the Digital Entities.

When the HN is not a trusted network with regard to the physical entity, the use of a TEE to create the HOP and the Digital Entities hosted therein may allow for the provision of a secure area inside the Hosting Network. The Hosting Network (HN), or network provider, may be able to guarantee the user and related physical devices that the area is closed and inaccessible to the network provider. When the HN receives a TEE by a TEE provider, the TEE may be provided with an access key, such as a cryptographic key, to access the TEE. The access key can be handed over to the end user (or UE) while providing an anchor function through which messages to and from the Digital Entity can be sent. Data and applications inside the TEE should not be tampered with by the HN. This preservation of privacy can be achieved by only allowing specific operations to be carried out by the HN, such as controlling code and functions already inserted inside the TEE by the TEE provider, which cannot be tampered with.

### 6.7. NET4DW Service Module

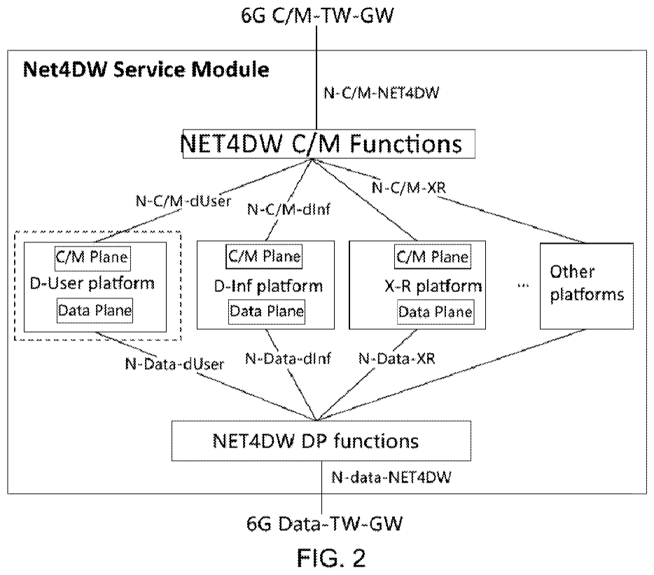

Referring to FIG. 2, in possible embodiments, a digital world network service module is schematically illustrated, which can provide Digital World (DW) services and which may include a capability to construct, control and manage objects and entities in a digital or virtual world. The digital world network service module may also be referred to herein as a “NET4DW” service module. A digital world can be defined as a digital realization or implementation of a physical world, including for example people, processes, animals, objects, such as robots, cars, lights, and infrastructures, such as roads, organizations, buildings and factories. For this application, the terms digital entities, DE, D-XX, DE module or D-XX module may be used to represent any of the above items. The NET4DW service module may provide different services to allow applications to run or be executed in the DW. In particular, the NET4DW service module may include D-Users, which correspond to digital representations of physical users (P-Users). Currently, some form of digital representation of a user is available in certain metaverses or servers such as Facebook™, Amazon™, Google™, etc. The required representation can vary from application to application and can vary from using user data to controlling personal items and actions on behalf of the user. A D-User can comprise a set of parameters and data corresponding to characteristics of a real, physical person or animal, including not only nominative data, such as a name, age, address, but also other characteristics, such as real-time location, heartbeat, medical conditions, preferences, physiological data, the user context, environmental context, mobility, past activities which can be gathered from sensors or not. A D-User may also comprise one or more software applications or modules that can simulate, predict or replicate the behavior or condition of the real, physical person associated with the D-User. Operational data defines operations performed by functions of the one or more D-Reps or D-Users. Operational data may comprise one or more of: processing of input data, modifying input data, forwarding input data or processed data to a specified destination, deleting input data, creation of other functions and life cycle management of other functions, resource assignment for other functions, modifying other functions.

FIG. 2 provides an exemplary high-level architecture of an NET4DW service module.

As shown in FIG. 2, NET4DW may include different types of Hosting Platform (HOP) for hosting Digital Entities, such as D-User platforms, D-Inf platforms and any other DW platforms such as Virtual Reality (X-R) platforms. These platforms may host one or more digital entities, which are commonly termed DE, DE module, D-XX or D-XX modules in the present disclosure. A D-Inf platform may contain digital representatives (D-Reps or D-Rep modules) of different physical objects, such buildings, roads or lights, and D-Inf can replicate an infrastructure such as a city, as an example only.

In the diagram C/M refers to control and management plane and DP refers to data plane. Net4DW C/M functions are the control and management functions of the NET4DW to manage and coordinate the platform interactions required for different DW applications. It may also include the Control and Management Gateway (C/M G/W) function though which the NET4DW C/M functions interact with the external C/M functions. Similarly, DP functions are the data plane functions such as routing and data processing functions. Each platform has its own C/M and DP functions and they may connect to Net4DW functions through G/W functions. A HOP platform may be a single Digital Entity platform or a multiple Digital Entity Platform (multiple DE-HOP). For example, a single D-User HOP may be used for hosting a single D-User (replica of a physical user) or multiple D-User platform may be used for hosting multiple D-Users, for example, a group of friends or a family.

Details of NET4DW functions, which may need to be instantiated when the NET4DW platform is created, may be needed for its proper creation and operation.

In addition, the digital entities (D-XX) used in the NET4DW and the NET4DW operations may require privacy preservation. In particular, the DW operations may need to be isolated from the hosting networks. Therefore, the hosting platforms discussed in this application may be used for providing in-network DWs as well.

One technical problem that is addressed in this application is the creation an isolated hosting platform (HOP) for digital entities (D-XX) inside the hosting network which may instantiate the entities when needed. The functions in the hosting network to create the hosting platform (referred to as Hosting Network Function—HNFs) and the functions inside the hosting platform (referred to as HOP Network Functions—HPFs) which may enable the creation digital entities (D-XX), including D-Users, are also included.

This application also provides different options that the network operator may use to create the hosting platforms (HOPs). Platforms can take various forms, such as a single-entity platform like a D-User platform, or a multi-entity platform like a multi-D-User platform, a NET4DW platform, or an isolated function module within the hosting network. Creation procedures are outlined separately for each case, along with descriptions of the functional architecture of the platform, including its main functions and interfaces.

The hosting network (NH) can be a trusted network or an untrusted network. In the untrusted case, this application may further provide methods to prevent the hosting network from accessing the digital entity data when a user requires processing to process data inside the HOP or when a user shares data with external devices outside the hosting network, such as 3^{rd} parties.

In addition, in the untrusted case, this application may provide methods to create the hosting platform (HOP) to prevent the hosting network (HN) from accessing information about the external servers the digital entities (such as D-User) access.

In addition, in the untrusted case, this application describes how the HOP may be created to anonymously access external servers (or 3^{rd} party servers) and also prevent the hosting network to access this information.

### 6.8. Communication Network System

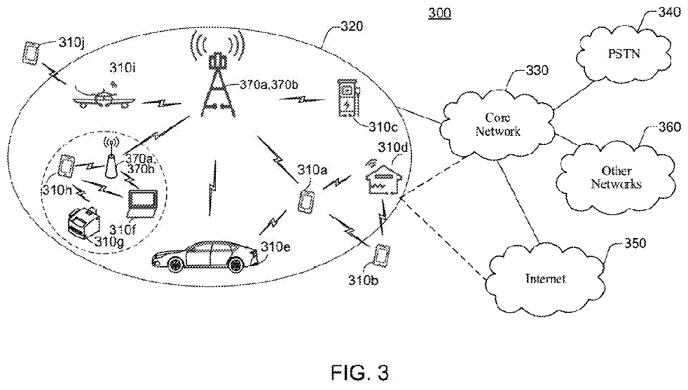

Referring to FIG. 3, as an illustrative example without limitation, a simplified schematic illustration of a communication network system is provided. The communication system 300 comprises a radio access network (RAN) 320. The radio access network 320 may be a next generation (e.g. sixth generation (6G) or later) radio access network, or a legacy (e.g. 5G, 4G, 3G or 2G) radio access network. One or more communication electronic devices (ED), including for example User Equipment (UE), 310a, 310b, 310c, 310d, 310e, 310f, 310g, 310h, 310i, 310j (generically referred to as 310) may be interconnected to one another or connected to one or more network nodes (370a, 370b, generically referred to as 370) in the radio access network 320. A core network 330 may be a part of the communication system and may be dependent or independent of the radio access technology used in the communication system 300. Also, the communication system 300 comprises a public switched telephone network (PSTN) 340, the internet 350, and other networks 360.

6.9. Communication System with Wired and Wireless Elements

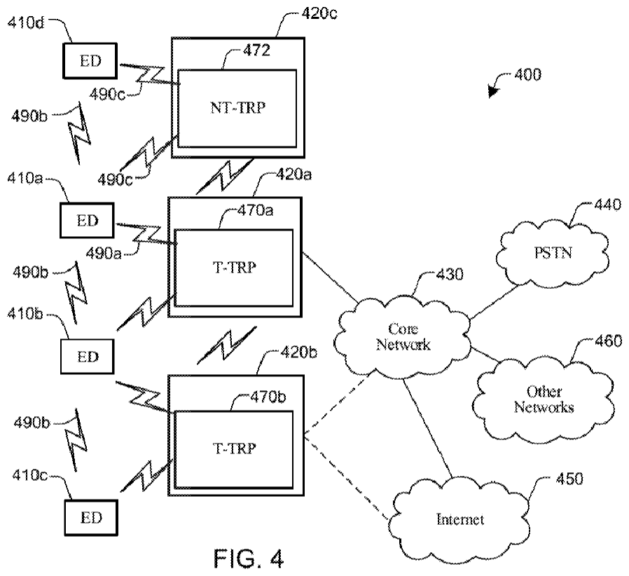

FIG. 4 illustrates an example communication system 400. In general, the communication system 400 enables multiple wireless or wired elements to communicate data and other content. The purpose of the communication system 400 may be to provide content, such as voice, data, video, and/or text, via broadcast, multicast, groupcast, unicast, etc. The communication system 400 may operate by sharing resources, such as carrier spectrum bandwidth, between its constituent elements. The communication system 400 may include a terrestrial communication system and/or a non-terrestrial communication system. The communication system 400 may provide a wide range of communication services and applications (such as earth monitoring, remote sensing, passive sensing and positioning, navigation and tracking, autonomous delivery and mobility, etc.). The communication system 400 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 4, the communication system 400 includes electronic devices (ED) 410a, 410b, 410c, 410d (generically referred to as ED 410, which may include User Equipment (UE)), radio access networks (RANs) 420a, 420b, a non-terrestrial communication network 420c, a core network 430, a public switched telephone network (PSTN) 440, the Internet 450, and other networks 460. The RANs 420a, 420b include respective base stations (BSs) 470a, 470b, which may be generically referred to as terrestrial transmit and receive points (T-TRPs) 470a, 470b. The non-terrestrial communication network 420c includes an access node 472, which may be generically referred to as a non-terrestrial transmit and receive point (NT-TRP) 472.

Any ED 410 may be alternatively or additionally configured to interface, access, or communicate with any T-TRP 470a,470b and NT-TRP 472, the Internet 450, the core network 430, the PSTN 440, the other networks 460, or any combination of the preceding. In some examples, ED 410a may communicate an uplink and/or downlink transmission over a terrestrial air interface 490a with T-TRP 470a. In some examples, the EDs 410a, 410b, 410c, and 410d may also communicate directly with one another via one or more sidelink air interfaces 190b. In some examples, ED 410d may communicate an uplink and/or downlink transmission over a non-terrestrial air interface 190c with NT-TRP 472.

The air interfaces 490a and 490b may use similar communication technology, such as any suitable radio access technology. For example, the communication system 400 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 490a and 490b. The air interfaces 490a and 490b may utilize other higher dimension signal spaces, which may involve a combination of orthogonal and/or non-orthogonal dimensions.

The non-terrestrial air interface 490c can enable communication between the ED 410d and one or multiple NT-TRPs 472 via a wireless link or simply a link. For some examples, the link is a dedicated connection for unicast transmission, a connection for broadcast transmission, or a connection between a group of EDs 410 and one or multiple NT-TRPs 472 for multicast transmission.

The RANs 420a and 420b are in communication with the core network 430 to provide the EDs 410a, 410b, and 410c with various services such as voice, data, and other services. The RANs 420a and 420b and/or the core network 430 may be in direct or indirect communication with one or more other RANs (not shown), which may or may not be directly served by core network 430, and may or may not employ the same radio access technology as RAN 120a, RAN 420b or both. The core network 430 may also serve as a gateway access between (i) the RANs 420a and 420b or EDs 410a 110b, and 410c or both, and (ii) other networks (such as the PSTN 440, the Internet 450, and the other networks 460). In addition, some or all of the EDs 410a, 410b, and 410c may include functionality for communicating with different wireless networks over different wireless links using different wireless technologies and/or protocols. Instead of wireless communication (or in addition thereto), the EDs 410a, 410b, and 410c may communicate via wired communication channels to a service provider or switch (not shown), and to the Internet 450. PSTN 440 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 410a, 410b, and 410c may be multimode devices capable of operation according to multiple radio access technologies, and incorporate multiple transceivers necessary to support such.

### 6.10. Electronic Device (ED) and T-TRP/NT-TRP

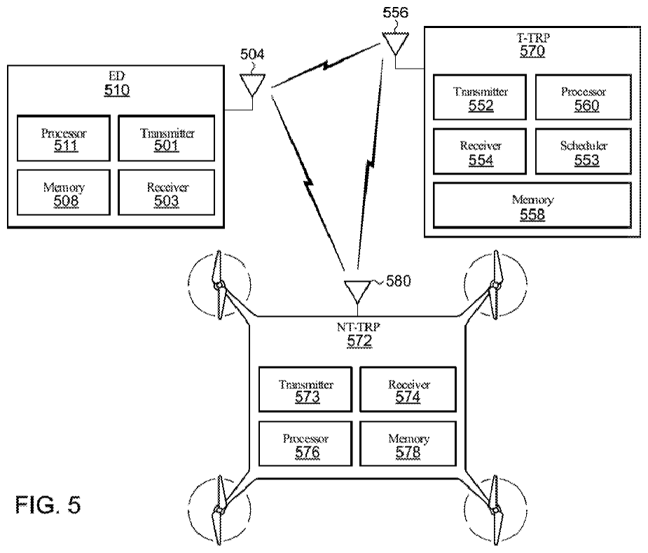

FIG. 5 illustrates another example of an ED 510 and a base station 570a, 570b 5and/or 570c. The ED 510 is used to connect persons, objects, machines, etc. The ED 510 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 510 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 510 may be referred to using other terms. The base station 570a and 570b is a T-TRP and will hereafter be referred to as T-TRP 570. Also shown in FIG. 5, a NT-TRP will hereafter be referred to as NT-TRP 572. Each ED 110 connected to T-TRP 570 and/or NT-TRP 572 can be dynamically or semi-statically turned-on (i.e., established, activated, or enabled), turned-off (i.e., released, deactivated, or disabled) and/or configured in response to one of more of: connection availability and connection necessity.

The ED 510 includes a transmitter 501 and a receiver 503 coupled to one or more antennas 504. Only one antenna 504 is illustrated to avoid congestion in the drawing. One, some, or all of the antennas 504 may alternatively be panels. The transmitter 501 and the receiver 503 may be integrated, e.g. as a transceiver. The transceiver is configured to modulate data or other content for transmission by at least one antenna 504 or network interface controller (NIC). The transceiver is also configured to demodulate data or other content received by the at least one antenna 504. Each transceiver includes any suitable structure for generating signals for wireless or wired transmission and/or processing signals received wirelessly or by wire. Each antenna 504 includes any suitable structure for transmitting and/or receiving wireless or wired signals.

The ED 510 includes at least one memory 508. The memory 508 stores instructions and data used, generated, or collected by the ED 110. For example, the memory 508 could store software instructions or modules configured to implement some or all of the functionality and/or embodiments described herein and that are executed by one or more processing unit(s) (e.g., a processor 510). Each memory 508 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 510 may further include one or more input/output devices (not shown) or interfaces (such as a wired interface to the Internet 350 in FIG. 3). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 510 includes the processor 511 for performing operations including those operations related to preparing a transmission for uplink transmission to the NT-TRP 572 and/or the T-TRP 570; those operations related to processing downlink transmissions received from the NT-TRP 572 and/or the T-TRP 570; and those operations related to processing sidelink transmission to and from another ED 510. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 503, possibly using receive beamforming, and the processor 511 may extract signaling from the downlink transmission (e.g. by detecting and/or decoding the signaling). An example of signaling may be a reference signal transmitted by the NT-TRP 572 and/or by the T-TRP 570. In some embodiments, the processor 511 implements the transmit beamforming and/or the receive beamforming based on the indication of beam direction, e.g. beam angle information (BAI), received from the T-TRP 570. In some embodiments, the processor 511 may perform operations relating to network access (e.g. initial access) and/or downlink synchronization, such as operations relating to detecting a synchronization sequence, decoding and obtaining the system information, etc. In some embodiments, the processor 511 may perform channel estimation, e.g. using a reference signal received from the NT-TRP 570 and/or from the T-TRP 570.

Although not illustrated, the processor 511 may form part of the transmitter 501 and/or part of the receiver 503. Although not illustrated, the memory 508 may form part of the processor 511.

The processor 511, the processing components of the transmitter 501, and the processing components of the receiver 503 may each be implemented by the same or different one or more processors that are configured to execute instructions stored in a memory (e.g. in the memory 508). Alternatively, some or all of the processor 511, the processing components of the transmitter 501, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 570 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 570 may refer to the forgoing devices or refer to apparatus (e.g. a communication module, a modem, or a chip) in the forgoing devices.

In some embodiments, the parts of the T-TRP 570 may be distributed. For example, some of the modules of the T-TRP 570 may be located remote from the equipment that houses the antennas 256 for the T-TRP 570, and may be coupled to the equipment that houses the antennas 556 over a communication link (not shown) sometimes known as front haul, such as common public radio interface (CPRI). Therefore, in some embodiments, the term T-TRP 570 may also refer to modules on the network side that perform processing operations, such as determining the location of the ED 510, resource allocation (scheduling), message generation, and encoding/decoding, and that are not necessarily part of the equipment that houses the antennas 556 of the T-TRP 570. The modules may also be coupled to other T-TRPs. In some embodiments, the T-TRP 570 may actually be a plurality of T-TRPs that are operating together to serve the ED 510, e.g. through the use of coordinated multipoint transmissions.

The T-TRP 570 includes at least one transmitter 552 and at least one receiver 554 coupled to one or more antennas 556. Only one antenna 256 is illustrated to avoid congestion in the drawing. One, some, or all of the antennas 256 may alternatively be panels. The transmitter 552 and the receiver 554 may be integrated as a transceiver. The T-TRP 570 further includes a processor 560 for performing operations including those related to: preparing a transmission for downlink transmission to the ED 510, processing an uplink transmission received from the ED 510, preparing a transmission for backhaul transmission to the NT-TRP 572, and processing a transmission received over backhaul from the NT-TRP 572. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 511 may also perform operations relating to network access (e.g. initial access) and/or downlink synchronization, such as generating the content of synchronization signal blocks (SSBs), generating the system information, etc. In some embodiments, the processor 560 also generates an indication of beam direction, e.g. BAI, which may be scheduled for transmission by a scheduler 553. The processor 260 performs other network-side processing operations described herein, such as determining the location of the ED 510, determining where to deploy the NT-TRP 572, etc. In some embodiments, the processor 560 may generate signaling, e.g. to configure one or more parameters of the ED 510 and/or one or more parameters of the NT-TRP 572. Any signaling generated by the processor 560 is sent by the transmitter 552. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 553 may be coupled to the processor 560. The scheduler 553 may be included within or operated separately from the T-TRP 170. The scheduler 553 may schedule uplink, downlink, sidelink, and/or backhaul transmissions, including issuing scheduling grants and/or configuring scheduling-free (e.g., “configured grant”) resources. The T-TRP 170 further includes a memory 558 for storing information and data. The memory 258 stores instructions and data used, generated, or collected by the T-TRP 170. For example, the memory 558 could store software instructions or modules configured to implement some or all of the functionality and/or embodiments described herein and that are executed by the processor 560.

Although not illustrated, the processor 560 may form part of the transmitter 552 and/or part of the receiver 554. Also, although not illustrated, the processor 560 may implement the scheduler 553. Although not illustrated, the memory 558 may form part of the processor 560.

The processor 560, the scheduler 553, the processing components of the transmitter 252, and the processing components of the receiver 554 may each be implemented by the same or different one or more processors that are configured to execute instructions stored in a memory, e.g. in the memory 558. Alternatively, some or all of the processor 560, the scheduler 553, the processing components of the transmitter 552, and the processing components of the receiver 554 may be implemented using dedicated circuitry, such as a programmed FPGA, a hardware accelerator (e.g., a GPU or AI accelerator), or an ASIC.

Although the NT-TRP 572 is illustrated as a drone only as an example, the NT-TRP 572 may be implemented in any suitable non-terrestrial form, such as satellites and high altitude platforms, including international mobile telecommunication base stations and unmanned aerial vehicles, for example. Also, the NT-TRP 572 may be known by other names in some implementations, such as a non-terrestrial node, a non-terrestrial network device, or a non-terrestrial base station. The NT-TRP 572 includes a transmitter 572 and a receiver 574 coupled to one or more antennas 580. Only one antenna 580 is illustrated to avoid congestion in the drawing. One, some, or all of the antennas may alternatively be panels. The transmitter 572 and the receiver 574 may be integrated as a transceiver. The NT-TRP 572 further includes a processor 576 for performing operations including those related to: preparing a transmission for downlink transmission to the ED 510, processing an uplink transmission received from the ED 510, preparing a transmission for backhaul transmission to T-TRP 570, and processing a transmission received over backhaul from the T-TRP 570. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 570. In some embodiments, the processor 576 may generate signaling, e.g. to configure one or more parameters of the ED 510. In some embodiments, the NT-TRP 572 implements physical layer processing, but does not implement higher layer functions such as functions at the medium access control (MAC) or radio link control (RLC) layer. As this is only an example, more generally, the NT-TRP 572 may implement higher layer functions in addition to physical layer processing.

The NT-TRP 572 further includes a memory 578 for storing information and data. Although not illustrated, the processor 576 may form part of the transmitter 572 and/or part of the receiver 574. Although not illustrated, the memory 578 may form part of the processor 576.

The processor 576, the processing components of the transmitter 572, and the processing components of the receiver 574 may each be implemented by the same or different one or more processors that are configured to execute instructions stored in a memory, e.g. in the memory 578. Alternatively, some or all of the processor 576, the processing components of the transmitter 572, and the processing components of the receiver 574 may be implemented using dedicated circuitry, such as a programmed FPGA, a hardware accelerator (e.g., a GPU or AI accelerator), or an ASIC. In some embodiments, the NT-TRP 572 may actually be a plurality of NT-TRPs that are operating together to serve the ED 510, e.g. through coordinated multipoint transmissions.

The T-TRP 570, the NT-TRP 572, and/or the ED 510 may include other components, but these have been omitted for the sake of clarity.

### 6.11. Electronic Device Modules

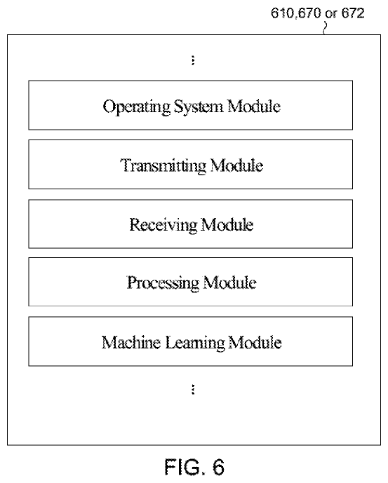

One or more steps of the embodiment methods provided herein may be performed by corresponding units or modules, according to FIG. 6. FIG. 6 illustrates units or modules in a device, such as in the ED 610, in the T-TRP 670, or in the NT-TRP 672. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit include a programmed FPGA, a GPU, or an ASIC. For instance, one or more of the units or modules may be logical such as a logical function performed by a circuit, by a portion of an integrated circuit, or by software instructions executed by a processor. It may be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 610, the T-TRP 670, and the NT-TRP 672 are known to those of skill in the art. As such, these details are omitted here.

The solution described in the application is applicable to a next generation (e.g. sixth generation (6G) or later) network, or a legacy (e.g. 5G, 4G, 3G or 2G) network.

In possible embodiments, the proposed System architecture is defined to support XaaS services by using techniques such as Network Function Virtualization and Network Slicing. The System architecture utilizes service-based interactions between services.

### 6.12. Service-Based Architecture

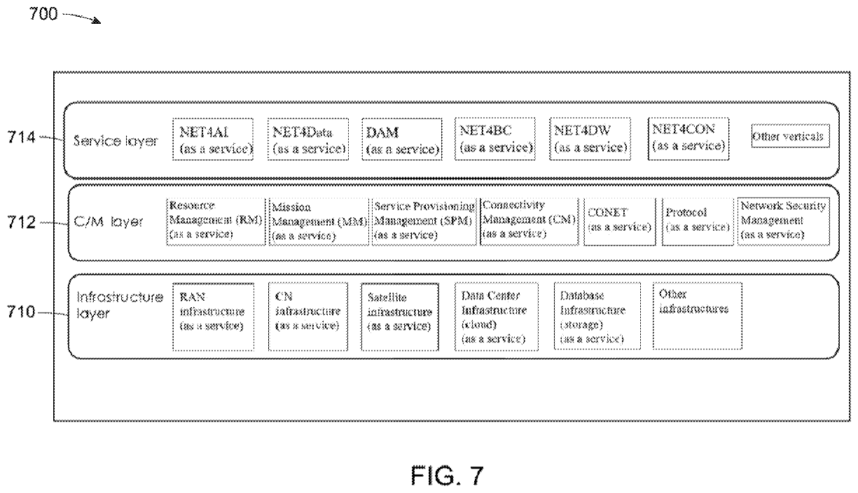

In possible embodiments, the network system 700, which can be a network system (such as a 6G network system), leverages service-based architecture and XaaS concept. XaaS services in the network System are categorized into three layers 710, 712, 714. A possible embodiment of a System conceptual structure is shown in FIG. 7.

In possible embodiments, Infrastructure Layer 710 includes infrastructures supporting network services (such as a 6G services). Among them are wireless networks (RAN, CN) infrastructures, Cloud/data center infrastructures, satellite networks, storage/database infrastructures, and sensing networks, and etc. These infrastructures can be provided by a single provider or by multiple providers.

Each of the infrastructures may have its control and management functions, denoted as C/M functions, for infrastructure management. Each of these infrastructures can be one type of Infrastructure as a Service.

In possible embodiments, Control and Management (C/M) layer 712 may include control and management services of the System. They are developed and deployed by using slicing techniques and utilizing resource provided by infrastructure layer. Services in Control and Management (C/M) layer 712 may include:
A Resource Management module comprising Resource Management (RM) as a Service functions, which may provide a capability of life-cycle management of a variety of slices and over-the-air resource assignment to wireless devices;
A mission module defined as a service provided to customers by the System. A mission can be a set of services which is provided by a single XaaS service or a type of services that needs contributions from multiple XaaS services;
A Mission Management module comprising Mission Management (MM) as a Service functions, which may provide a capability to program provisioning of XaaS services at Service Layer to provide mission services;
A CONET module comprising Confederation Network (CONET) as a Service functions, which may provide a capability to enable multiple partners to jointly provide services. This capability is provided by confederation formation, mutual authentication, mutual authorization among partners and negotiation of agreement on recording and retracing of selected actions performed by partners, in order to assure a trustworthy environment of System operations
A Service Provisioning Management module functions, which comprises Service Provisioning Management (SPM) as a Service, to provide a capability of control and management of service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world;
A Connectivity Management module, which comprises Connectivity Management (CM) as a Service functions, to leverage connectivity management functions of older networks such as 5G, but with extension to include digital world;
A Protocol as a Service module, which comprises Protocol as a Service functions to provide a capability to design service customized protocol stacks for identified interfaces. The protocol stacks can be pre-defined for on-demand selection, or can be on-demand designed;
A Network Security as a Service module, which comprises Network Security as a Service functions to provide a capability for owners of infrastructures to detect potential security risks of their infrastructures;
A XaaS module, comprising XaaS services in the C/M Layer support control and management 712 of the System itself and also provide support to verticals if requested. One example is that RM service can serve RAN for over-the-air resource management and can also provide service to a vertical for the vertical's over-the-air resource allocation to its end-customers. The XaaS in C/M layer can be deployed by using slicing technique.

Service Layer 714 may include services which provide services to customers. In the System structure 700, the following modules may be included:
An AI service module, denoted as NET4AI as a Service. Artificial Intelligence service functions provide AI capability to support a variety of AI applications;
A Data Analytics Module (DAM) comprising Service of data collection, data sanitization, data analysis and data delivery functions, denoted as DAM as a Service, this service provides a capability of lifecycle management of statistic data, including acquisition, de-privatization, analysis and delivery of data which are information statistic data from any types of sensors, devices, network functions etc.;
A NET4Data module, comprising Service of storage and sharing of data, denoted as NET4Data as a Service. This service module provides a capability to trustworthily storage and share data under the control of owners of data and following recognized authorities' regulations on control of identified data;
A NET4DW module, comprising Service to provide digital world, denoted as NET4DW as a Service. The Digital World module (or system) provide a capability to construct, control and manage digital world. Digital world is defined as digital realization of physical world;
A block chain module, comprising block chain service is denoted as NET4BC as a Service. A connectivity service is denoted as NET4Con as a Service. This service provides a capability to support block chain services;
A NET4CON module, comprising Enhanced connectivity service, e.g., network for connectivity (NET4CON) as a service. This service provides a capability to support exchange of messages and data among new services.

All XaaS services at this Layer may developed and deployed by using resources provided in the infrastructure and utilizing Network Function Virtualization and Slicing techniques. The capability of each of the services is provided by its control and management (C/M) functions and service specific data process functions.

In addition to support XaaS services at Service Layer 714, the System 700 leverages previous networks, such as 5G System for provisioning of vertical services. The difference between XaaS services and other verticals are that a vertical is a pure customer which needs other XaaS services to enable its operation, while each of XaaS services provide their capabilities to customers.

Any pair of XaaS services of the System may also be mutual customer and provider of each other. Some examples are that an infrastructure owner providing its resource to Xaas services in the Service Layer 714 and C/M Layer 712; RM services may need the capabilities provided by NET4AI, DAM and NET4DW for its resource management for vertical slicing; CONET service and NET4Data service may need the capability provided by NET4BC for their operation.

The structure and associated modules/platform of the proposed System may provide the following functionalities and advantages:

Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, mission management service, etc.

Allow joint operation of the System by multiple partners;

Define Data Plane of the System which includes processing functions of data plane of XaaS services. Programing the interconnection of these functions, by mission management service, enables to support a variety of customized customer services;

Simplify System architecture by categorizing basic control services and management services and combining them as basic XaaS services in Control and Management (C/M) Layer;

Define C/M Plane of the System which includes C/M functions in XaaS services and may include CP (e.g., AMF) depending on implementation options;

Define Basic Architecture Structure (BAS) which is a unified basic structure with minimized number of interfaces and is independent of types of infrastructures.

Simplify standardization, development and deployment of the System using the BAS concept, while supporting a variety of infrastructure deployment scenarios;

Adapt to a variety of deployment scenarios by applying the BAS or a subset of it to infrastructures based on capability, capacity and requirement of the infrastructure networks;

Leverage SBI interface concept and apply SBI interaction in both C/M plane and data plane;

Simplify SBI interfaces by introducing trustworthy GWs in Data Plane and C/M Plane of the System;

Improve trustworthiness from perspectives of operation of the System by introducing CONET capability, NET4BC capability and anonymous service provisioning provided by the trustworthy GWs in the C/M plane and data plane of the System;

Improve trustworthiness from perspective of end customer privacy protection by unified mutual authentication, IDM, data sanitization and etc. provided by SPM service, DAM service and Block Chain service;

Simplify roaming management of wireless devices, in physical world and digital world, by unified authentication including all participated partners and customers.

Support multiple development paths from known systems, such as 5G Systems, to future systems, such as 6G Systems, by defining multiple architecture options without incurring much efforts due to the introduction of the BAS concept;

Support backward compatibility by utilizing benefits of SBA and its add-on feature. For, example, 5G users can use the 6G System to access 5G services;

Support future extension by adding new XaaS services with minimized impact on standardization and deployment, due to the introduced anonymous service provisioning concept implemented in trustworthy GWs in C/M plane and in data plane.

### 6.13. D-User and User Controlled and Managed (UCM) Services

Since any information provided from a user access device (UAD), or a user application can be regarded as personal data, the term ‘user’ is used to represent one or more of physical user (P-User), user equipment (UE), User access device (UAD) or user applications.

A Physical User (P-User) correspond to a real, physical entity using a network service, and can therefore correspond to a human, an animal or a machine such as a robot.

A user equipment (UE) can correspond to the equipment used by the P-User to interact with the network. The UE may consist of two parts, user personal device (UPD) where all user applications and other information is kept and User Access Device (UAD) which is the device used to access the network. UAD may be a public device which may be used by multiple users. The various sensors connected to the device may be considered as part of UPD as they carry user information. Therefore, UE may also correspond to a user access device (UAD), user applications and sensors.

The term ‘Digital User’ (D-User) refers to a digital representation of a user and may be described as a digital representation of one or more of:
real or physical user (P-User) such as a human, animal, or a robot,
P-User access device (UAD),
User equipment (UE),
UE sensors, and
user application.

The term ‘D-Rep’ refers to a Digital Representation and corresponds to a type of Digital Entity (D-XX). A D-Rep is the digital representation of any real physical objects or set of objects. The D-Reps can correspond to replicas or digital representatives of physical devices, including vehicles such as cars and robots, provided with connectivity to the network and sensors. Other types of digital entities include digital infrastructures (D-Inf) or digital networks (D-Net). A D-User is also another type of digital entity. The D-Users can be digital representatives of real or physical users (P-Users); P-User access device (UAD); User Equipment (UE); UE sensors; physical devices, and user applications.

Any type of Digital Entity (DE/D-XX), such as D-Users or a D-Reps, may be placed, that is, instantiated, stored, maintained and controlled, inside a Hosting Platform (HOP) of any type of network (hosting network) such as a WiFi network, a mobile network (RAN or CN) or any data network (DN), including 6G networks. When a network provides the resources to create and maintain HOPs, the network can be referred to as a Hosting Network (HN).

The following description in this document describes the services provided using a digital user as a special case of the services provided by a digital entity. Therefore, the methods and procedures describes in the document can be applied similarly to any digital entity which can be understood by a person skilled in the art.

For example, similar to user controlled and managed services provided using a D-User, there are digital entity customer controlled and managed services using a digital entity.

In possible embodiments, an in-network digital entity, such as a D-User (i.e., a D-User hosted in a HOP) may act on behalf of the user and provide digital entity services which can be termed as Entity-Controlled and Managed (ECM) services (or UCM, for User Controlled and Managed Services—when the digital entity is a digital user). For example, these can include: analyzing and processing user data, providing a computing platform to run user applications, providing AI services to the user, home control of the user, financial and health control, handling data sharing with the 3^{rd} parties, processing user data, acting on behalf of the user, obtaining content from 3^{rd} party content providers, interacting with the network to obtain better communication services, interacting with the network to obtain network data, facilitating the interactions with 3^{rd} party servers, such as user accessing application servers and making payment and receiving payments.

Some of these actions are very personal to an entity, such as a user and, therefore, exposure of the D-user data and operations may be limited or prevented from the hosting network. Such protection may not be needed if the hosting network is a trusted network. However, the trustworthiness may depend on the type of the services or actions the D-User is performing. The services the D-User provides (i.e., UCM services) may be categorized into three types:
D-User acting on behalf of the physical user by carrying out in-network processing, such as processing data, computing tasks such as running its own applications, analysis and AI, controlling user devices and health.
D-User facilitating interactions with 3^{rd} party entities (e.g., by providing privacy, sharing data, obtaining content from the content providers, financial transactions and establishing agreements and negotiations)
D-User interacting with the hosting network to enhance services obtained from the hosting network or 3^{rd} parties (improve the QoS of the communication services, obtain network data and state such as loading and topology)

A hosting network operator (HNO) such as a Mobile Network Operator (MNO) may decide the type of D-User that needs to be created in the D-User platform of the Digital World, based on the services the network needs to provide to the user.

In possible embodiments, a method to create an isolated Hosting Platform (HOP) for Digital Entities (DEs or D-XX) representing real entities requiring privacy may be provided. In some embodiments, the real entities represented by the DEs may comprise physical entities existing in the real (i.e. non-digital) world. In other embodiments, a real entity may comprise programs, applications or functions separate from the HOP. Some examples of real entities include physical processing devices, physical users (P-Users); P-User access device (UAD); organizations; infrastructures; buildings, one or more network functions, application servers; User Equipment (UE); UE sensors; and user applications. A platform can refer to a set of software and/or hardware components that provide a foundation upon which other applications and services can be built. In the context of the present disclosure, a Hosting Platform may comprise hardware components, such as servers including memory and processors, and software functions, such as data plane and Control/Management Plane functions, that facilitate the deployment, maintenance, communications, and management of Digital Entities. The HOP can host different types of Digital Entities (D-XX), such as digital representatives of users (D-User), of objects (D-Rep), of infrastructures (D-Inf) or of any type of entity, including software applications or business processes. In possible embodiments, the HOP may be provided as an isolated container inside the hosting network. An isolated container may encapsulate the different functions that the platform may need to run, including libraries, system tools, runtime, and settings, into a single package. The different HOPs hosted by the hosting network may thus be isolated from each other and from the underlying hosting network. A network which provides the resources for the creation and maintenance of hosting platforms for digital entities can be referred to as a “hosting network”. A request, such as a message or command, may be sent from a processing device to a hosting network, such as a 5G or 6G mobile network, to request the creation of a HOP. A request may, for example, come from a city that wants to replicate all of its infrastructure in an isolated platform, from a factory that wants to replicate a production line, or from a public utility company that wants to replicate its electricity distribution network. The hosting platform may provide the necessary resources, including memory space and processors, and functions that allow for the creation, management, maintenance of digital entities, and control access to the data and applications used by these digital entities. The hosting platform may ensure the confidentiality of operations and data accessed or generated by the digital entities.

When the digital entity is a user (D-User), the user may represent one or more of a user equipment, user application or the physical user. An in-network D-User can be used for many user-controlled and managed (UCM) services which include in-network data storage, in-network processing (e.g., run applications or specific network functions for evaluations, computing, data analysis and AI schemes), interacting with the hosting network to improve the communication services provided by the hosting network to the user, monitoring, controlling and managing user devices, and providing privacy for interactions with external application servers (e.g. data sharing, negotiations for agreements, financial transactions, content downloading, search engines, accessing the web sites).

In some embodiments, the isolated container may be a software container in the hosting network, using the hosting network hardware controlled, managed and orchestrated by the hosting network operator (HNO).

In some embodiments, the isolated container may be created using an enclave created in a confidential computing environment (CEE), such as a TEE, which is isolated from the hosting network. The enclave may create HOPs and may perform Life Cycle Management (LCM) of the functions inside the HOPs according to instructions provided. The instructions may be provided to the container's manager as a blueprint of the HOP wherein the blueprint may contain the descriptions of the functions, their interfaces and configuration attributes, descriptions of the Digital Entities that can be supported including blueprints for their creation, detailed steps for the creation, LCM and operation of the Digital Entities, resource requirements and QoS requirements for the messaging to and from the HOP functions.

In some embodiments, the method may comprise identifying different privacy levels required by the Digital Entities, including for example for D-user modules, and associated technical solutions to provide these privacy preservation levels.

### 6.14. Privacy for UCM Services

User privacy may be an important factor for users, since users currently have to share their personal data with many organisations including, for example, Over The Top (OTTs) such as Google™, Amazon™, YouTube™, etc. and other service providers such as shops, equipment providers etc., in order to get various services from those organisations.

Therefore, possible embodiments may provide methods to create a digital entity, such as a D-User, considering these privacy issues, and to obtain a cost effective and improved service from the network. Many factors may need to be considered when creating a D-User inside a network to give the user the control and management (UCM) capabilities on the services the D-User obtains from the hosting network.

Since D-User may act on behalf of the user, the actions taken by the D-User (e.g., analyzing and processing user data, providing a computing platform, providing AI services to the user, home control, or financial and health control) may not be exposed to the hosting network and D-User functions may need to be isolated from the hosting network. This may be important when the hosting network is not a trusted party. Depending on the type of UCM services, the isolation the D-User required from the hosting network may be different.

In addition, the hosting network may provide some added capabilities to the user when the user is communicating with 3^{rd} parties, e.g. prevent privacy and identity leaking to the 3^{rd} parties and to the hosting network. This may depend on the type of interaction the user is having with the 3^{rd} parties which can include user accessing an application server or making payments or receiving payments to/from 3^{rd} parties.

### 6.15. Privacy Issues Solved Using D-User and a Hosting Platform (HOP)

Digital Entities, such as D-Users, may be isolated from the hosting network depending on the trust level the hosting operator would like to offer. For example, there may be a need to prevent the hosting network from accessing the digital entity data. In addition, a DE, such as a D-User, may need to be isolated from external networks accessed by the user.

Furthermore, the user may need protection from malicious attacks to prevent the hosting network from accessing private user data.

Depending on isolation requirements, different solutions may be implemented. The complexity and/or cost of providing privacy to a D-User may depend on the level of trust the host is willing to provide. For example, a hosting network may offer trust levels such as those described below.

The hosting network can provide services as a trustworthy party to the user or as an untrustworthy party. Table 1 provides examples of privacy preserving levels a user may require for different types of UCM services. In order to meet those requirements, a D-User may need to be instantiated inside a separate network module which can be referred to as a ‘Hosting Platform’ (HOP).

The HOP is preferably isolated from the hosting network and the required level of isolation depends on both the trustworthiness of the hosting network and the type of UCM services the D-User is providing to the P-User. In addition, the HOP may help the user preserve privacy when accessing external servers. These cases are summarised in Table 1.

In Table 1, a trusted network (T) means that a user needs to trust the network which provides the particular service/capability to the user. On the other hand, an untrusted network (U) means the user can obtain services from the network while preserving privacy, without leaking user information to the network providing the service. Preserving privacy of the real entity by the network may be performed by 1) preventing visibility of real entity and/or DE data, 2) preventing visibility of processing of the real entity data and/or DE data or by preventing visibility of execution of specific functions of the real entity from any other entity using the Hosting Network or from any other external networks.

TABLE 1
Example levels of privacy that can be provided by the hosting network for UCM services

| | Exposure to hosting | | | | | | | | |
|---|---|---|---|---|---|---|---|---|---|
| | network & | | | | Exposure to External | | | | |
| | Trustworthiness (T/U) | | | | data Network (e.g. | | | | |
| | | | C/M | | Server) & Trustworthiness | | | | |
| Use | | Data + | Operation/ | Destination | | | User | D-User capability/ | Requirement/ |
| case | T/U | Processing | Action | Address | T/U | Data | ID | UCM service | Solution |
| 0 | U | No, | Yes | Yes | T | Yes | Yes | Network provides | Current system. |
| | | Encrypted | | | | | | transport service. | No privacy |
| | | | | | | | | | solution other |
| | | | | | | | | | than UE |
| | | | | | | | | | filtering. |
| 1 | T | No, | Yes | Yes | U | Yes | No | Can access 3^{rd} party | ID change by the |
| | | Encrypted | | | | | | servers | host. |
| | | | | | | | | anonymously. | |
| 2 | T | Yes | Yes | Yes | U | FHE | No | User data can be | ID change and |
| | | (DPF) | | | | | | processed inside | data de- |
| | | | | | | | | the network (data | privatized by |
| | | | | | | | | accessible to host) | host. |
| | | | | | | | | as needed by the | Data processing |
| | | | | | | | | user. | done by host. |
| | | | | | | | | USER ID change | |
| | | | | | | | | and data de- | |
| | | | | | | | | privatized by host. | |
| 3 | U | No | Yes | Yes | U | FHE | No | D-User can process | User data is not |
| | | | | | | | | data. Host does not | accessible to |
| | | | | | | | | have access to user | host. |
| | | | | | | | | data. | |
| 4 | U | No | Yes | No | U | FHE | No | Can access 3^{rd} party | HOP need to |
| | | | | | | | | servers | have a minimum |
| | | | | | | | | anonymously and | number of D- |
| | | | | | | | | without the host | Users (multi-D- |
| | | | | | | | | knowing which | User platform). |
| | | | | | | | | user accessed the | HOP changes the |
| | | | | | | | | 3^{rd} party server. | USER-ID. |
| 5 | U | No | No | No | U | FHE | No | Same as above. | The operations |
| | | | | | | | | Host does not know | inside the HOP |
| | | | | | | | | the operations a | are controlled by |
| | | | | | | | | user is taking | the user and the |
| | | | | | | | | inside D-User. | hosing network |
| | | | | | | | | | is unaware of |
| | | | | | | | | | them. |

### 6.16. HOP Requirements and Solutions/Use Cases

The HOP requirements and solutions for the cases indicated Table 1 are described below.

6.16.1. Current Model (No D-User, No Privacy from 3^{rd} Parties)

Current mobile networks act like transport systems for the user to access the external data networks/servers. Data may be encrypted end-to-end so only the user device and the application server have access to data and control of data. A user can filter the data they share with the 3^{rd} parties but, depending on the service they obtain, they might have to provide, for example, information about their identities and other valuable information. In addition, in current mobile networks, a user may not have any control or management over the services the user obtains from the network (i.e., no UCM service can be operated).

### 6.16.2.Use Case 1: Provide Anonymous Access to 3^{rd} Party Servers (Service Providing Network May be Trusted)

In a possible embodiment, the mobile network may hide the entity identity (ID change) so that users may access external servers anonymously. The network is trusted to keep access sites/server descriptions, other than for police tracking events. In this case, the HN is trustable by the entity associated with the corresponding DE.

Requirement: An external server should not be aware of which digital entity has accessed it.

Solution: The hosting network may perform an ID management function (IDMF) to change the source ID and the return address of the digital entity hosted in a HOP. However, the hosting network may know what server the digital entity has accessed (privacy leaks to the hosting network). The hosting network may include a Hosting Network Function (HNF) which facilitates access of the one or more DEs to access external servers anonymously by executing a IDentification Management Functions (IDMF), which change source identifiers (or source ID) s and/or response addresses associated with the one or more DEs. For example, the source ID and response addresses may correspond to IP addresses that could be used to trace back the identity of the Digital Entity, such as D-Users.

HOP requirement: The HOP may be an isolated network function module created using the infrastructure of the hosting network.

6.16.3.Use Case 2: Network Aware in-Network Processing (D-XX Exposed to the Trusted Network)

In a possible embodiment, processing data inside the hosting network may enable many services for an entity, such as AI services or service optimization solutions. The hosting network may provide the services but there is a risk of data and processing details being exposed to the hosting network.

Requirement: The Hosting Network may provide a data processing function (DPF) for the entity.

Solution: The host may provide a DPF for the entity. For example, one HNF of the hosting network may process the DE data (i.e. D-XX data, such as D-User data) inside the HOP by performing Data Processing Functions (DPF) inside the HOP. In this case, DE data (payload) is exposed to the hosting network but protected from external entities. The hosting network can additionally provide entity ID change similar to case 1, to protect the entity identity from 3^{rd} parties, but the hosting network may be aware of both the external server address and the payload.

HOP requirement: The HOP may be an isolated network function module created using the infrastructure of the hosting network.

6.16.4. Use Case 3: Network Unaware of in-Network Data Processing (D-XX Isolated from the Untrustworthy Hosting Network)

Unlike in case 2, DE data can be processed inside the hosting network without exposing DE data to the hosting network. Anonymous access to external/3^{rd} party servers can be provided additionally as in case 1. However, the hosting network may be aware of the external server address).

Requirement: The Hosting Network may need to provide an isolated data processing function (DPF) inside the hosting network to the entity and ID change function to access external servers anonymously.

Solution: The Hosting Network may provide a DPF or a Digital Entity, such as a D-User, inside an isolated enclave.

HOP requirement: The HOP may be an isolated enclave in a confidential computing environment (CEE). A HPF of the Hosting Network (HN) may prevent the HN from accessing the DE data by having the container in which the HOP is instantiated provided in a Trusted Executive Environment (TEE), corresponding to a confidential computing environment (CEE) located inside the HN. The container may thus be isolated from the operating systems (OS) of the HN. The HPF may thus prevent the HN from accessing the data of the digital entity (DE data) when the DE (or D-XX) processes data inside the HOP or when the DE (or D-XX) shares DE data (or D-XX data) with other entities external to the HN.

6.16.5. Use Case 4: Access to 3^{rd} Parties Anonymously (Network Unaware)-D-XX Isolated from Untrustworthy Hosting Network)

Anonymous access to external/3^{rd} party servers without exposing external server address to the hosting network. In addition, host-unaware in-network data processing can be done similar to case 3.

Requirement: The Hosting Network may need to provide an isolated IDMF (not accessible to the hosting network) inside the hosting network to the entity.

Solution: The Hosting Network may provide an IDMF inside an isolated enclave. However, in order to carry out ID changes without knowledge of the hosting network, a minimum number of digital entities should be hosted in the isolated enclave, e.g. Multi-D-User platform. In addition, the hosting network can do in-network processing inside the enclave as in Case 3.

HOP requirement: The HOP may be an isolated enclave in a confidential computing environment (CEE) which can create at least K number of Digital Entities as the K-anonymous requirement described in L. Sweeney. “k-anonymity: a model for protecting privacy”. International Journal on Uncertainty, Fuzziness and Knowledge-based Systems, 10 (5), 2002; 557-570 which is hereby incorporated by reference in its entirety. In such embodiments, the HOP may have a minimum number of DE. For example, the K-anonymity model requirements proposed can be used to anonymize user communications to/from DNs (i.e., hosting network cannot know which user inside the HOP communicated with the DN). The K-Anonymity requirement can be summarised as “for every combination of identifying attributes in a dataset, there are at least “K minus 1” other people with the same attributes”. Therefore, the source ID may be changed with a randomized ID and also the return address may be randomized with a randomized location.

### 6.16.6. Use Case 5: Network Unaware Operations by the D-User

This case is similar to use case 4, but additionally, the hosting network is not aware of the type of operations the digital entity performs for its services (i.e. the services obtained by the entity are hidden to the hosting network).

Requirement: The Hosting Network may need to provide an isolated data processing function (DPF), an isolated IDMF and entire user service functions inside the HOP.

Solution: In addition to above case 4, Digital Entity (such as D-User) related functions are completely placed inside a multi-DE platform, e.g. a separate slice of the network is provided for the multi-entity hosting platform. A slice may refer to a logical network segment that is dynamically created to cater to specific service requirements, traffic types, or user groups within the broader physical network infrastructure. Once the HOP is created, the HOP may be given the capability of independent operation. For this purpose, when the HOP is created, a HOP manager function (HOP-M) may be created inside the HOP which can do the LCM DE (e.g. creation, modification and termination of Digital Entities) and common functions needed for the interaction of the DE functions with entities outside the DE (e.g. other platforms inside the HOP, hosting network functions, P-User and P-User devices, 3^{rd} party servers), privacy preserving functions when a D-User communicating with external entities.

HOP requirement: The HOP may be provided as an isolated enclave in a confidential computing environment.

### 6.17. Summary of Use Cases 1 to 5

In above use case 1 and use case 2, the hosting network can provide the UCM services described but the entity privacy is leaked to the hosting network. For example, an exposed D-User, e.g., using an infrastructure managed and controlled by the hosting network, can be used for these services.

In use cases 3, 4, and 5, different UCM services may be provided by using a DE installed inside the hosting network without entity functions or entity data being exposed to the network according to the privacy requirements for those cases.

Therefore, there may be at least two options for a network operator to provide services to digital entities.

### 6.17.1. Hosting Network Provides DE Services as a Trustworthy Entity (Cases 1 and 2):

In this case, only the entities (such as users) who can trust the hosting network would be interested in obtaining a service which limits the hosting network's ability to serve the general public. The hosting network may not need to provide strict isolation from the hosting network although it may have to provide full protection to the DE data and DE operations from exposing them to external entities (e.g. data consumers, servers, etc.) who interact with the DE or entity. In addition, Digital Entities need to be isolated from each other to protect their privacy. Furthermore, access to functions inside the HOP may be access-controlled using a GW in the C/M plane and a GW in the DP plane. The hosting network may use its own infrastructure to create an isolated software container (a HOP) for the DE and the hosting network may not need to provide a TEE like hardware isolation since hosting network is trustworthy. A container may consist of a standard unit of software that packages up code and all its dependencies.

6.17.2. Host Provides D-User Services as an Untrustworthy Network where Users do not have to Trust the Hosting Network (Cases 3, 4, and 5):

In this case, the hosting network may have to perform additional actions to isolate the DE from hosting network in which the HOP is provided. Therefore, the HOP may need to be created inside a confidential computing environment created inside the hosting network such as a TEE, and be preconfigured to be able to create the necessary functions inside the HOP and interact with the entities requiring DE services. In this case, hardware portion of the HOP may be created with a platform manager inside the HOP which may be able to create the other functions and the required interfaces for those functions.

In both cases, the DE should be isolated from each other and also privacy preserving techniques need to be established when accessing the external servers. Isolation from the hosting network may be required for the cases 3, 4 and 5.

### 6.18. HOP Placement

In possible embodiments, the hosting platform (HOP) can be placed inside a mobile network (MN), e.g. Radio Access Network (RAN), Multi-Access Edge Computing (MEC) network, or Core Network (CN), or it may be placed in any type of data network.

Keeping the HOP inside the mobile network (MN) may have many advantages compared to keeping it in a data network because:
Keeping the HOP closer to the entities (such as users) reduces the delay between the entities and their digital twin/digital entity;
All communications of a mobile go through the wireless network and therefore the wireless network is in a better position to provide services to digital entities. In contrast, a user has many options to choose a host in the data network and the communications with other data networks would not go through the selected host and selected host cannot provide all the services that a wireless network may provide;
When the host is located in a data network, the user might not have much visibility of the methods used by the host for preserving privacy because a host in the cloud may not be trustworthy as a network provider providing the mobile access to the user.

The general approach to the creation of a hosting platform (HOP) and generic hosting platform architecture is described below.

### 6.19. Generic HOP High Level Architecture

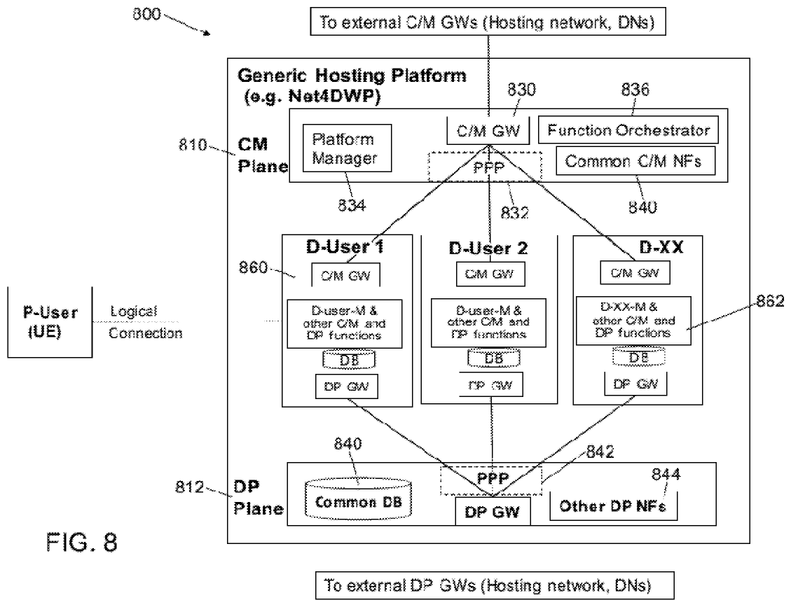

A high-level architecture of a generic hosting platform 800 is provided in FIG. 8. Some of the HOP Network Functions (HPFs) may include:
C/M plane functions 810 may be split into the following functionalities:
C/M gateway 830 which controls incoming and outgoing messages of internal C/M functions (access control, security and isolation)
C/M plane privacy preserving portal (PPP) 832 which may be included in the C/M GW
HOP manager function (HMF) 834
HOP's internal function orchestrator (HFO) 836
Common C/M network functions (NFs) 840 supporting operations of the Digital Entities (D-Users or any type of D-XX) 860.
DP functions 812 may also be split into a common database 840, PPP 842 and other DP NFs 844 to support operations of the Digital Entities (D-Users or any type of D-XX).

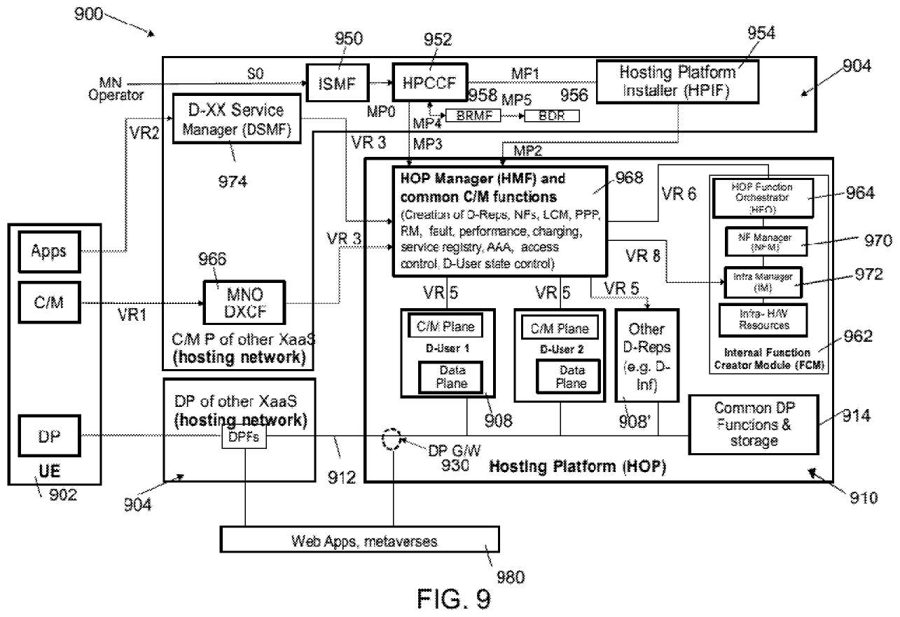

More details of these functions are provided later in this document. In the present disclosure, a gateway may refer to a network element that serves as an interface between different types of networks or protocols. Logical interfaces may be referred to as virtual interfaces configured to exchange data. Logical interfaces may be configured for a specific physical interface of a device. In possible embodiments, an interface of a digital entity can be a logical interface. The logical interface can be configured and adapted to: (a) connect the digital entity and a real entity (such as a UE) using an air interface; (b) connect the digital entity and a control plane function in the hosting network; (c) connect the digital entity and a data plane function in the hosting network or/and hosting platform; (d) connect the digital entity and a management function of the hosting network or/and hosting platform; (e) connect the digital entity and external networks. The logical interfaces may be established using a Service Based Interface (SBI) interface in the hosting platform or hosting network. In possible embodiments, a logical interface for a control plane function in the digital entity may be established through a control plane gateway and a logical interface for a data plane function may be established using a data plane gateway, as shown for example in FIGS. 8 and 9.

In addition to D-Users, the HOP 800 can host other types of Digital Entities (i.e. DE or D-XX) for any digital representations of real objects such as infrastructure (D-Inf) or organizations. The HOP C/M functions, such as Platform Manager 834 and Function Orchestrator 836 are for the coordination of the D-Users and other DEs. Similarly, there may be common DP processing functions 844 and data storage 840. Each DE or D-XX may have its own specific functions for internal control, management and data processing which are isolated from the hosting platform via specific gateways (i.e., C/M GW or DP GW). A Digital Entity (D-XX) function, or DE function, can be referred to as a functional block of code executable by one or more processors, within the Digital Entity (D-XX), with predefined external interfaces and behavior, to receive, process and transmit data packets. Examples of DE functions include C/M Plane functions and Data Plane functions. In possible embodiments, access to the DE Functions executed by the DEs hosted in a HOP provided by the network is controlled by a Hosting Network Function (HNF) of the hosting network.

### 6.20. Hosting Platform Creation: Overview of D-User Creation and UCM Service Establishment

As mentioned above, in order to provide UCM services, Digital Entities that are for digitally replicating users, i.e., D-Users, may be created inside a hosting network with the required functionalities. D-User functionalities may be isolated based on the type of UCM services being used by the user. Therefore, a D-user may be created inside a container, as an isolated software module, inside a hosting network. A container is a standard unit of software that packages up code and the code dependencies so that applications may run quickly and reliably in the hosting platform (HOP).

Containers may run on the same OS as the OS used for the hosting network servers, which results in weak isolation from one container to the other, and also from relative to the hosting network. In this document the term ‘software container’ is used for such a container. There are additional protection methods to secure some of the functions of given digital entity from the other containers in the same hosting platform, but a software container may not be fully isolated from the hosting network.

An enclave may be a container which provides hardware isolation in terms of having a protected memory region that provides confidentiality for data and code execution. An enclave may be an instance of a Trusted Execution Environment (TEE) which is secured by hardware. Therefore, it is referred to as a hardware container in this document. An enclave can also be run on its own CPU separate from the CPUs used by the hosting network. An enclave can also be considered as a virtual machine (VM).

Therefore, a hosting platform (HOP) for a Digital Entity, for example a D-User, may be created using a software container or a hardware container (an enclave) based on the privacy level required by the entity.

A hosting platform (HOP) can be an exclusive platform for a single D-User, a platform for multiple D-Users (Multi-D-User Platform). This configuration of the HOP is also possible for any type of digital entity, i.e., a HOP can host a single DE or multiple DEs, depending on privacy requirements for the DE.

In order to support a multi-DE platform or NET4DW platform, additional layers of remote attestation may be necessary. First, the hosting network may have access to the HOP. Secondly, when the HOP creates the DE (D-XX) and connects it with the DE (D-XX) operator (in the case of a D-User, the end-user is the operator), the DE operator should be able to perform a remote attestation of the DE to gain confidence in the security and integrity of the DE. This ensures that the hosting network cannot access the DE hosted in the HOP, in cases where the DE code is provided by a vendor, and the vendor can attest the DE integrity during remote attestation. In some embodiments, each DE may be provided in an enclave, in addition to the HOP being provided in an enclave of the hosting network.

When a Host Network Operator (HNO) decides to provide D-User services, the HNO may first create a HOP platform with a HOP manager which is capable of instantiating the D-User portals when requested by an HNO network function. Some HNOs may not use a common HOP, such as a NET4DW or Multi-D-User platform, to create D-Users and may create individual D-User platforms as and when needed. In this case, each D-User or D-XX module may have their own enclaves.

Accordingly, the UCM service establishment may require the following procedures:

A hosting platform creation which may establish D-User modules and configure the D-Users.

Establishment of a D-User (e.g. when requested by a user or any network function, or prepare several D-Users of different types beforehand and have the D-User ready whenever they are needed).

Establishment of particular UCM service capability

A brief description of these procedures is provided below.

### 6.21. The Hosting Platform Creation

When HNO decides to provide services to digital entities, such as D-User services to D-Users, the HNO may first create a HOP platform 800 provided with a HOP manager 834, which is capable instantiating DEs (D-XX), including for example D-User portals when requested by the HNO CPFs or the HNO's D-XX service manager (DSMF). HOP platform is created inside the HNO network but isolated from the network so that the hosting network cannot access the digital entity data inside this platform. It may be created in at least two ways.

One possibility is that an HNO uses its own infrastructure and creates an isolated software container for the hosting platform (HOP). In this case, the internal function creator may not be inside the hosting platform (HOP). The Platform Manager 834 can manage the HOP NFs and associated resources using APIs. Without hardware isolation, this option may not be the preferred option by operators or end-users of the digital entities.

Another possibility is that an HNO may use an enclave, such as a trusted executive environment (TEE), which is preconfigured to be able to create the necessary functions inside the hosting platform (HOP) and interact with the DE operators or end-users. In this case, this hardware hosting platform may be a standard platform with a Platform Manager 834 which is able to create the other functions and the required interfaces.

### 6.22. Establishment of a D-User or a D-XX Module

The following paragraphs explain the creation of a digital entity (DE or D-XX) in general terms, and also refer to the specific case of creating a digital entity for a user (D-User). As explained above, in the present application, a digital entity (also referred to as an entity replica or a digital twin) represents or replicates any type of entity, whether for an organization, an object, a process, an application, a set of objects, or a user. The creation process of these different entities is similar, and similar creation functions can be used. The creation of a user entity (D-User) represents a special case of a digital entity creation.

The creation of a D-User inside a HOP may be initiated either by a user, a network entity or another D-User. In possible embodiments, a D-XX service manager (DSMF) may request the HOP to create a D-XX module or assign a D-XX module already created in the system to a particular user. These are several ways this can be performed.

A D-User may be created when the user or a network entity requests the creation of the D-User, such as after a user has subscribed for a D-User. When a message is received by a digital entity service manager (DSMF), from the user or from a HNO's network function, the DSMF may transmit the D-User creation request to a HOP function (e.g. HOP Manager function) with the type Digital Entity to be created (for example, a D-User with strict privacy requirements). There can be different types of Digital Entities, and different types of D-Users, as described in this document. The request may be generated by a network function when a D-User subscribed to a particular D-User type or a UCM service. The HOP manager function may create the required D-User module using its Function Orchestrator 836, when an enclave is used for the HOP, or by a HNO's Function Orchestrator, when a software container is used for the HOP. Once D-User is created, a secure link may be established between the user and the D-User for further communication and to establish D-User services.

The process may be similar for other types of digital entities. In the general case where the creation of a Digital Entity is requested, a service provider of Digital Entities (the network operator or an external service provider), requests the Digital Entity creation from the DSMF. The DSMF may then request the HOP to create the Digital Entity and the HOP may create it using its Function Orchestrator 836.

The hosting network and/or the HOP may create and store one or more digital entities, such as D-User modules, ready to be used. Since the creation process of digital entities (which include creation of various functions and interfaces and configuration of those functions), may take some time, if users or the hosting network needs to create a D-User without much delay, the hosting network may create and keep several D-Users in standby mode, without assigning them to end-users. Other types of digital entities may also have additional unassigned D-XX so that, when a request is received, the HOP can assign these digital entity modules quickly. The number of DEs to be kept in a semi-active mode may depend on rate of requests received for the creation of D-XX. The preconfigured DEs may be kept inside a single HOP or in different HOPs. Pre-deployed and preconfigured D-Users may be of different D-User types to suit different types of user requirements. When preconfigured D-Users are available, upon receiving a request, the hosting network can quickly assign them to a user as specified in the request. However, there may be some additional configuration steps that are needed before the D-User is fully operational.

A digital entity may be created dynamically (e.g. in visiting networks), for example when a user wants to obtain a D-User service (i.e., a UCM service) or when a service provider wants to provide a new D-XX service. In the case of a D-User, a user or a network function may request a D-User Creation Function (DUCF) in the control plane of the hosting network to create particular D-User type or allocate an existing D-User container to the user and user can use the UCM service after the creation. In the case of a D-XX module, the service provider may send a request to a D-XX creation function (DXCF—An appropriate function for that D-XX type), to create a D-XX module or allocate an already available D-XX module for this service.

Different HNOs may offer D-User and UCM services to users in different ways. In addition, a network entity may create a D-User in special occasions (e.g., handover). Furthermore, the external services such as DW services or D-Reps may request the creation of a D-User for which the user authorization had already been obtained.

Some of the example implementations an HNO may use for the creation of a D-User include:

D-User creation with the subscription: An HNO may require a user to first subscribe for a service with a service management layer function (DSMF). After the subscription the DSMF may take action to create the D-User. The subscription may be for one or more of a basic D-User, specific D-User type(S) which can provide certain UCM services, or specific UCM service type(s):
Subscription for different D-User types may incur different charging systems for the service,
Subscription for a UCM service without having a D-User may be implemented as a subscription for both a D-User and the specific UCM service,
Subscription for a basic D-User does not facilitate any UCM service but there are at least two ways to obtain a UCM service after subscription for a basic D-User:
The user may subscribe for a specific UCM service, or
The user may request to add a UCM service dynamically, making such a request to a control plane function (DUCF). In this case, the D-User can quickly orchestrate the service by instantiating and the configuring the required functionalities as basic D-User is in place.

Dynamic D-User creation with a request to control plane function: a user, 3^{rd} party service operator, a 3^{rd} arty D-Rep inside the HOP, or a network entity may trigger dynamic D-User creation by making a request for a specific D-User type(s) or a UCM service type(s) from a control plane function (D-User creation function-DUCF):

Some HNO's may need prior subscription for a D-User and the HNO may design and make it ready to create a D-User at the subscription, but does not create D-user until such a request is received through the DUCF.

Some HNOs may consider this request as a request for a subscription and creation. Therefore, the DUCF may take action to add the user subscription for D-User type or UCM service type and initiate the creation process. Subscription is needed to start the charging mechanism and its associated monitoring system.

Dynamic D-User creation with a request to a HOP function: A user or network entity may directly request a HOP function which is capable of creation of a D-User or UCM service without requiring the authority from the hosting network. However, it may have obtained prior authorization from the network for such creations. The subscription for such services may be kept inside the HOP. An In-network DW may create individual D-Users or D-Reps in this manner.

D-User creation by a 3^{rd} party service provider from a service management layer: Usually 3^{rd} party service provider may not have access to make a request to control plane function as in above (b). In such case, it has to first make an agreement with the HNO and HNO wants to obtain user authorization for the same. External DW operator or XR operator may need such a service.

When an external service provider needs to create a D-XX module for its service, the example implementations an HNO may provide include:

A service provider requests the creation of a D-XX module from the service management layer function. When a message is received to D-XX service manager (DSMF) from the service provider (which can be the HNO in which case it is requested by HNO or a HNO's network function), the DSMF may trigger the D-User creation request to HOP Manager function (HMF) with the type of the D-XX module. There can be different types of D-XX modules as described in this document. The HOP manager function may create the required D-XX module using its function orchestrator in case an enclave is used for the HOP or by a HNO's function orchestrator when a software container is used for the HOP. Once the D-XX module is created, a secure link is established between the service provider and the D-XX manager for further communication and to establish D-XX services.

A D-XX module such as a D-Rep may be created dynamically when a service provider or an internal D-XX module wants to create another D-Rep. If a service provider already having a D-XX module wants to create a D-Rep, it can make a request to the HOP manager directly, or make a request from the DUCF. If the Service provider does not have a D-XX module, it can request it from the service layer as mentioned above.

In some embodiments, different types of D-XX modules (e.g., D-User types) may be created beforehand, and when a request comes, they are allocated to the users, with some modification including function configuration which might not speed up the creation process. This may be applied to all embodiments discussed above, in which case the creation step means assignment of an already created D-user to a particular user with certain configurations. In the case of a D-XX module, the creation means assignment of an already created D-XX module to the D-XX service provider. These configurations include establishment of a secure link between the user and the D-User and specific user policy transfer from the user to the D-User and HOP managers. In addition, specific techniques for the privacy requirements of a particular user are established. In the case of a D-XX the link between D-XX module and its service provider and provide D-XX service policies from the service provider to the D-XX module and HOP managers. Other D-Reps can also have additional unassigned D-XX modules so that when a request comes, the HOP can assign these modules quickly. The number of D-XX modules to be kept in this semi-active mode depends on the arrival pattern of the D-XX creation requests. They may be kept inside a single HOP or different HOPs.

6.23. Establishment of a Specific D-XX Service(s) (e.g. UCM Service or D-User Service)

Once a D-User is created, additional UCM services may be requested by the user. This may be done by making an additional subscription to the service layer function (i.e. DSMF), or by making a dynamic request to the control plane function (i.e. DUCF), or making a dynamic request to the HOP or D-User management function. However, as mentioned above, a user can request to create a UCM service without the creation of the D-User and at that time the network treat it as a request for a specific type of D-User with that UCM service and create the D-User as well.

For a given Digital Entity (D-XX module) there can be different types of services. A D-XX service operator may need some operations or services from the D-XX module and may need to configure them. In addition, some D-XX service providers such as a Mobile Virtual Network Operator (MVNO) may have end users or end devices which obtain direct services from the D-XX modules. Both of these service types may be included in the D-XX configurations.

A user or a hosting network function (HNF) may request the establishment of a specific UCM service. The request would be received by D-User creation and configuration function (DUCF) inside the HNO. The DUCF function may be comprised in a more general DXCF module, where a DXCF module is configured and adapted to create services to digital entities, and the DUCF function is especially adapted to provide D-User related services. If D-User is not already created, the method may first follow the steps of the D-User creation process explained above. Once a D-User is available, the DUCF may request the establishment of the UCM service either from the HOP or from the D-User, depending, for example, on the privacy requirements and specific implementation. Similarly, for the D-XX services, the request may come from the D-XX service operator or a D-XX service operator's client device to the (D-XX creation and configuration function) DXCF and DXCF may request the establishment of the service.

In certain cases, the UCM service establishment may need to be performed transparent to the hosting network, i.e., such that the UCM service establishment is performed without the hosting network being aware of this new UCM service. In this case, D-User manager is provided with the required capabilities and also may have authority to request the creation of new hosting network functions, HOP functions (HPFs), or configure them by obtaining authorization from the network. When the HOP manager creates the D-User, these capabilities may be provided to the D-User manager. Similarly, for the D-XX services, if the D-XX service operator requires to have fully independent operation, various D-XX services may be established by the service provider directly requesting the D-XX (e.g., D-XX manager function). For this purpose, the D-XX capabilities may be provided to the D-XX manager during the establishment of the D-XX module and the hosting network functions may be configured to receive and execute specific requests from the D-XX manager required for the D-XX service establishment and operation.

### 6.24. D-User Types and UCM Service (UCMS) Types

As mentioned before, there may be numerous digital entity-controlled and managed service types a Digital Entity, such as a D-User, can use. When the digital entity represents a user, the controlled and managed services may be referred to as User Controlled and Managed Services (UCM). Depending on the UCM services a D-User is supporting, D-User's composition can vary. Thus, D-Users may be classified according to the types of UCM services (UCMS) they can support. A UCM service can be a service a user receives to control or manage its services or network entities providing the service. A D-User may consist of one or more functions that may be needed for UCM service provisioning.

D-Users and a user needing a UCM feature may subscribe to the associated D-User type or to a UCM service. Not all users need user empowerment and therefore, a D-User may be provided as an add-on feature to a user on a needed basis. When a user requires the feature, the user may make a special request to the network which is forwarded to a D-User creation function in the network.

The type of D-Users or types of UCM services can be standardized for the UE to request the required service. An MNO may provide the D-User facilities based on its view on creating these functions and associated privacy preserving methods, costs and available facilities.

In some embodiments, the UCM services are grouped such that they can be supported by a common set of functions or common network topology. Table 2 indicates an example categorization of D-User types and associated UCM services based on the basic functions that may be needed for a D-User.

TABLE 2
Example D-User type categorization based on common functional requirements

| | | UCMS services that can | |
|---|---|---|---|
| | Basic UCM services | be provided with minor | |
| DUser_TypeID | (UCMS) supported | additions | Comments |
| Type 0 (Basic D- | User can create any UCMS | Any UCMS service | |
| User) | services by adding functionality | | |
| Type 1 | UCMS 2: authentication of user | UCMS 3: Making or | Need key |
| | for service access, | receiving payments to/from | exchange with |
| | authorization for using | 3^{rd} party preserving privacy | core network |
| | personal data, payments | | functions and CA. |
| | UCMS 1: Home network, | | Need UE home |
| | equipment, health and alarm | | equipment |
| | control | | controlling |
| | | | functions and |
| | | | storage. |
| Type 2 | UCMS 4: Capability to | UCMS 6: Controlling UE | D-User need |
| | dynamically obtain special | traffic routing within the | access to RAN and |
| | network features for its | network UPFs | request |
| | dynamic needs (e.g. low power | UCMS 7: Obtaining service | resources/features |
| | channels, diversity). | quality maps | (dynamic CPF |
| | UCMS 5: Capability to define | | interaction with |
| | special services (e.g. QoS | | 3GPP at L2/L1). |
| | guarantee over a specific route, | | No UPF. Need |
| | multiple channels) | | resource control |
| | | | for UCMS 3. |
| Type 3 | UCMS 8: Ad/Spam Blocking; | UCMS 9: TCP acceleration | Application level |
| | UCMS 11: Source address, ID | with a proxy; UCMS 10: | protocol stack at |
| | change for privacy; UCMS 12: | Local data caching and pre- | D-User. Need |
| | Sharing content interests; | fetching; UCMS 15: Sharing | CPFs and UPFs |
| | UCMS 14: Processing specific | data | and data |
| | user traffic; UCMS 16: Support | | processing. |
| | for UE's Net4AI applications | | |
| Type 4 | UCMS 17: Obtain own network | | Need RAN |
| | resources/services (slices, | | capability info and |
| | tunnels, multiple AP | | resource control |
| | RBS/frequencies) | | |
| Type 5 | UCMS 18: D-User AI | | Joint network |
| | interaction with UE and | | optimization |
| | network AI to optimize | | capability. |
| | network and UE services | | |
| Type 6 | UCMS 19: Obtain service from | UCMS 20: Supporting | Interacting with |
| | neighbour UEs and vice versa | network for XaaS services | neighbouring UEs |
| | (e.g. relaying, D2D) | | infrastructure, |
| | | | providing |
| | | | services. |

As shown in Table 2, certain UCMS types do not need User (or Data) Plane Functions (UPFs) inside the D-User for special processing, and the D-User is relatively simple. In this possible embodiment, there may be no exposure of raw data (e.g. D-User Types 2, 3, 4,7). In addition, there are certain UCM services which may not need network exposure information which also reduces the complexity (e.g., D-User types 1, 4). Another D-User categorization may indicate that certain UCMS types do not need the exposure of user information to the network which limits the privacy requirements (Type 1). The UCMS type of Table 2 are defined in more detail below.

6.24.1. Basic/Default Digital Entity which is Able to Establish New UCM Services (Type 0)

In some embodiments, an HNO may decide to establish a basic or default digital entity, such as a D-User, which may later be extended to provide any UCM services or any digital entity type that a user requires. Creation of a basic or default digital entity enables the network or user to create UCM service on demand basis. Therefore, any other digital entity type can be considered as a basic digital entity modified by adding functions to support specific UCM services. For this purpose, a basic digital entity has a logical control link established between the UE and the digital entity. The digital entity has one or more functions to create additional functions required for a UCM service when requested by the user or a network function. The one or more functions may include functions to trigger the creation of a digital entity from a network function orchestration function or an equivalent management function.

6.24.2. Digital Entity Having Only CPFs and Storage and does not Need Network Exposure (Type 1)

This is the simplest digital entity which has only control plane functions and no data plane functions. It may need a storage to keep information related to the user, e.g., use context. It may have one or more control plane functions. The one or more control plane functions may include a function to communicate with the user, for example to obtain user requirements. It can also include a function to communicate with the control plane functions of the hosting network. Additionally, it may have a function to control the UPF functions which depends on the type of the UCM service the digital entity intended to provide. For example, the UCM services provided by this type of digital entity includes:
digital entity taking decisions for home equipment, personal health and trigger alarms to personal User Device (PUD) or external home/health control systems,
Authenticating and authorizing on behalf of user when interacting with 3^{rd} party entities, and
Making payments or receiving payments to/from 3^{rd} party entities without providing identification to them and without allowing the financial institute the receiver or provider of the payment.

### 6.24.3. Digital Entity Having Only CPFs and Storage and Use Network Exposed Features/Facilities (Type 2):

This digital entity type, in addition to having CPFs, may be provided with capabilities to obtain certain type of network information such as specific facilities provided to UEs, e.g., specific processing or traffic routing control and priority control, or apply special technical features of the MNO (RAN/CN), topology or traffic monitoring such as loading situations and costs in dynamic costing situations. Further capabilities may include:
Requesting special network features or functions dynamically by the UE for its dynamic needs (e.g., low power channels),
Defining special services/flows for efficient communications, including:
Specific QoS for multipath diversity combining for UL/DL,
Rate QoS guarantee for a UE moving path, and
A specific service consists of a combination of flows with specific QoS requirement,
Controlling its own traffic routing inside MNO, and
Obtaining geographical areas with good service quality (map)—knowing UE can move to move good locations/routes.

This second digital entity or digital container type may be adapted to control network features used for user communication services provided by the hosting network, based on dynamically changing needs of the digital entity customer. The second digital entity or digital container type may be adapted to set specific Quality of Service (QoS) for at least some of the services provided to the digital entity customer. Controlling network features may include controlling network functionalities, such as data processing, traffic management, etc. Controlling network features may include controlling network technologies, such as controlling low power channels in a RAN, or controlling network resources, such as bandwidth or Quality of Service (QoS) between nodes of the hosting network. The hosting network may provide a feature ID for this purpose to the digital entity, such as the D-User. The hosting network may also provide parameters associated with the features and/or a range of possible values for the parameters which can be specified by the digital entity to obtain the feature.

### 6.24.4. Digital Entity Having UPFs for User Traffic Handling and Controlling User Data (Type 3):

This digital entity type allows a user to process its traffic according to its own processing functions. It also allows the user to do data processing agnostic to the network or carry out network agnostic communications with DNs. For example, UCM services provided by this type may include:
Work as a middle person to block ads (also reduce the air interface bandwidth)
Work as a proxy to do app/TCSP acceleration. The capability to provide user dependent QoS requirements for a given application by adjusting the user QoS and monitoring the service quality experienced by the user.
Local data caching and pre-fetching
Privacy preservation—for sending queries with a different user ID
Sharing contents interest for pre-fetching
D-User receive data (e.g. voice recording) when user is offline
Processing specific types of traffic (transparent to the network)
Sharing user data
Analyzing P-User data (e.g. Net4AI)
   6.24.5. Digital Entity has its Own Resources Obtained from MNO which can be Controlled or Managed by D-User (Type 4):

The resources, such as certain network segments (RAN or CN parts), network slices, transport bearers, AP resource blocks, APs, reflective intelligent surfaces (RISs) etc. may be obtained exclusively for a user and use it for its own traffic.

6.24.6.Digital Entity Capable of Joint Network Optimization by Communicating with MNO (Type 5):

Under this type of digital entity, a user can support the network services and vice versa by, for example helping joint optimizations or supporting network services. For example, this type allows for digital entity AI interaction for joint design providing predicted user information (e.g. mobility prediction for resources and tracking area, per UE based UE idling time, use switch off or turned volume down).

### 6.24.7. Digital Entity Capable of Supporting Network Services (Type 6)

Under this type of digital entity, a user can support the network services and vice versa by, for example, helping joint optimizations or supporting services as indicated below:
A Digital entity may ask UE to facilitate network traffic to UEs neighbours or vice versa (knowing neighbours from the network).
A Digital Entity may support network to deliver non-connectivity XaaS services, (AI services. Video/weather sensing data from D-User)
   6.25. Hosting Solutions to Create a Digital Entity with Different Isolation Requirements

In order to meet the requirements for use cases such as those described above, the following steps may be implemented. Although the following paragraphs are described for a D-User, it is understood that the steps described can be applied to any type of digital entity, without being restricted to D-Users.

Each D-User may be isolated from D-Users of other users but they can share the same network functions. In this case, a D-User may use a software container providing added functions to isolate the D-User from other D-Users. When a user has access to multiple D-Users, it may not be needed for the D-Users to be isolated from each other and the D-Users may share common functions for their operation.

A HOP may be created inside an enclave isolated from the hosting network (i.e. even the hosting network may need to obtain permission to access functions or data inside the enclave). This may be useful, for example, for use cases 3, 4, and 5 described above. For these cases, an isolated confidential computing platform such as a TEE (or CEE) may be used.

A HOP platform may be used for multiple D-users in order to be able to perform ID changes to hide the identity of the end-users even from the hosting network when communicating with external devices. This may be useful, for example, for use case 4. One hosting network function (HNFs) within the Hosting Network may ensure that the Hosting Network cannot track the external servers accessed by a specific Digital Entity (D-XX) by deploying the Hosting Operations Platform (HOP) as a multiple DE-HOP. When the HOP hosts multiple Digital Entities (DEs), it may become impossible for the HOP to track which specific DE has accessed which external server.

A HOP may also keep a minimum number of DEs, such as D-Users, inside the HOP. For example, the K-anonymity model requirements may be used to anonymize user communications to/from DNs (i.e. hosting network cannot know which user inside the HOP communicated with the DN). The K-Anonymity requirement can be summarised as “for every combination of identifying attributes in a dataset, there are at least ‘K minus 1’ other people with the same attributes”. Therefore, the source ID of messages sent to the DE may be changed with a randomized ID and also the response address of messages sent by the DE to the user may be randomized, with a randomized location (such as random or encrypted IP address).

The confidentiality requirements of a D-User may also be met by having one, or a limited number of D-Users, in separate enclaves. The communications to outgoing and incoming ports of each of the separate enclaves to third parties can be configured to transit through another isolated enclave of the hosting network. This isolated enclave can be configured to perform random ID changes, thus preserving the confidentiality of D-Users with respect to third parties. In such possible embodiments, it is possible to maintain confidentiality specifications for a D-User even with a limited number of D-Users in a HOP.

Once the HOP is created, the HOP may be given the capability of independent operation. This may be useful, for example, for use case 5 described above.

For this purpose, when the HOP is created, a HOP manager function 834 (HOP-M) may be created inside the HOP. The HOP-M 834 may be capable of doing the LCM for D-Users (e.g. creation, modification and termination of D-Users). The HOP-M may also be capable of doing common functions needed for the interaction of the D-User functions with entities outside the D-User (e.g. other platforms inside the HOP, hosting network functions, P-User and P-User devices, 3^{rd} party servers), privacy preserving functions when a D-User communicating with external entities.

Metaverse or digital world (DW) applications may use different types of digital entities (D-XX) and privacy preservation may be required for the Digital Entities (D-XX) as well as for the DW application operations. In particular, the DW operations may need to be protected from the hosting networks. The hosting platforms (HOP) discussed herein can be used for providing in-network DWs as well. DWs may consist of D-Users, various D-Reps such as D-Infs and various other applications, such as VR or AR applications.

6.26. System Architecture for in-Network HOP Creation

In this section, a generic creation process of the hosting platform (HOP) inside a mobile network or a data network to host the D-XX modules such as D-Users is discussed along with the hosting platform architecture.

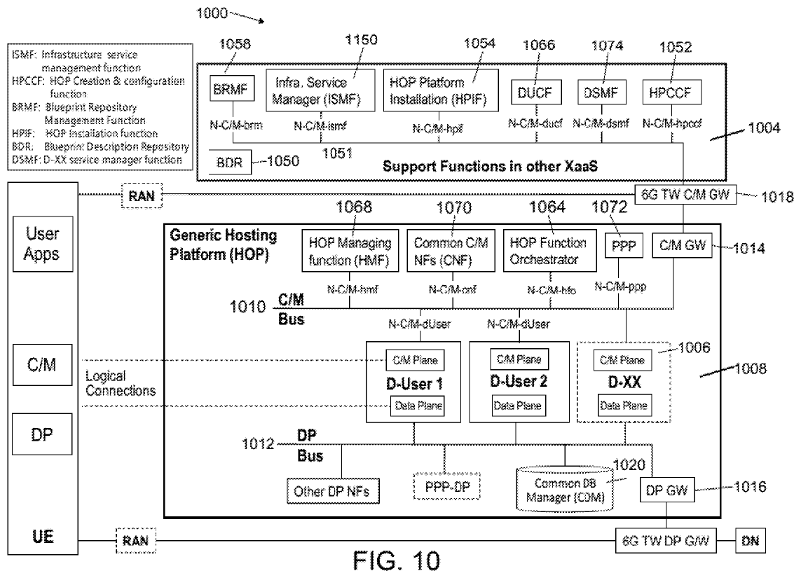

FIG. 9 shows an exemplary system architecture 900 which also includes HOP creation functions and various interfaces. Note that these interfaces (VR1-VR5, MP1-MP5) are logical interfaces and they are connected through a common bus under the SBA architecture which is shown in FIG. 10. A user may connect, via a User Equipment (UE) 902, to the hosting network 904 through a radio access network (if the hosting network is a core network) or through both a RAN and CN (if the hosting network is a data network in the cloud) which is not shown here as these interfaces are logical interfaces. The logical interfaces are displayed to clarify the relationship between the different functions involved in creating the HOP.

FIG. 9 further shows exemplary data plane (DP) 912 connecting the UE 902, the hosting network 904, the Digital Entities (D-User), (D-Rep) 908′, the HOP DP functions 914 and external data networks and servers 980. As can be seen in FIG. 9, data communications between the HOP 910 and the external servers 980 may go through a HOP DP GW 930. This configuration is given as an example only and may vary depending on how accesses to and from the HOP data plane are implemented.

The HOP creation process may start with a network operator determining the type of HOP to create, for example based on the type of Digital Entity (D-User or other) and based on the UCM services to be provided. Then, the network operator may provide the Infrastructure XaaS service Management Function (ISMF) 950 the hardware and software requirements for the HOP based on the determination. The ISMF 950 may further evaluate or confirm the resource requirements and the capability of the hosting network in determining the type of HOP. The ISMF 950 may then request that the Hosting Platform Creation and Configuration Function (HPCCF) 952 create the HOP. The HPCCF 952 may use the platform installer (HPIF) 954 to create the HOP and instantiate the initial functions needed to create and manage Digital Entities (including for example D-Users and/or D-Reps). The initial functions may include HOP Network Functions (HPFs). The HOP Network Functions (HPFs) may include various functions, including a HOP Manager Function (HMF) 968 which can be configured to create the Digital Entities 908, 908′. The HPCCF 952 may configure those initial functions and provide blueprints for different functions. Blueprints for different functions may be stored in the Blueprint Description Repository (BDR) 956. The Blueprint Description Repository Management Function (BRMF) 958 may obtain the required blueprints according to the HOP creation request, via the HPCCF 952, through interfaces MP4 and MP5, and send the blueprints to the HOP manager 968 to be used, for example, for creation of specific types of Digital Entities, such as D-Users or D-Reps. These initial functions may include the HOP managing function (HMF) and other common Control and Management functions.

The exemplary HOP 910 shown in FIG. 9 also has an internal function creator module (FCM) 962 which may consist of a HOP Function Orchestrator (HFO) 964 to instantiate additional functions inside HOP. An orchestrator typically refers to a component or service responsible for coordinating and managing the deployment, configuration, and operation of multiple services or components. The HFO 964 may use infrastructure provided for the HOP (for example, the memory allocated to a container) for this purpose and an infrastructure manager (IM) 972 may manage the infrastructure. The created HOP network functions (HPFs) may be managed by a network function manager (NFM) 970.

In embodiments where the HOP uses resources of the hosting network infrastructure, the entire FCM module 962 may be kept outside the HOP, and the Network Function creation and other LCM operations may be done by requesting the external FCM 962 to create the HPFs of the HOP. In another option, HFO 964 may be inside the HOP and other functions of the FCM 962 may be placed outside the HOP.

When a request is made by a user, a network entity, or any other authorized entity to create a DE, the request may be received by the D-XX Creation Function (DXCF) 966. The DXCF may then inform the HOP manager 968 to create a container for the DE with a D-XX manager (D-XX-M) 862 (identified in FIG. 8) and certain essential functions, such as the access control function. The instantiation of the other functions required for the DE may be done either by the D-XX-M 862 or the HOP manager depending on the required independence of the Digital Entity from the HOP. Note that if each Digital Entity is created inside a separate enclave, a separate D-XX-M is not required and all the D-XX-M function describes in this document may then be done by the HOP Management Function (HMF) 968. Each Digital Entity (D-XX) may comprise D-XX functions accessible to the P-Users via a P-User access device (UAD) or via a UE, without knowledge or awareness of the HN. In other words, the functions, applications and data of the D-XX hosted in the HOP may not be visible to the Hosting Network. The HN may not have access to HOP functions nor to the D-XX data or D-XX operations. The HN is blinded and unaware of the functions and operations performed by the HOP or in the HOP. In some cases, functions inside the HOP may be provided by the user or by an external server (3^{rd} party) trusted by the user.

To make a request to the DSMF 974 the VR2 interface in FIG. 9 may be used. The request may include the Digital Entity or UCM service type and date and time by which the Digital Entity is needed. To make a dynamic request to the DXCF 966, a user control plane function may use the VR1 interface, indicating the Digital Entity or UCM service type, a user ID and subscription details. The DSMF 974 or the DXCF 966 then make a request to the HOP manager 968 (after the authentication of the request and authorization) to create the required Digital Entity for the requested service, using the VR3 interface. The HOP manager 968 will then create the Digital Entity with a D-XX manager (D-XX-M) 862 and establish a secure link between the D-XX-M and the HMF 968 to configure the Digital Entity (such as D-User 1, D-User 2 or D-Rep) via interface VR5 and any other appropriate functions.

### 6.27. Digital Entity Creation and Life Cycle

This application provides a method to instantiate and operate a digital entity, such as a digital user, inside a network to provide the digital entity services to the user wherein the digital entity can act on behalf of the user for certain user operations. In a possible implementation, this application provides a method to instantiate and operate a digital entity (or digital module or instance (D-XX)) for a customer. Therefore, although the following procedures and descriptions are mainly described in reference to D-User creation, similar procedures and descriptions can be extended to the creation of a digital entity.

In some embodiments, the method includes preparing a blueprint for different digital entity types (such as D-User types) required for different UCM services, where the blueprint includes the digital entity functions and interfaces required for a digital entity type. The method also includes sending the information to the users, via user equipment, of the digital entity types of entity service types available, receiving a subscription for a digital entity, and receiving a request to create a digital entity of specific type, of a specific digital entity service type to a CN CPF function (DUCF) or to a service management function (D-User service manager-DSM). The method further includes sending a request to a function orchestrator, e.g., an Operations, Administration and Maintenance (OAM) module, to create a digital entity container comprising functions and interfaces needed for the basic digital entity. Creating the digital entity container can includes one or more of requesting the MNO to create a Digital-Entity-Manager to instantiate the functions and interfaces according to the blueprint or creating a separate enclave such as a TEE inside the wireless network. In some embodiments, the separate enclave is created by creating a digital entity manager inside the enclave, creating the other C/M functions and interfaces for the digital entity, establishing a link between the digital entity and the user by providing access keys and addresses, and establishing a secure link between the user and the digital entity for communication.

The method for instantiating a digital entity inside a hosting network to provide a digital representation of a real entity may comprise transmitting a request to a function orchestrator to create a digital entity container comprising digital entity functions and interfaces based on a digital entity type to provide life-cycle management and operational services. The digital entity functions may comprise control and management (C/M) plane functions and data plane functions. The interfaces may comprise internal and external interfaces. The method may also comprise, upon or after creation of the digital entity container, establishing a secure link between the digital entity and a user equipment (UE) associated with the real entity. The secure link may be used by the real entity to request the digital entity to provide or establish services on behalf of the real entity. The digital entity can interact with the hosting network and exchange data between the hosting network and the real entity to provide the services, via one of the control plane functions, the data (or user) plane functions and the internal and external interfaces.

The method can include Informing the user that the requested digital entity is ready for operation.

As mentioned before, the digital entity or D-User creation method may depend on the trustworthiness of the HNO. In the case of trusted HNO, the hosting network functions can create an isolated HOP such as a software container using the HNO infrastructure and all the digital entity functions can be created inside with some isolation and do LCM by the hosting network. In that case, there may be no need for the HOP to handle internal function creation, LCM or resource assignment which can be done by the hosting network. Still some of these functions may be delegated to HOP, for example internal resource assignment using an allocated resource for all the HOP may be managed by the HOP functions. When the HOP uses the hosting network infrastructure, the entire FCM module may be kept outside the hosting platform and the NF creation and other LCM operations may be done by the HMF requesting the external FCM. In another embodiment, HFO may be inside and other functions of FCM may be placed outside the HOP.

In non-trustworthy embodiments, the HOP may be in an isolated enclave and the digital entities (e.g., D-User) and internal function creation can be performed by the HOP. For this purpose, the HOP may also have an internal function creator module (FCM) which may consist of an orchestrator (HFO) to instantiate functions inside HOP. The HFO may use the infrastructure provided for the HOP for this purpose and an infrastructure manager may manage the infrastructure. The created network functions (NFs) may be managed by a network function manager (NFM).

In either case, the digital entity (D-XX module) blueprints may be prepared and provided to the network function initiating the creation and configuration of the digital entity and related entities. The HOP blueprint can include all the blueprints of the expected digital entity that may be created inside the HOP.

The HOP blueprint may keep all the types of digital entity and their blueprints and capture the workflows or message flows for all the digital entity operations. HOP blueprint is comprised of one or more of:

The type(s) of digital entity platforms that may be created inside the platform and their blueprints. For example, there are several D-User types that may be created with associated UCM services. Therefore, the procedures for all these D-User types, UCM service types, D-Inf types and service types supported, X-R types supported need to be specified. This also include the constituent functions required for each service.

The procedure to create a new type of digital entity, that needs to be specified.

The common functions of the HOP and their configurations and associated processes.

All the procedures the HMF is associated with after HOP is created. For example, establishment of secure communication with the Hosting network functions such as HPCCF, DUCF, DSMF and hosting network function discovery process including messaging structure, and ingress and egress ports, to use the hosting network C/M and DP bus.

All the functionalities and procedures associated with the HOP managing function (HMF).

Resource requirements for the digital entity which include storage, computing and link capacities for different interfaces. Computing resources may include the number of CPUs or GPUs and their speeds and allocated % of CPU power from the computing engines and RAM memory requirements. Storage requirement may include storage size and access speeds.

The QoS characteristics (e.g., latency, packet loss, data rate etc.) of the links between the digital entity and the associated real entities such as users, devices etc. The link requirements for the links between the expected D-XX modules and the network functions in the HOP or hosting network (e.g., for a D-User, the link between D-User and the user, links from D-User to other network and HOP functions such as HPCCF, DUCF, ISMF).

Examples of HOP functionalities related to digital entity creation are listed below:

creation of a D-User portal which includes a D-User manager and default D-User functions when a request is received from the DSM or from a network control plane function (HNO DUCF).

Providing of D-User blueprints for different D-User types and UCM service types.

Resource assignment for the D-User (and all D-XX modules)

Configuration of the D-User manager with the capability to set up a secure connection with the UE and the capability to establish UCM services when receive a request from the HNO DUCF. In case of multiple D-Users or other D-XX modules are to be created inside the HOP, the HOP may need to create the initial D-User exactly according to the vendor specification so that the use can later does remote attestation to check the protection level of the D-User.

LCM of D-Users, D-XX modules and the common functions of the HOP used for multiple D-Users or other D-XX modules.

Access control for the common database.

Fault, performance and charging related functionalities for D-Users.

### 6.28. High Level Steps for D-User Creation and the Interface Description

As discussed before, when a request is made by a user, a network entity, or a D-Rep to create a digital entity, such as a D-User, it may be received by the hosting network service management function DSMF or a control plane function DUCF (D-User creation function) depending on the specific implementation an HNO provides to its customers. A request to DUCF is a request for a dynamic creation of a D-User.

With reference to FIG. 9, a brief description of logical interfaces is provided. The flowing descriptions are high-level descriptions. The interfaces are described for the creation of D-User, but similar interfaces are involved for the creation of any type of digital entity. More details are given with the functional descriptions and the description of the procedures.

VR1 (UE<=>DUCF): User may trigger/request the network to initiate the D-User creation for UCM service creation. Message contains the user ID, user authentication information, D-User Type ID or UCM service type ID.

VR2 (UE App<=>DSMF): User may request/subscribe to the network to initiate the D-User creation for UCM service creation. Message contains the user ID, user authentication information, D-User Type ID or UCM service type ID.

VR3 (DUCF< >HMF) (DSMF< >HMF): After the authentication of the request a message may be sent to the HMF to create the D-User. It passes the UCM service type ID or D-user service type ID in this message and the user ID and IP address and security keys to communicate with the user.

VR5 (HMF< >D-User-M): This link may be used to communicate with D-User to configure the D-User functions including D-User-M. It passes the UE security keys and procedures to establish communication link with the user.

VR6 (HMF< >HFO): This link may be used to instruct the internal function orchestrator to instantiate the functions required for the D-User using the allocated HOP infrastructure. The message may carry the function types, the topology and resource requirements.

To make the request to DSMF, the VR2 interface, as shown in FIG. 9 may be used. The request contains the D-User or UCM service type and time information the D-user may need to be created. To make a dynamic request to DUCF, a user control plane function may use the VR1 interface indicating the D-User or UCM service type and user id and subscription details. The DSMF, or the DUCF, then makes a request to the HOP manager (after the authentication of the request and authorization) to create the required D-User for the requested service using VR3 interface. The HOP manager may then create the D-User with a D-User manager (D-User-M) and establish a secure link between the D-User-M and the HMF to configure D-user-M (VR5) and any other appropriate functions. In the case of untrustworthy hosting network scenario, the enclave vendor may provide hard-coded software in the HOP for HMF and other procedures indicative of the D-User-M programs such that the HMF can configure the D-User-M. This is necessary for the remote attestation of the D-User functionality which proves the protection level of the D-user operations from the hosting network. In addition, the HOP-M may provide secure keys for the user and the D-User and establish a logical communication link with the user to communicate and establish their own keys. This logical communication link is established through the HOP GW and hosting network's data plane. There are different ways the attestation can be done to convince the user that the enclave is secured from the hosting network. For example, the attestation may happen for the D-user functionality at this point, e.g., by the creation of a hash to prove that it is done according to the vendor specification, and so it cannot be accessed without the permission from the user. The instantiation of the other functions required for the D-User may be done either by the D-User-M or the HOP manager depending on how independently the D-User is to be created.

An exemplary high level procedure performed when creating a D-User includes a user subscribing for a D-User service or requesting a specific UCM service type(s), or a network entity requesting creation of a D-User. Specific D-User type or UCM service type may be specified, or the request may be for a basic D-User. When the request is received, the HOP creates the required D-User with a D-User manager (D-User-M). The D-User-M is provided with security credentials to establish communication with the user (address, security keys etc.), and the user is also provided with the required information to establish the logical communication link. A D-User access control function is also created which can authenticate the external functions being accessed. The secure communication is established for the D-User-M to contact the HOP manager.

In one embodiment, the D-User is created as an enclave and the internal functions being created up to this point and the associated interfaces are strictly according to the enclave specifications provided by the enclave vendor. In another embodiment, the HOP is created as an enclave and a D-User module is one of the isolated modules inside the HOP. For example, one method for remote attestation may be to create the D-User including all the functions and interfaces are established strictly according to the enclave vendor specifications which may be provided to the vendor by the hosting network. This may include blueprints of the initial D-User which can be self-sufficient to provide the UCM services.

In some embodiments, the remote attestation may happen at this point. For example, any modification of the functionality, interface or configurations after this point may be carried out with the authority of the D-User-M only. D-User can obtain instructions only from the user for this purpose. In other words, neither the HOP nor any network functions in the HN can modify any of the functions or configurations inside the D-User module without the knowledge of the user and user authorized such modifications (function creation, function configuration, interface establishment etc.) are kept in a log inside the D-User and also a similar log is kept with the user. This way, a user may periodically attest that the D-user functions are not modified without authority and also D-User is fully under control of the user.

In the case that an enclave is used for the D-User or the HOP platform, the D-User may create a remote attestation codes as per the procedure received from the enclave vendor. This code is sent to the user with the vendor address and authentication keys. The user contacts the vendor using that information and the vendor may attest the D-User as a protected enclave which cannot be accessed by any 3^{rd} party without the authorization from the D-User. This process can be done from time-to-time, as modifications are recorded with both the user and the D-user. When preparing the code for remote attestation, the D-User can do it with the inclusion of all the changes or after excluding the changes and inform the user the method that is used. The user uses the same method to attest the D-User configuration.

The D-User has a D-User manager which is capable of creating new functions inside the D-User using an internal function orchestrator. In some cases, it can be done by the function orchestrator of the HOP. In some embodiments, such modifications may be authorized by the user.

Once D-User is established with the required functions and interfaces, the UCM service can be established dynamically requested either by the P-User or a network entity.

### 6.29. Description of the Logical Interfaces

High-level descriptions of the interfaces shown in FIG. 9 are presented below. Logical interfaces may be referred to as virtual interfaces configured to exchange data. Logical interfaces may be configured for a specific physical interface of a device, for example to route data to an address, such as IP address, as an example only. More details are given later, with the functional descriptions and the description of the procedures.

The VR1 interface, defined as the interface between the UE and the DUCF, may allow for a user to trigger/request the network to initiate the D-User creation for UCM service creation. The request message may contain the user ID, user authentication information, D-User Type ID or UCM service type ID.

The VR2 interface, defined as the interface between the UE App and the DSMF), may allow for a user to request/subscribe to the network to initiate the D-User creation for UCM service creation. The request message may contain the user ID, user authentication information, D-User Type ID or UCM service type ID.

The VR3 interface, defined as the interface between the DUCF and the HMF, or the interface between the DSMF and the HMF, may allow for sending a message to the HMF to create the D-User, after the authentication of the request. The UCM service type ID or D-user service type ID may be included in this message and the user ID and IP address and security keys to communicate with the user.

The VR5 interface, defined as the interface between the HMF and the D-User-M, may be used to communicate with D-User to configure the D-User functions including the D-User-M. It passes the UE security keys and procedures to establish communication link with the user.

The VR6 interface, defined as the interface between the HMF and the HFO, may be used to instruct the internal function orchestrator to instantiate the functions required for the D-User using the allocated HOP infrastructure. The message may carry the function types, the topology and resource requirements.

### 6.30. HOP Functional Architecture: Functional Description and Interfaces

FIG. 10 shows an exemplary functional architecture 1000 of a hosting platform 1008 showing details of the internal bus structure as well as platform creation functions of a hosting network 1004. Some of the functions, such as the ISMF 1050, the HIPF 1054, the DUCF 1066, the DSMF 1074 or the HPCCF 1052, are in the hosting network 1008, but outside the HOP 1008, and they may belong to various other XaaS services. The internal communications inside the HOP 1008 may be done by common C/M bus 1010 and DP bus 1012 as per the Service Based Architecture (SBA) architecture. The internal C/M and DP buses may be connected to the external buses through the HOP C/M GW 1114 and HOP DP GW 1016 respectively.

### 6.31. Detailed Description of Hosting Network Functions Supporting D-User Creation

Under SBA architecture, a function may be described by the services it provides to its customers, the inputs required to provide the services and the associated outputs. Services may refer to software components or functionalities that provide specific capabilities or functionalities to users or other software modules. End users, or customers, may discover the service functions using, for example, a discovery function. The services may be limited to authorized end users. End users may be connected (via their UE) to the network functions 1070 providing the service using, for example, the internal C/M 1000 and DP 1012 buses. The functions not directly connected to the internal bus may be connected to using the GWs 1114, 1016, 1018. The reference points for the functions are marked in the diagram in the connection line to the bus, e.g., ISMF services 1050 are provided using N-C/M-ISMF reference point.

A description of the functions and their services are provided below.

### 6.31.1. ISMF (Infrastructure Service Management Function)

The ISMF 1050 may be used by a network operator to initiate the creation of an infrastructure service, in this case a HOP as a service. This function provides, allocates or identifies the infrastructure required to create a HOP for an end user. The infrastructure (hardware and/or software) for the HOP 1008 may be obtained from a 3^{rd} party vendor, for the provisioning and configuration of an enclave, or in the network operator's own infrastructure. In certain cases, obtaining infrastructure from 3^{rd} party vendors may be done at a later stage by HPIF 1157 after finalization of the overall resource requirement. A basic HOP management function description may need to be provided to the infrastructure vendor to prepare the HOP as a customized package that may include the HPFs needed to operate the HOP, create Digital Entities and/or provide services to Digital Entities. There may be additional functions that need to be included within the HOP to facilitate remote attestation of its contents. For example, once the HOP is created inside the hosting network, the hosting network may use the initial access keys to access the HOP and complete its configuration. When a Digital Entity (D-XX module) is created, the end user (owner or operator) of the Digital Entity may be allowed to prepare independent access keys to communicate with the service operator offering D-XX services and the service operator needs to attest authenticity of the Digital Entity. For example, isolation from the hosting network may need to be proved or certified by the hosting network. For this purpose, remote attestation keys may be generated from the Digital Entity (D-XX module) so that the service operator may verify the integrity of the Digital Entity with the infrastructure provider. This capability may be included in the initial enclave provided by the infrastructure provider. The customer may be the network operator in this case, as the HOP is required for the network operator. However, the service may be extended to an outside customer to create an in-network HOP for their user. For example, an external DW customer may need an in-network DW isolated from the network and that service (i.e., DWaaS) may be requested from the ISMF 1050.

ISMF services (provided using an N-C/M-ISMF reference point 1051) may include initiating the acquisition and allocation of infrastructure for the creation of a hosting platform for one or more of D-users, D-Reps, D-Infs or DWs as requested by an authorized service consumer giving the service requirements.

Potential service consumer examples include: Network operators, HPCCF, HPIF, a 3^{rd} party wanting to create an isolated platform for an in-network DW, in-network D-Inf or any type of in-network D-Rep including D-Users.

### 6.31.2. HPCCF (HOP Creation and Configuration Function)

The HPCCF function 1052 can initiate the creation of a basic HOP 1008 by requesting the creation by the HPIF 1054 after obtaining infrastructure information from the ISMF 1050. After the creation of the basic HOP, the HPCCF 1052 may configure the HOP functions, change the access keys and instantiate more supporting functions according to a blueprint for that type of HOP. The HOP 1008 can be instantiated and configured by the HPCCF 1052, which may perform one or more of: managing resources of the HPFs relating to storing, processing and communications; creating the HPFs in the container; providing interfaces for the HPFs; and performing Life Cycle Management (LCM) of the HPFs inside the container according to a set of instructions.

HPCCF services may include:
Interpret the HOP service requirements, check available blueprints and finalize blueprints for execution by the HPIF;
Request the installation of a HOP after the required blueprints are finalized;
Send new blueprints to the BRMF to be saved in the BDR;
Configure the HOP Manager (HMF) and any other basic HOP function after creation of the HOP;
Request the HMF to instantiate internal functions required for D-XX module operation.
Potential service consumer examples may include: ISMF, BRMF, HOP-M.

### 6.31.3. HPIF (Hosting Platform Installation Function)

One of HPIF's 1054 main functionality may consist of installing the HOP 1068 and creating initial functions required according to the request from HPCCF 1052. The HPIF 1054 may be considered as the orchestrator of the hosting network 1004. The initial functions may include at least a HOP manager (HPM). They may also include other support functions such as privacy preservation functions of LCM functions.

Where hardware from vendors is used, the HPIF 1054 may have to contact the hardware vendor to obtain access codes to access and create the HOP with the functions required for the basic HOP. The basic HOP 1008 may consist of a HOP management function (HMF) 1068 which may include access control functions such as, for example, a C/M G/W function 1114, a database function 1020, a DP G/W function 1016 and an internal function orchestrator 1064. It may also create the related interfaces with the hosting network functions such as the HPCCF 1052 and the DUCF 1066. The HPIF 1054 may also create additional support functions.

The HPIF 1054 may pass the given access code or separate access keys to the HPCCF 1052 so that the HPCCF 1052 can complete the HOP creation by instantiating other support functions to create the intended Digital Entity (D-XX) 1006 and their operation and also configure them for the Digital Entity (D-XX) operations. Alternatively, creation of these additional functions may be done by the HPIF 1054 and the HPCCF 1052 may do the configuration of these additional functions.

Possible services of the HPIF 1054 may comprise:

Isolated enclave preparation: When a request to create a HOP as an isolated enclave is received, based on its policy and the requirements received in the creation request, the HPIF can decide what hardware may need to be obtained from a list of possible infrastructure solutions provided by the ISMF 1050 and it can obtain the infrastructure allocations to be used from the ISMF. If the ISMF 1050 has not acquired the infrastructure needed from an external vendor, the HPIF 1054 may instruct the purchasing department to obtain the HOP hardware required from the external vendor. Basic HOP management function description may need to be provided to the infrastructure vendor to prepare the HOP as a customized tool or package which can manage the HOP for the desired D-XX services.

For this purpose, the HPIF 1054 may receive a list of hardware vendors and their capabilities and the HOP requirements. After obtaining the hardware, the HPIF 1054 may install the hardware or activate the installed hardware and related ports as per a HOP blueprint or according to the requirement to create the isolated enclave.

After the isolated enclave is created, the HPIF 1054 may obtain security codes for accessing the internal HOP functions and create the HMF 1068 and other initial set of functions needed for the HOP creation according to the procedures given for the enclave.

When a request to create a HOP as a software container is received, the HPIF may instruct the hosting network orchestrator to create the HOP using the hosting network infrastructure and computing environment and allocate resources according to the requirement and acquire the management of the container.

When a request is received, the HPIF may provide a basic HOP to the HPCCF with established security keys for access where applicable.

Potential service consumer examples may comprise: the HPCCF, ISMF or the DUCF can be the functions that may request the creation of the HOP.

### 6.31.4. BRMF (Blueprint Description Repository (BDR) Management Function)

The BRMF 1058 function can manage the blueprint description repository 1056 (BDR). The BDR 1056 may contain blueprints of different HOP types and options and Digital Entity (D-XX) 1006 (e.g., D-users) that may be accessed using the BRMF 1058.

The services provided by the BRMF 1058 may comprise:

Update new HOP, Digital Entity (D-XX) blueprints, modify and terminate existing blueprints in the BDR.

Provide available matching blueprints when requested, optionally with HOP requirements.

Potential service consumer examples may comprise: HPCCF, HPM.

### 6.31.5. D-XX Service Manager Function (DSMF)

The DSMF 1074 can use the VR3 interface to trigger the HOP manager the creation of a new D-User portal after receiving a corresponding request. In some embodiments, a user may request it directly from DSMF 1074 using reference point VR2a and the DSMF may request the creation of an individual platform from the platform installer.

A network control plane function (MNO DUCF) can also make the request to the service manager using V2b interface for the creation of a new D-User. DUCF makes this request due to a request from the UE CPF or a request from another MNO CPF.

The DSMF 1074 can also use the VR3 interface to send the credentials of the UE and the associated security keys to the HOP manager so that HOP manager can create the D-User manager (D-User-M) and initial D-User functions. This may also enable the D-User-M to establish a secure connection between D-User manager and the UE. In addition, the DSM may pass the blueprints (network functions, interfaces and the procedural flow for establishment) of different UCM services to the HOP manager via VR3.

The DSMF can also request the establishment of a UCM service from the HOP manager using the interface VR3. If a UCM service is received prior to creation of the D-User, HOP manager may first request to create a D-User as indicated above prior to establishment of the UCM service.

### 6.31.6. DXCF (Digital Entity Creation Function)

The DXCF 1066 may arrange a digital entity creation when requested by a user, network entity or another D-Rep. A DUCF is a particular case of a DXCF.

The services of the DUCF 1066 may include the creation of a Digital Entity (in this case a D-User) inside a HOP following a request from HMF 1068. The D-User type to be created may be provided by the consumer.

The services provided by the DUCF can include:
create a D-XX module inside HOP by requesting from HMF. D-XX box type should be provided by the consumer;
Prepare and keep configurations, policies and mission blueprints required for different UCM services and keep them in a Database;
D-User creation function establishes Sync channel between D-User and UE
Establish AAA between D-User and UE;
UE capability assessment and Process UE requests for new UCM services and obtain;
UE capabilities in providing the service (e.g., software availability, computing capability etc.); and
Update UE profile with UCMS subscriptions.

Potential service consumers can include a user, an authorized hosting network function (e.g., when handover to a visiting network), the hosting network operator or an authorized 3^{rd} party service provider.

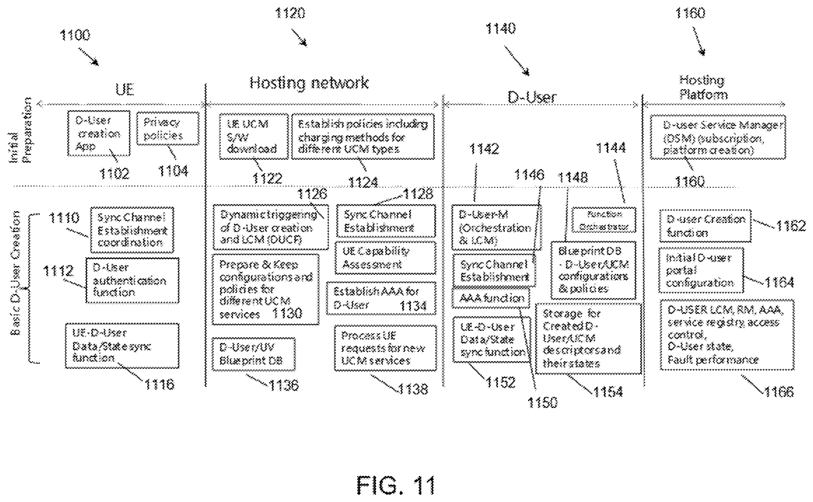

FIG. 11 shows D-User creation related functions in a User Equipment 1100 and in other network domains, including in the hosting network 1120, the D-User module 1140 and the Hosting Platform 1160. The UE 1100 may include an application to create D-Users or to request the creation of a D-User, which may be referred to as a D-User creation App 1102. The UE may also include functions to set privacy policies 1104. The UE may include functions to coordinate the establishment of a Sync Channel, which may be referred to as Sync Channel Establishment Coordination function 1110. The UE may comprise a function to authenticate the digital entity, such as a D-User authentication function 1112. The UE may include a function to synchronize data and states between the real and the digital entity, such as a UE D-User Data/State sync function 1116.

The hosting network 1120 can include download software to provide the UCM services, UE UCM S/W download 1122. The hosting network 1120 can include functions to establish policies including invoicing methods for different types of UCM 1124. For the creation of basic a digital entity, such as a D-User, the hosting network may include a function to trigger the dynamic creation of the D-User and Life Cycle Management (Dynamic triggering of D-User creation and LCM-DUCF, 1126. The hosting network may also include a function to prepare and keep configurations and policies for different services, including invoicing of some the services, i.e. a function to prepare & keep configurations and policies (e.g. invoicing) for different services 1130. The hosting network may include a database of digital entities, such as a D-User Blueprint DB 1136, D-User/UV Blueprint DB. The hosting network may also include the following functions: a Sync Channel Establishment function 1128, a UE capability assessment function 1132, a function to establish authentication, authorization and accounting (AAA) for the digital entity, i.e. a function to establish AAA for D-User, 1134 and a function to process UE requests for new UCM services 1138. The digital entity, such as a D-User or D-User container. 1140, may also include several functions, including for example at least one of: a digital entity manager functions 1142, such as a D-User-M (Orchestration & LCM), a Sync Channel establishment function 1146, a Blueprint BD D-User/UCM configuration and policy function 1148, a UE/D-User data/state sync function 1152, storage for the created D-User and UCM descriptors and their states 1154, and a function orchestrator 1144.

The HOP 1160 hosting the digital entity may include a digital entity service manager 1160, referred to as a D-User Manager (DSM) for subscription and platform creation function. The HOP may also include digital entity creation functions, including D-User Creation Function 1162, function relating to Initial D-User portal configuration 1164 and functions 1166 relating to digital entity LCM, RM, AAA, service registry, access control, digital entity state, and fault performance.

### 6.32. HOP Functions Supporting the D-XX Module Creation and Operation

The following are some of the functionalities required inside HOP. Different functions may be combined and implemented as one or more functional entities. For example, the HMF may take most of these responsibilities or spread the responsibilities across various individual functions. The following is an example categorization of the responsibilities.

### 6.32.1. HMF (HOP Management Function)

This control and management (C/M) function 1068 may take responsibility of:

continuing the actions needs to complete the creation of HOP (creation and configuration of the supporting functions needed) after initial creation and configuration as a basic HOP (including an HMF function), and

continuing to involve in operation of the HOP (creation of the D-XX modules and supporting their operation).

Certain Digital Entities (D-User or D-XX) 1006 may have a management function to take care of their own internal operations such as instantiation of other functions, LCM and resource allocation for them. In certain cases, the function instantiation inside a D-XX module 1006 and their LCM and resource allocation may be done by the HOP functions as well. For example, a D-User module 1006 may have a D-User manager so that it can take internal function instantiation and LCM. This may be important when the D-User management is fully done by the user. In that case, a HOP may be used exclusively for that D-User and the D-user manager is given the capability to create internal functions, do LCM and allocate resources.

The HMF 1068 may need to be configured by the HPCCF 1052 after it is created, in order for the HMF 1068 to take these actions. Some examples of the functionalities the HMF 1068 may execute are provided below. Some of these functionalities can be separate functions inside the HOP and whether these are handled by the HMF 1068 or a separate function is implementation dependent. For example, decision-making may be done based on the HOP AI function which would evaluate the actions and provide the recommendations or the evaluation results (e.g., prediction of the performance of an operation carried out by a D-XX module).

### 6.32.1.1. Creation of a Digital Entity (D-XX)

The creation of the Digital Entities (D-XX) 1006 and carrying out LCM may be the main function of the HMF 1068. The HMF 1068 may use internal function orchestrator 1064 (HFO) to create the Digital Entities 1006. If the HOP uses the hosting network infrastructure, the creation of D-XX modules is done by the hosting network's orchestrator based on a request from the HMF 1068. The requests in both cases may include the appropriate blueprints or essential components of the blueprint. The request may be received from the DUCF 1066 in the network or by the ISMF 1050. If an external host wants to have the ability to dynamically create Digital Entities (D-XX) 1006, such as D-Users, D-Reps or other types of D-XX, several D-XX of different types may be preinstalled and kept in a ready state, so that when a request is received, specific functions needed for the requested operation types are instantiated. The dynamic creation of these functions could be done by the HMF 1068.

The HMF 1068 may create D-XX 1006 with associated functions when a request is received from one of the hosting network functions, such as the DUCF 1066, the HPCCF 1052 or the ISMF 1050. The HMF 1068 may then use the internal function orchestrator (HFO) to create those modules when the HOP 1008 is provided with the capability of creating them inside the HOP (e.g., when independent operation is required). Otherwise, the hosting network functions HPCCF 1052 or HPIF 1054 would create those functional modules inside the HOP 1008. The functions required outside the HOP (i.e. software container or the enclave) may be created by the hosting network orchestrator or installer (i.e. the HPIF). The request may include a D-User type and the user access method and security keys to establish a communication link with the user. The creation of a D-User includes the creation of an isolated set of network functions and configuration of those functions and also the configuration of the common supporting functions that may be used for the D-User services inside the HOP or the hosting network. In some cases, D-User managing functions might create functions inside the D-User module instead of their creation by the HOP functions.

### 6.32.1.2. Instantiation of the Supporting Functions in the HOP and LCM of Those Functions:

For the operation of the D-XX modules 1006, several supporting functions may be needed which may be instantiated when the HMF 1068 is created, or the HMF 1068 may instantiate them. If the hosting network infrastructure is used, the instantiation of other supporting functions and LCM may be done by the hosting network orchestrator.

For this purpose, the HMF 1068 may be provided with full capability to create functions inside the HOP and to do LCM, configure them, create GWs outside of the HOP, access control and privacy preservation functions for the D-XX modules 1006 and other supporting actions for the applications run in the HOP 1008 and D-XX modules 1006.

### 6.32.1.3. Configuration of the Supporting Functions:

Once created, the supporting functions should be configured to do the necessary actions according to the blueprint. For example, one of the supporting functions inside the HOP is HOP Function Orchestrator (HFO) 1064 which is capable of function creation inside the isolated container and do LCM. Such a supporting function is privacy preserving portal (PPP) 1072, which may to be configured based on the D-XX modules and their services the HOP needs to support.

### 6.33. Privacy Preserving Portal (PPP):

Since D-User is deployed inside the hosting network, the privacy of the UE could be leaked to the hosting network and also hosting network information may be leaked to the UE. Therefore, it is proposed that several PPP functions be used, each having different objectives as indicated below.

6.33.1. Preserving UE Privacy without Exposing to the Host or to DN

One of the of the functions of the Ppp 1072 may be to protect the UE/customer data from being exposed to a non-trusted hosting network. This function 1072 may be provided inside the D-user/D-XX 1006 or inside the HOP 1008. If a trusted executive (TEE) is used, this function may be placed outside the HOP. Employing PPP functions, such as a data filter, in the UE or the customer equipment, e.g., using Full Homomorphic Encryption (FHE) techniques, may limit the use of data for the data consumers. Therefore, the Ppp 1072 may be provided inside the D-User/D-XX/HOP or in a secured location in the HN such that all the user queries, interests and other data may be shared only through this PPP. A Ppp 1072 may have the following 3 Core modules:

### 6.33.1.1.Data Portal:

The Data Portal provides data processing including: Data Collecting, Data Distribution, and Policy Application.

### 6.33.1.2. Crypto Suite:

The Crypto Suite provides fundamental privacy and security functionalities, including:
FHE (Full Homomorphic Encryption) module which helps to achieve the privacy preserving query and other operations,
IDM (Identity Management) which generate and manage the Pseudo-ID which represents the D-User/D-XX information. To ensure anonymity to the hosting network, there should be at least K number of D-Users/D-XX inside HOP as described in the K-anonymous requirement. For example, the K-anonymity model requirements can be used to anonymize user/customer communications to/from DNs (i.e. hosting network cannot know which user/customer inside the HOP communicated with the DN). The K-Anonymity requirement can be summarised as “for every combination of identifying attributes in a dataset, there are at least “K minus 1” other people with the same attributes”. Therefore, the source ID may be changed with a randomized ID and also the return address to the D-User/D-XX/user/customer may be randomized with a randomized location. These locations may change every time a communication is established with an external DN.

### 6.33.1.3. Policy Engine

The Policy Engine provides the updated access policy from the User/customer and interacts with the Crypto Suite module and Data Portal to reflect the dynamics of the User.

### 6.34. Access Control and Authorization

The access to D-user/D-XX 1006 and HOP functions may be tightly controlled. Any incoming message should be first authenticated and then authorized if authentication has succeeded.

### 6.25. Blueprint Storage and the Storage Managing Function

D-User blueprints, or more generally digital entity (D-XX) blueprints, may be stored in this storage. D-User/D-XX blueprints describes the structure, configuration and the procedures for how to create and control the D-Use/D-XX module from the instantiation to the termination. Different D-User/D-XX modules has different features.

For example, a D-User/D-XX blueprint may consist of one or more of:

User-ID, customer identity, User/customer IP address, D-XX type(s) supported (e.g. specific D-User type or/and UCM service type(s), D-Inf types and service types supported, X—R types supported)

The constituent functions required for each service the D-XX module support for each D-XX type (e.g. UCM service types D-user support in a particular implementation),

Service establishment procedure for each service supported by a D-XX module (e.g. UCM service establishment procedure for each UCM service type for a D-user).

Service operation procedure for each service supported by a D-XX module (e.g. UCM service operation procedure for each UCM service type for a D-User).

Resource requirements for the D-User which include storage, computing and link capacities for different interfaces. Computing resources may include the number of CPUs or GPUs and their speeds and allocated % of CPU power from the computing engines and RAM memory requirements. Storage requirement may include storage size and access speeds.

The QoS characteristics (e.g. latency, packet loss, data rate etc.) of the links between the D-XX module and the associated real entities such as customers, users, and the links between the D-XX module and the network functions in the HOP or hosting network. (e.g. for a D-User, the link between D-User and the user, links from D-User to other network and HOP functions such as HPCCF, DUCF, ISMF.)

### 6.36. Accounting and Invoicing Function

Invoicing D-XX services is carried out by this function. Invoicing (or charging) can be based on D-User service types or the amount of traffic used for these services or based on both criteria.

### 6.37. Common Database Manager (CDM)

The CDM 1020 controls to the database. There can be a common database which is used by multiple D-XX modules. These data areas needed to be isolated from each other and each D-XX module would be given access only to data stored by those modules. In addition, when data is stored outside the HOP in a common hosting network database, data transfer to and from the other database may be controlled by CDM or by the HOP's DP GW.

### 6.38. Fault and Resilience Management Function

The fault and resilience management function may monitor the performance of each D-XX module operations and if any quality degradation or malfunctioning is noted it would provide the input to the HMF which may take appropriate action based on the decision maker input.

### 6.39. Performance Management Function

The performance management function may monitor the performance of the individual communication links supporting an operation of a D-XX service as well as the overall D-XX service delivery quality. If there is any performance degradation (e.g. expected performance (overall delay) is not met, an action is taken to inform the D-XX manager and the HMF.

### 6.40. Resource Management Function

There can be a resource management function in the HOP as well as in each Digital Entity (D-XX). This may include monitoring and dynamic allocation of resources, including memory and bandwidth, to meet the Digital Entity's needs.

### 6.41. In-Network Processing Functions:

There may be common in-network processing functions for standard types of processing needed for the Digital Entities (D-XX). If a Digital Entity is required to perform a specific type of processing, it might need to create the necessary functions within the module itself or the HOP may need to provide the D-XX with the required software to create those functions. AI functions, as discussed in the next section, may be considered as one type of processing. These AI functions could be a standard AI scheme or a specific type required by the Digital Entity. Similar to other processing functions, AI functions can be implemented either within a Digital Entity or within the HOP.

The computing resources needed for processing functions may be specified in a Digital Entity blueprint. As the processing may be dynamic in nature, the computing resources may need to be adjusted.

6.42. Artificial Intelligence (AI) functions

AI functions are specific type of processing function. AI functions may be available as common AI support functions inside the HOP or inside Digital Entities to prevent exposure of data used by the AI schemes to the hosting network. These AI functions can be used for many services including, for example:

User decision-making.

Support of a user's applications.

More efficient and improved running of various services (e.g., user home control, user mobility prediction, user interests tracking etc.).

In case of D-XX modules other than the D-User module, these modules may require more specific AI functions.

A method may need to be determined to train the AI functions described above.

### 6.43. D-User/D-XX Functions Established During Initial Step of D-User/D-XX Creation

A digital entity manager (D-XX Manager, also referred to D-User-M or D-XX-M) is instantiated with the creation of the digital entity (D-User/D-XX). When the HOP uses an enclave and contains multiple digital entities, then in order to perform remote attestation for the owner or customer of the digital entity (D-XX customer/owner, such as D-XX service provider which is the user in the case of D-User) the digital entity and the initial functions are instantiated according to the specification of the vendor. If a separate enclave is used for the digital entity, a separate D-XX-M may not be necessary and the HOP-M can carry out the functions of the D-XX-M, including preparation for the remote attestation.

Once the security keys and the user information are received by the D-XX-M, it may obtain methods for contacting a network function (e.g. DXCF) using HOP-M in the case of an enclave with multiple digital entities (multi-D-XX enclave) or directly in the case of single entity enclave. Then the D-XX-M may contact the user using DXCF and set up a secure channel (Sync channel) by creating shared keys.

The D-XX-M can determine the remote attestation code (e.g., a signature of the code such as a hash function) and provide it to the user or digital entity customer for attestation. Once attested, the digital entity creates the other functions needed for the Entity Controlled and Managed Services (UCM services or D-XX services) the user/customer requires according to the digital entity blueprint. The blueprint may be provided when the digital entity is created or may be obtained from the hosting network or from the user/customer. User/customer may provide software for any service user/customer needs as well.

### 6.44. Functions in the UE or User Application Related to D-User Creation

Functions in the UE or user application may include:
A function to request the D-User service after receiving the D-User service types available. This may be provided to the UE as a user application,
Install the software for the UCM services when received from the hosting network,
A function to prepare the packet header changes for the packets received from the user application to the lower layer (e.g. network layer) or packets transmitted from the lower layer to the user application.

A function to do pre=processing of the user application data before sending it to the network functions to secure the privacy.

Established sync channel between the D-User and the user after authentication the D-user, and

Remote attestation of the D-User by obtaining the related code and the public keys and IP addresses of the attestation authority from the D-User.

### 6.45. D-User/D-XX Instance Creation Procedure and UCM Service Establishment

An exemplary high-level message flow for D-User creation and UCM service establishment is provided below. For the UCM establishment, the D-User needs to be created inside the network. The message flow includes:

The HNO's customer service department (CSD) provides a description of the available D-User and UCM service to the public. It may be provided by broadcasting the information to UEs or users may obtain by requesting or user access the information from other sources (e.g. from the HNO's web site). Information include service descriptions such as privacy levels and user processing facilities, charging methods for different types of services.

P-User subscribe for a suitable one or more of D-User type or UCM service type with CSD. This may be for a basic D-User subscription as explained later.

CSD inform the subscription to DSMF.

CSD confirm the subscription to P-User with charging information.

Optionally a user application can contact DSM to subscribe for D-User or UCM service type.

Optionally a network entity may request a D-User creation from the DSM.

DSM confirm subscription to UE, UE app or network entity as appropriate.

DSM record the subscription in the user subscription profile in UDR.

DSM request D-User creation from HPCCF or HOP C/M depending on how the HNO create the D-User functions.

HPCCF or HOP C/M creates the basic D-User with essential D-User C/M functions.

Establish sync channel, a secure link between user and D-User.

If initial subscription is only for a basic D-User, user app may find the requirement of a specific UCM service and trigger the UE. Otherwise, this could be a request to add another D-User service. Otherwise, this step is optional.

UE trigger the new UCM service establishment request from DUCF if it is not already subscribed for,

DUCF checks the availability of the UCM service type and the other requirements such as resource availability and record the UCM service as a new subscription to UDR.

DUCF request HOP C/M or the HPCCF as applicable, the establishment of the UCM services already subscribed by the user Include new UCM service request or the original subscription from the UE with the D-User request.

HPCCF or HOP-C/M request the D-User C/M to establish the UCM service.

UCM service establishment which involve D-User, HOP, hosting network and UE function creation and configuration.

UCM establishment confirm to the UE and the user app and any new software needed for the operation is sent to the UE for installation.

User can now use the UCM service.

### 6.46. Subscription Options and Procedures

The HNO may offer various example subscription ways for D-User services to the digital entity customers, e.g., its users. For example, subscription options may include:

### Option 1:

Subscribe for a D-User service,
Create a basic D-User,
Subscribe for a UCM service, and
Add UCMS functionality to D-User;

### Option 2

Subscribe for a new UCM service,
Create a basic D-User if no existing D-User, and
Add new UCMS functionality to D-User;

### Option 3

Subscribe for both a D-User and a UCM service (or specific D-User type providing the UCM services),
Create a basic D-User, and
Add UCMS functionality to D-User.
   Options 1, 2 3 may be used for creation of a D-User starting from the subscription. There is another case, option 4 detailed below, of creation of an additional D-User to support an existing D-User and an existing UCM service dynamically.

### Option 4

Network identifies a need for an additional D-User at a particular network segment to support a UCM service already in operation (UE already subscribed for the UCM service). A D-User for the UCM service already exists (May be in a different network segment, e.g. handover of a UCM service).

Create the additional D-User in the identified network segment

Establish communication with existing D-User and the additional D-User or UE and the additional D-User or both.

In the above description, creation of a basic digital entity (such as a D-User) and adding UCMS functionality is indicated as two separate steps, However, as per D-User type description indicated in Table 1, these two steps can be equivalent to creating a specific D-User type which include those UCMS functionality.

Example detailed procedures for subscription are provided below. The order of the steps depends on different implementations as indicated by above options.

### 6.47. Procedure for D-User Subscription

Given that there may be several types of D-Users with different complexity and cost depending on the type of UCM services it can provide, an HNO may use different ways to keep user subscription records for D-User services in the user's subscription profile. Some examples include:
Record of a subscription of a basic D-User type and a record of each UCM service subscribed,
Record of a D-User type subscribed,
Record of all the UCM services subscribed, and
Record of a specific D-User type and the added UCM services subscribed.

Once subscribed for a D-User this may be included in the user subscription repository (UDR) controlled by a user subscription manager (USM). Then, when a user requires to establish or use a UCM service, the network may check whether the user is authorized by checking the UDR. For this purpose, the D-User service provider may publicize or provide the user with all the information of the D-User services, various methods for subscription and associated policies which include charging policies and privacy policies. Some HNO's may create a D-User, provide the software for the user to install for the service and establish a secure connection with the D-user after subscription for a D-User. This may be done usually if the subscription is for a UCM service or a D-user type other than the basic D-User. If the subscription is for a basic D-User, some HNOs may take one of the following actions: Create the D-user and establish a secure connection with the user, plan and prepare the network to provide the D-user but not create the D-User and wait for a D-User service or UCM service request to create the D-User.

In case of a data network providing D-User services, the user may be given the following subscription options:
Basic D-User subscription followed up with a dynamic UCM service access,
D-User type subscription, and
UCM type subscriptions

In the case of an MNO providing D-User services, there may be at least two options for a user to initiate the creation of a D-User: (1) subscribe with a business/service management layer or (2) subscribe automatically whenever user needs a D-User service.

For example, the user may subscribe with the PLMN's business management layer (BML) or service management layer (SML). This can be done similar to user subscribing for a mobile communication service. The user can subscribe to this service as an added feature to UEs subscription when user subscribe for a mobile communication service or subscribe later when user needs the service. The process may be similar to a UEs subscription for a service package with the PLMN. In addition, a user may be allowed to directly subscribe for a UCM service online using a user application with the PLMN and in that case, the D-User subscription may be done automatically. The user application may be downloaded from the MNO web sites. Once the UE is subscribed for a D-User or UCM service, the MNO updates the UDR about one or more of subscribed D-User types and subscribed UCM types.

Alternatively, the dynamic subscription can be requested by the UE. In some networks, a UE may be allowed to automatically trigger the creation of one or more of a D-User or a UCM service by sending a message to a control plane function of the MNO. For example, the MNO can have a D-user creation function (DUCF) which can check the UE's authenticity by checking with the AMF (e.g. UE ID check) or by directly querying the UDM.

This may be initiated by the UE when UE requires to use an application that needs a UCM service. The procedure may include:
Identifying the need for a UCM service such as a privacy requirement or user data processing service by the UE or by the user. This may be done by checking the available UCM service types and/or D-User types and procedures by looking at the broadcasting channel of the PLMN or any user accessible location. Users may also make a request from the MNO obtain the services;
Determining the D-User type required for the UCM service;
Sending a subscribe message to a network function for the D-User with the D-User type ID;
Network function checks the authentication and does the authorization of the service after checking from the policy function and user equipment capabilities authorized services;
If the user's PLMN subscription indicates that the required UCM service can be allowed, accept the subscription by sending an acceptance message to the UE. Required invoicing methods and other policies are also negotiated in this process. The UE may be provided with the software required for the subscribed UCM service operation. Once required software is installed, the UE may start the D-User services.

### 6.48. Procedure for UCM Subscription

The procedure may depend on whether a D-User subscription is already available or not. If no D-User subscription is available for the user, there are at least two ways to subscribe for a UCM service:

The user identifies the D-User type required for the UCM service and requests the subscription for the D-User type as indicated in the previous section. Some HNOs may allow user to subscribe directly for a UCM service and the network may include subscription for a basic D-user or specific D-User type or the required UCM service and take action as indicated in the previous section,

The user sends a message to subscribe for a specific UCM service from a control plane function and the network determine the matching D-User type required and adds user subscription for one or more of a matching D-User type and the specific UCM service.

If a D-User subscription exists, a user may subscribe for a UCM service in at least two ways:

Send a UCM request message to a network function by including the UCM type. Procedure include the following steps:
Identifying the need for a UCM service by the UE or by the user,
Checking whether the existing D-User type allows this UCM service,
Sending a subscribe message to a network function for the UCM service with the UCM type ID,
Network function checks the authentication and may authorize it after checking the subscription profile, user device capabilities and associated charging and other policies, and
If the users PLMN subscription indicates that the required UCM service can be allowed, accept the subscription by sending an acceptance message to the UE.

Send a UCM service request message directly to the D-User already instantiated according to the subscription, and D-User may make arrangements to establish the UCM service by configuring the required D-User, HOP and hosting network functions. If new functions are needed it may take action to create them by informing the appropriate function in the HOP, hosting network or D-user as applicable. In some cases, the D-User may add subscription in the MNO by registering the service with the UDR by informing to an appropriate network function (e.g. DUCF). This is similar to above scenario (a), except for the fact the user subscription message sent by the D-User.

6.49. Creation Procedure after Subscription
6.49.1. Case 1: D-User is created using a TEE environment

In this possible embodiment, referred to as case 1, first the D-User-M is created and establishes a secure communication channel with the UE. The D-User-M may be provided with the capability to instantiate the NFs required for the authorized UCM services for that D-User and other LCM functions without the knowledge of the hosting network, such as a MNO. The LCM may charge (bill or invoice) for the UCM services using the information it obtains from D-User-M on the services provided. Invoicing can be based on one or more of the resources used, the type of services used, types of applications run, or the amount of traffic that is sent in and out of the D-User (for each type of QoS). Therefore, the D-User-M is created inside the TEE with the capability to provide that information to the MNO. In addition, the D-User-M may be carrying out the resource management for different UCM services. The following is the exemplary detailed procedure.

The network receives (e.g. via the DUCF) a subscription for one or more of:
UCM service
D-User type with a specific UCM service(s)
A basic D-User type

The network, via a corresponding function, such as the DUCF, checks with UDM whether UE is authorized for the subscription and if so, accepts the subscription. The network determines that the D-User needs to be instantiated, may be imply receiving a request for a UCM service, or network always create the D-User once a D-User subscription is received. The network may select a TEE and may request to instantiate a D-User-M with the capability to instantiate further functions based on the type of UCM services that could be supported. This may include the information of the NFs required for each UCM type with UMC type ID, the interfacing requirements (egress, ingress points) for CPF, UPF connections, invoicing related information such as how the resource usage is informed back to the network, how the network information is provided to the D-User and how the UE data is shared to external entities all of which depends on the UCM type.

Two options may be available for provisioning the digital entity, such as a D-User. One option includes that the UE can create the required UCM services by directly communicating with the D-User-M without having to communicate with the network. For this purpose, a communication link, which may be referred to as the synchronization channel, is set up between the VU-M and the UE. The D-User-M may create the necessary functions and the interfaces and informs the UE of the communication procedures, such as signaling requirements, data preparation for transmission and extracting UCM data.

Another possible option is that the LCM of the UCM services (Establishment, modifications including scaling up and down and NF modifications and termination) may be done with the awareness of the hosting network, such as a MNO. This may allow invoicing for the UCM services instead of invoicing for the resource usage and/or UE type basis. In this case, when a new UCM service is required, the UE or D-User may send a request from the network.

6.49.2. Case 2: D-User is Created Using the MNO Infrastructure within a Trusted Environment

Once an MNO decides to create a D-User (e.g. after UE subscribed for a D-User/UCM service), the OAM function (e.g. D-User network orchestrator, VUNO) in the MNO is triggered. The VUNO creates a VU-M function and associated NFs and required interfaces to the CN network functions. If the D-User needs to be created with the UCM services the functions include the basic D-User functions as well as the functions required for the UCM services which can include both CPFs and UPFs. This is similar to a subnetwork in 5G with CPFs. The interfaces include a sync channel between the UE and the D-User. Sync channel could include a signaling interface. In addition, depending on the D-User/UCM requirement one or more data channels may be set up.

The D-User-M may be provided with the UE identification and authentication methods. Setting up the sync channel may include the hosting network, such as the MNO, providing both UE and the D-User-M the security keys, UE identification (this may be different than the UE ID) and address information. After that the UE may set up its own security keys for communication with the D-User.

In some embodiments, the D-User-M may give the authority to create CPFs and UPFs. A proxy VNFM, and a proxy VIM may be provided and an interface may be provided with the VUNO for this purpose. In these embodiments, the LCM of NFs may be done by the D-User-M or the VUNO.

An exemplary procedure for D-User creation includes:
When the HOP is created, a HOP-M is provided with all the D-User box blueprints which are also given to the DSM function,
The DSM or MNO OAM broadcasts to the P-Users the D-User types or/and UCM types.
The MN broadcasts or publicizes the available UCM services or D-User types

P-User Subscribes for a UCM Service or D-User Type:
User subscribes to a D-User service which would lead to creation of a basic D-User and later request UCM service.
User subscribes to a specific D-User Type(s) which can provide a group of UCM services.

User subscribes to a specific UCM type(S)
P-User request D-User service (can be specific type, in that case, type ID is provided).
Optionally the request may be made by a network entity.
N-AMF function authenticate the UE like 5G and forward the request to the DSM.

DSM check the subscription if eligible and request the creation of the basic D-User from HOP-M
HOP-M creates basic D-User using HOP function orchestrator.
Orchestrator creates the D-User with D-User-M and other basic D-User functionality.

HOP-M configures the D-User with security keys for communication with UE, and the blueprints for all the UCM types
Now user can request a specific UCM type to be added. If in 4, a specific UCM or D-User type is requested that may be automatically done in this stage.
Once UCM service is established, P-User and D-User can use that UCM feature any time.

### 6.50. Life Cycle of a D-User

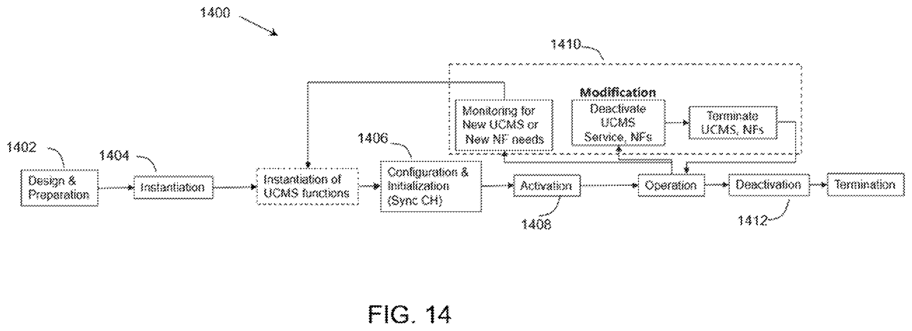

Once a user subscribes for a D-User, several steps may need to be taken by the MNO to make a D-User to a fully operational state. In the present disclosure, different implementation possibilities are described. In the process, a D-User can have different states from the preparation to fully operation mode. This can happen in different ways based on the UCM services the D-User expected to provide. In addition, different MNOs may use different steps in creation and using it for UCM services. For example, A D-User life cycle may consist of following exemplary as shown in FIG. 14. The life cycle includes a design and preparation phase 1402, an instantiation phase 1404, an initialization phase 1406, an operation phase 1408, a modification phase 1410 and a deactivation/termination phase 1412.

Before operation, the D-User is to be activated and before termination the D-User is to be deactivated. During operation phase, the D-User can be modified by adding or deleting UCM services and adding and deleting network functions as required by the UCM service operations.

When a UE is subscribed for a D-User without subscribing to any UCM service, the MNO does not need to instantiate the D-User and it can design and prepare the network for the D-User creation. D-User instantiation can happen at that time whenever a UE subscribe or request for a UCM service and after the instantiation the D-User is configured and initialized with UE's policies and required other information.

For some UCMS scenarios, the D-User has to obtain UE details before providing the UCM services (e.g. UE interests, location, user policies, communication keys and authorization privileges etc.). In that case a D-User may go through an Initialization phase where it is connected with the UE to obtain those UE details. After this initialization phase, the D-User's UCM services are activated and the D-User will be in the operational (active) phase. Once activated the D-User is ready and the PDU sessions of the subscribed UCM services could begin. There can be scenarios where a user does not need a UCM service for some periods. In order to save resources, the D-User may be made inactive or semi-active in such cases where the sync channel is also disconnected or move to an idle state. The D-User may be terminated if the UE does not need it anymore (e.g. during a handover from visiting network to another network, visiting network does not want to keep a D-User unless there is a chance to use it again).

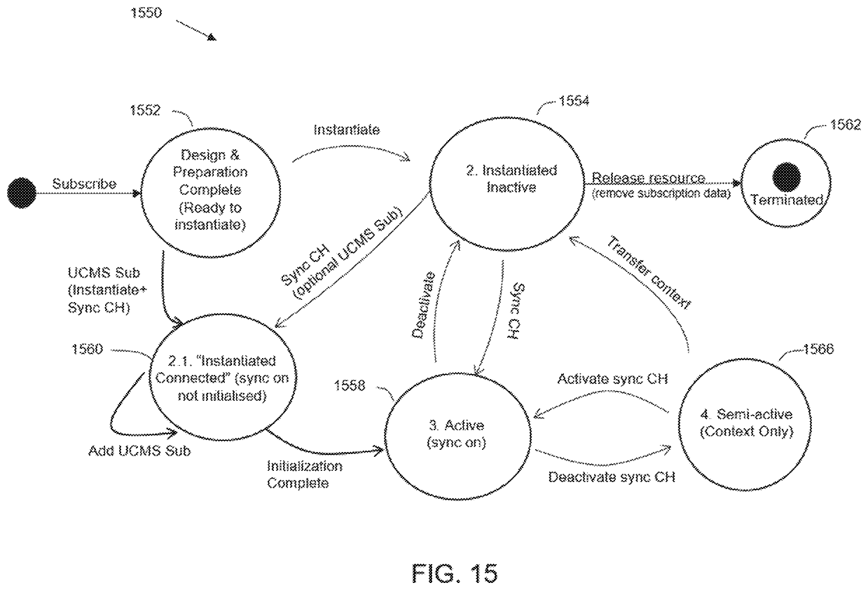

The D-User may go through several states or modes during its life cycle. The transition or flow 1550 between possible states of the D-User are shown in FIG. 15. D-User states and state transition conditions are detailed below. The states of a digital entity may include a design and preparation state 1552, a state where the D-User is instantiated but inactive 1554, or a state where the D-User is instantiated and connected 1560, a state where the D-User is active and the synchronization is also ongoing 1558, a state where the D-User may be semi-active 1566, and a state where the digital entity is being terminated 1562.

### 6.50.1. Design and Preparation State 1552

Note that when a D-User needs to be created, the network may create only a D-User descriptor (or a blueprint) outlining all the NFs, the interconnections and resources needed and wait for a trigger for the creation, for example, receiving a subscription for a UCM service or D-User. For different types of D-Users different descriptors may be available. Some HNO's may create D-Users even before a trigger is received, without allocating to any specific user, so that when a user requires it D-User can be assigned to the user quickly. For this purpose, the HNO may create several D-Users of different types and keep them in “Instantiated-Inactive” phase 1504 without assigning a user. This is useful for an MNO, when a user with a D-User is handover so that it can quickly assign a D-user to the user. Therefore, depending on the HNO or the type of subscription (subscription includes a UCM service, basic D-user or specific D-User type) the D-User may be instantiated and transfer its state to one of the following states:

### 6.50.1.1.Transition to ‘Instantiated-Inactive’ State 1554

Some MNOs may instantiate the D-User and keep it inactive (‘Instantiated-Inactive state’). Even after a user is subscribed for a D-User, some HNO's may create the D-User and keep it in this state. In this case, the D-User is allocated to the user, but sync channel (Sync CH) is not established with the user which may be done when the user requires to establish a UCM service, Some HNO's may establish the Sync channel when the user subscribe for a UCM service indicated in the state diagram as ‘UCMS Sub’. Some HNO's may even not connect the Sync channel after subscription for a UCM service and keep the D-User in this state and wait for a specific UCM session establishment request is received. This may also be done depending on the UCM service a D-User required, in particular when the initialization state is not necessary for a UCM service or initialization does not take time.

### 6.50.1.2. Transition to ‘Instantiated Connected’ State 1560

Yet some MNOs may instantiate the D-User and keep it connected to the UE by establishing the connection to UE through a Sync channel (CH) so that the D-User can be initialized.

The following functions may be required for the preparation stage:

UE functions:
UE app for UCM/D-User service subscription/request and UCM service software download.
This is required for the case, where an HNO does not instantiate the D-User even after a subscription.

HNO's C/M functions:
D-User service manager (DSM) function for UCM/D-User type subscription
Providing UCM software to the UE if a user has already subscribed.

Establish policies for different UCMS types (charging, priority, mission graphs)

D-User blueprint preparation function: For each UCM service type that is expected to be provided, this function identifies the network functions, interfaces and operation policies for those UCM services and store it in a HNO's blueprint database to be sent to the HOP or/and D-User when the D-User is created. The required interfaces with the ingress and egress ports of the D-User for each NF of the D-User needs to be identified for this purpose.

### 6.50.2. Instantiated Inactive (Standby) State 1554

Once a D-User is instantiated, the D-User may be kept in the standby (inactive) mode to save resources. During inactive mode user does not have any interaction with the D-User CPFs and UPFs. As explained before, there are at least two possibilities:

D-User may not be assigned to any user at this stage and keep this standby to be assigned to a user when it is required. D-user may be configured for a specific UCM service type(s) or D-User may be a basic D-user.

D-User is assigned to a user but not connected to the user D-user may be configured for a specific UCM service type(s) or D-User may be a basic D-user.

Instantiation of UCMS functions: Instantiation of functions required for a specific UCM service may be done at this stage as indicated by the life cycle diagram. As mentioned before different UCM services may require different functions whether they are in hosting network, HOP or in the D-user.

6.50.2.1.Transition to next state

Usually when a UE subscribes to a UCM service (UCMS Sub) the D-User has to be changed to Active state because a PDU session of the UCM service could be initiated at any given time. Some UCM services need the D-User to be initialized with the UE information, guidelines, and policies before actually using the D-User for the UCM service. In that case D-User state is moved to ‘Instantiated Connected’ state and after initialization is complete it would go to the Active state where UCM services can use the D-User. For some UCMS cases, if the standby to Active changes (e.g. initialization process) does not need much time, the HNO can activate it whenever a UCM service related traffic is generated and transition to Active state could happen when a UCM session of the UCM service is started for the first time.

6.50.2.2. Active to Inactive transition

In addition, when a D-User does not expect to use a UCM service for a long duration including the need for keep alive message or the sync channel, a D-User can move from Active to Inactive state by deactivating the D-User.

6.50.3. Instantiated Connected state

As explained, when a user moves to this state, the D-User is connected to the user and specific functions needed for specific UCM services are already instantiated. The D-User is not initialized yet. The activation of the D-User (preparing the D-user to provide a specific UCM service) begins at this stage which needs transferring UE data to the D-User, establishment of authentication keys, establishing UCM service policies, obtaining specific software from/to user for UCM operation etc. These depends on the UCM service the UE is expected to use. A sync channel is established between the UE and the D-User for this purpose.

Configuration and Initialization: As in the life cycle diagram, this box indicates the need to create and configure the specific functions required for a supported UCM services since different UCM services may need different functions as well as different configurations. Depending on the UCM service this may be done at the inactive state and this action may either not needed or only some minor configuration parameters may need to be changed. For example, if a UCM service is in-network processing, the user may provide the specific software for processing to the D-User and D-User install that and establish a method to identify such data from the UE and process them and transfer data as per the instructions from the user or as indicated in the software.

6.50.3.1. Transition to active phase (e.g. Activation)

Once the initialization is complete for a particular UCM service the D-User moves to the active state.

6.50.4. Active state 1558

During active state a D-User is fully configured for the UCM service and could be used by the UCMS session for example PDU sessions or data processing sessions. At least one UCM service is in operation in this state as indicated by the ‘Operation’ box in the life cycle diagram. However, it does not mean that a ‘UCMS session’ is in operation, a session can be established at any time and the network is ready for user to start a UCMS session. The logical synchronization link between the UE and the D-User is used by the UE to communicate with the D-User.

During active state the D-User can be modified by deactivating a UCM service, activating a UCM service, terminating a UCM service or adding a new UCM service. Sub-states of the Active mode exist based on the state of the UCM service being subscribed. All those sub-states may be related to one or more of an active UCM service state, a standby UCM service state and terminated state. Active UCM service is a USMS service in operation. Standby UCM service is where the user has subscribed for the UCM service but no UCMS sessions is active or in operation. Terminated UCM service is when the user cancelled the subscription or when the subscription duration is expired and HNO removes the UCM service. The details of these sub-states are not discussed here but may be discussed in a detailed UCMS operation document.

6.50.4.1. Transition to Semi-active state 1556

When a UCM service is not used for a long time the D-user may be placed in a ‘semi-active’ state, by keeping the sync channel in a deactivated state, but the D-User context is not removed. In this state the Sync-channel information is still kept and but when communication between the D-User and the user is needed, either User or the D-user would initiate the activation of the channel by making a request to a hosting network (E.g. DUCF) or HOP function (HMF).

6.50.4.2. Transition to inactive state

When all the UCMS subscriptions are cancelled or expired while in the active mode (i.e. no more existing UCMS subscriptions) the D-User can be deactivated and be moved to Inactive state and may be moved to terminated state from that state. In some embodiments, the D-User may be kept at Active state even no subscribed UCM services because UE can dynamically subscribe to a UCM service.

6.50.5. Semi-active state 1556

In this state, the sync channel is disconnected or dormant. This may be done when there is no active UCMS session for a long time or user does not need to interact with the D-User for some duration. However, the network may interact with the D-User and D-User may take actions on behalf of the UE (authorization, data processing, prefetching, data sharing, store messages from external parties etc.). Exemplary scenarios include:

When a UE moves from a visiting PLMN to another PLMN (home PLMN or a visiting PLMN) the first D-User may be terminated or move to Inactive state and prior to that the D-User may need to transfer its context for which the Semi-active state can be used.

When a UE is offline, the D-User may not be connected to the UE with the Sync channel, but the D-User can take actions on behalf of the UE and continue its operation with the network or other entities for the communication requirements of the UCM service.

When an UE is online but the user or D-user is carrying out certain processing of data until they need to be communicated again, e.g. training phase in an AI process.

60.50.5.1. Transition to active state

When communication between the D-User and the user is needed, either User or the D-user would initiate the activation of the channel by making a request to a hosting network (E.g. DUCF) or HOP function (HMF).

6.50.5.2. Transition to instantiated-inactive state

The D-User may transfer all the D-User and user context in the D-User including those associated with all the UCM services to a user or remove that as per the instruction from the user or it may be determined by the D-user itself after observing the operation of all the UCM services. It may also take action to remove all the UCM services before moving to instantiated-inactive state.

6.50.6. Terminated state 1562

Before terminating a D-User all the UCM services should be terminated. The D-User itself, hosting network or UE decides to terminate a D-User. The network would decide if the contract is over or when a D-User installation is originally triggered by a network entity (e.g. during handover). D-user would decide once the purpose of creating it is completed. A user would terminate it if user does not want it further.

The termination procedure can include:

Request to terminate the D-User is received from a user or a network entity or D-User itself decides to terminate it as explained above.

Deactivate al the UCM services and terminate each of them. Remove the specific functions used for the service, change the configurations if needed (specially hosting network functions and HOP functions), communicate with the user to remove or configure the specific functions used for UCM service and inform the final termination to the user and to HOP and hosting network if applicable (HOP or hosting network may not be aware of certain UCM services D-user use).

Before termination D-User context may be transferred to another D-User or UE depending on the UCM service as indicated above.

Inform UE the need to disconnect the sync channel and erase associated security keys. Inform the HOP or hosting network to remove the D-User and associated functions in the HOP and hosting network specific to the D-User.

6.51. UCM service subscription

This application provides a network operator a method to provide a wide variety of user controlled and managed (UCM) services using a digital representative of the user (D-User) inside a network.

In some embodiments, the method includes UCM service preparation by the hosting network. The UCM service preparation can include creating a D-user module inside the network comprising one or more network functions. The method further includes UCM service establishment, which can include receiving a request for the establishment of a specific UCM service type, creating a secure link for the user to communicate with one of the UCM service functions through which the user can instruct a UCM service function to actions required for the UCM service, and modifying the D-User module and the hosting network to make it capable of providing the specific UCM type. For instance, modifying the D-User module can include adding new functions inside the D-User module required for the specific UCM type, adding new functions inside the hosting network required for the specific UCM type, configuring the functions inside the D-User module, or configuring the functions in the hosting network.

The method also includes a UCM service session setup step that can include sending a UCM service session establishment request to a network function by the session initiation node containing a UCM service type, and establishing data paths required with the needed resources to provide required QoS for the UCM service session (e.g. user to a DN, user to a network function, D-User to a network function, User to D-User, D-User to DN) for both directions. The method also includes receiving by the session initiation node a confirmation of the UCM service establishment with the data packet format to be used, and starting the session by sending session data packets through the established data paths.

In some embodiments, the UCM service preparation includes
Determining the type of UCM services that the network can provide, identifying a charging mechanism, and preparing a blueprint for these services,
Determining the UCM service functions required in the network that may be needed for the UCM services and the privacy requirements for the functions and the data they handle,
Determining the configuration requirements for the already existing network functions or if available, hosting platform functions,
Sending the available UCM service (UCM) types to the user,
Instantiating the determined UCM service functions required for UCM operations inside the container, wherein the container contents are privacy preserved, and,
Configuring a network function to establish the UCM session when the network function receives a request for a UCM session from a user.

In some embodiments, the method further includes receiving a request for a UCM session by a user, and establishing a secure communication link between the D-User and UE associated with the user. In this case, the method may include configuring the UE associated with the user and the UCM service functions and initialising the UCM service functions with the user data. Optionally, a process is established to continue providing user data to the UCM service functions when required for the UCM service operation. In some embodiments, the user may start data transmissions relating to a UCM service session and the network and the D-User may identify the type of the UCM service session and process the data packets of the data transmissions as per the established UCM service. For example, any data transmission, between the user and the D-User, or between other elements of the network, can be identified and processed by the network or the D-User according to the type of UCM service.

6.52. Procedure for UCM service establishment

Before proceeding with the UCM service establishment, in some embodiments, a basic digital entity, such as a basic D-User, may be already instantiated, and a sync channel may already be established. As there are different possible implementations for creating a digital entity, including D-Users, the establishment of Entity Controlled and Managed Service, which may correspond to UCM services when the services are for users, may vary according to how the digital entity has been or is being instantiated. The examples given below concern digital entities corresponding to D-Users, but the same process can be implemented for other types of digital entities D-XX, such as for D-Reps or digital processes, for example.

Generally, a method for establishing User Controlled and Managed (UCM) services for a user is provided. The user uses a digital representative (D-User) inside a hosting network. The D-User may support or act on behalf of the user. The method may comprise the following steps: a request for establishing a UCM service is received, where the request includes a UCM service type. The UCM service corresponds to a service provided by the hosting network using the D-User. The method also comprises a step of establishing the UCM service according to the UCM service type by configuring at least one function inside the D-User required for rendering the UCM service. The method may also comprise a step of informing a User Equipment (UE) of the user that the UCM service is established and that communication sessions related to the UCM service can be initiated.

The UCM service type may be associated with a UCM service blueprint which provides indications to the hosting network or to the D-User how to configure the at least one function. This one (or more) function may consist of existing function(s) inside the D-User. In some cases, it may be required to creates one or more new functions and their associated interfaces inside the D-User, to be able to render the UCM service. These new functions can be created and/or configuring according to instructions contained in the UCM blueprint of the UCM service.

In some implementations, the method may also require the creation of one or more new network functions and associated interfaces inside the hosting network but outside the D-User. For these new network functions also need to be configured, based on instructions provided by the UCM blueprint.

Depending on the situation, the request may be sent by the UE of the user (of by a UE associated with the user) or by the D-User. The request may be received by a control plane function of the hosting network, such as Network Access and Mobility Management Function, as will be described in more detail below.

The hosting network, via one specific function, may need to verify a subscription profile of the user or of the D-User to authorize the establishment of the UCM service. This UCM service may be stored or recorded as a service subscription in the subscription profile of the user or of the D-User in the hosting network, to enable the user or the D-User to obtain the UCM service from the hosting network.

In some implementation, the D-User is already instantiated and in used, and hosted in a hosting platform of the hosting network when the request for a new UCM service is received. In this case, at least some of the one or more new functions can be created by a hosting platform (HOP) function orchestrator. In other possible implementations, at least some of the one or more new functions can be created by the D-User. Establishing the UCM service can comprise the creation of one or more specific data path between the D-User and a User Equipment (UE) and/or a node external to the D-User, for rendering of the UCM service. This node external to the D-User can be a node that is part of the hosting network or that is provided or maintained by third parties.

As will be explained in more detail below, in some cases, the D-User is not yet created when a request for a new UCM service is received by a user, via a UE. In these cases, the method may further comprise a step of first instantiating the D-User in the hosting network, either at the time the request is received or prior to the request. Creating the D-User inside the hosting network can be performed as described previously, for example by creating a secure link between the User Equipment (UE) of the user and a D-User entity, so as to be able to provide the UCM service or a UCM service function of the UCM service. In some other cases, the request may be sent by the UE and may be received by the D-User directly, without first interfacing with a function of the hosting network. A secure communication link may already be existing between the UE and the D-User prior to establishing the UCM service. The D-User may already have access to available UCM services that can be offered and to their corresponding UCM blueprints. In some implementations, the request may be encrypted with a key created for the communications between the D-User and the UE, and the network may not be aware of the content of the messages used for sending the request. As explained previously, the D-User may be hosted in a Trusted Execution Environment (TEE) isolated from the hosting network.

In some implementations, in order to establish the UCM service, a UCM service identifier (ID) may be assigned to the UCM service so that the UCM service ID can be included in packets exchanged between the UE and the hosting network and/or the D-User, in communication sessions related to the UCM service. Once the functions have been created and configured, and the UCM service is ready be used, the User Equipment (UE) can be notified or informed that the UCM service is established by informing the UE of the data packet format to be used and of the software needed to operate the UCM service.

As will be explained in more detail below, providing UCM services by the hosting network may require, as a preliminary step, the preparation of the UCM service blueprints. This UCM service blueprint preparation may include: determining UCM service functions required within the hosting network for the UCM services; determining privacy requirements for the UCM service functions and associated data; and determining configuration requirements for already existing network functions. The UCM service blueprints may be stored in a UCM service blueprint storage made available by the hosting network to the D-User. The hosting network may inform UEs of available UCM services by broadcasting available UCM service types.

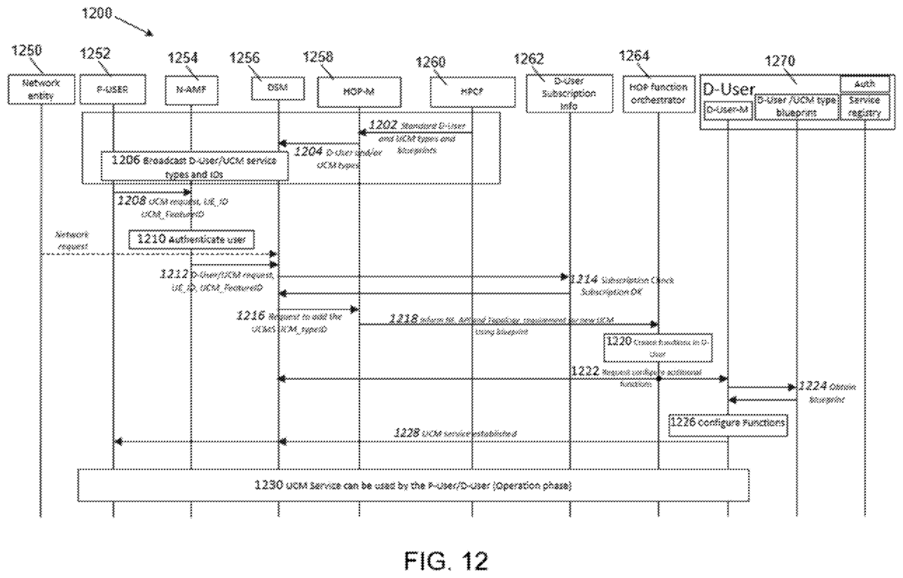

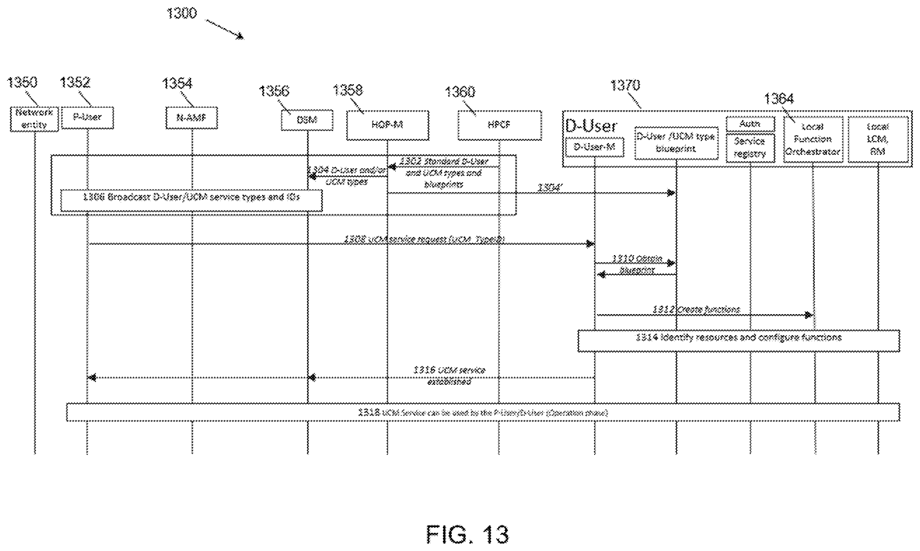

The method may thus require preparing blueprints for the User Controlled and Managed (UCM) services or associated D-User types. This preparation can be performed by a HOP Creation Function (HPCF) and the blueprints (for the UCM services and/or D-User) can be made available to network or D-User functions, such as the HOP Manager Function HOP-M and/or a Digital-User Service Manager DSM (1204), as in FIG. 12 described below, or to a DSM and/or the D-user, as in FIG. 13 further described below.

Examples of possible implementations are provided below.

### 6.52.1. Case 1

In a first case, the D-User is created using a TEE, and there may be at least two options to establish a UCM service: Network aware creation and network unaware (or agnostic) creation.

6.52.1.1. Case 1a: Network aware creation

In this case, the request for a UCM service needs to be allowed by the hosting network, which may be a Mobile Network Operator (MNO). A network function, which may correspond to a D-User Creation Function (DUCF) may be requested to create the UCM service (by the UE or D-User) and the DUCF may interact with the D-User-M for establishing the UCM service. Turning to FIG. 12, an exemplary detailed flow chart 1200 for network aware UCM service establishment is shown. The steps of the flow chart 1200 are described below.

At steps 1202, 1204 and 1206, the network entity 1250 may provide the available UCM service types or D-User types. For example, at step 1202, the HPCF 1260 may transmit D-User types and/or UCM types and their respective blueprints (UCM service blueprints) to the HOP-M 1258. Similarly, at step 1204, the HOP-M 1258 may transmit the D-User types and/or UCM types and blueprints to the D-User Service Manager (DSM) 1256. At step 1206, D-User and/or UCM types may be broadcasted to the Network Access and Mobility Management Function (N-AMF) 1254 and to the D-User. At step 1208, the UCM service establishment request may be transmitted from the UE, or physical user (P-User) 1252, to the Network function (N-AMF) 1254 with a UE identifier (ID) and a User Controlled and Managed (UCM) service identifier (ID), and an indication that it is to be forwarded to DSM 1256. At step 1210, the N-AMF 1254 may authenticate the user request, such as by using the UE ID, and may forward the request to the DSM 1256 at step 1212. At step 1214, the DSM 1256 may validate the subscription to the UCM service, and if the UE is not subscribed to the UCM service (identified with its UCM ID), the DSM may request, at step 1216, the HOP-M 1258 to add the UCM service to the D-User or User. At step 1218, the HOP-M 1258 may check the UCM blueprint for the new UCM service and may request the function orchestrator (HOP function orchestrator) 1264 to create new functions associated with the new UCM service. At step 1220, the HOP function orchestrator 1264 may create the new D-user functions and new hosting network functions, and can, at step 1222, request to configure the new and existing functions required for the UCM service. At step 1224, the D-User user blueprint of the new UCM service is fetched to obtain configuration details for configuring the new UCM service, and at step 1226, the functions are configured. For example, the D-User functions may be configured by the D-User-M provided inside the D-User 1270, the HOP functions may be configured by the HOP-M 1258, and functions outside may be configured by the MNO OAM. In some embodiments the new internal D-User functions may be created by the D-User at step 1226 in addition to the configuration. At step 1228, a confirmation that the UCM service is established may be transmitted to the P-User 1252 and/or the DSM 1256, for example. At step 1230, the UCM service is ready for the P-User 1252 or D-User 1270 to use.

In some embodiments, the new functions inside D-User 1270 may also be created by the D-User function orchestrator in Step 1220. In this case, the configuration request in step 1222 is sent by the D-User-M instead of the HOP-M.

In summary, the UE request may request a UCM service from the network, for example, via the N-AMF) for a given UCM service type. The request may also be performed by requesting a specific type of a D-User which can provide this UCM service type if there is no existing D-user. The hosting network function (DSM) verifies (1214) the subscription for the service, in cases where a subscription is required first. The DSM may send a request (1216) to the HOP-M (service manager) to create the UCM service, after checking network policies. The HOP-M may locate the matching blueprint for the UCM service type from the UCM blueprint storage and request the HOP function orchestrator to establish the service (1218). The HOP function creator may create the functions in the D-user (1220) and the required interfaces and may need to create a data path between the D-User and the UE and/or a node which is external to the D-User.

All of the steps described above may also be initiated from a request generated by the D-User. The HOP function creator may request the D-User M to configure the required functions (1222). The HOP function creator may also request the DSM to create new functions in the hosting network if needed and configure needed functions (1222). The D-user may search and locate the corresponding UCM blueprint (1224) and create the internal functions in the D-User and configure them (1226). The D-User may then inform the establishment of the UCM service to the DSM and also to the UE ((1228). The UE or/and D-user can then use the UCM service, by establishing associated communication sessions.

6.52.1.2. Case 1b: Network agnostic creation

In this case, when a UCM service needs to be added, it may be done such that the process is transparent to the hosting network, if that option is allowed. In other words, UCM services may be provided to a D-User without the hosting network being aware that the D-User is using this service. This option may be an additional facility provided for the D-User. In that case, the UE requests the service from the VU-M (D-User-M) with a message indicating the UCM service type, and the UCM service instantiates and configures the NFs and interfaces required. The D-User informs the hosting network (MNO) of the necessary protocols for enabling interactions between the hosting network (MNO) NFs and the D-User NFs and also traffic controlling procedures. Depending on the type of UCM services allowed in the D-User, the network may provide sufficient instructions to the D-User when the D-User is created.

FIG. 13 shows an exemplary flow chart 1300 for the establishment of UCM service without awareness of the hosting network. In this case, steps 1302, 1304 and 1306 are similar to steps 1202, 1204 and 1206 described above. The UCM service blueprints may be sent to the DSM (1304) or to the D-User (1304′). The same entities may be involved, such as the network entity 1350, the P-User 1352, the N-AMF 1354, the DSM 1356, the HOP-M 1358, the HPCF 1360, a local Function Orchestrator 1364, provided in the D-User 1370. However, not all these functions may be involved in providing a new UCM service to the D-User 1370. A difference with flow chart 1200 is that the P-User 1352 may directly contact its D-User 1370 at step 1308 and request the creation of the UCM service. The HPCF may provide the D-User blueprints of the UCM services in step 1302. The D-User 1370 can obtain D-User and/or UCM type blueprints, at step 1310, and can create the UCM services and functions, at step 1312, and configure the network functions, at step 1314. For this purpose, the hosting network may need to provide additional authority to the D-User 1370 to create and configure the functions. For certain services, the hosting network may need to carry out additional actions (e.g., special exposure) which may make it aware of the establishment of a new UCM service. Steps 1316 and 1318 are similar to steps 1228 and 1230, respectively.

In summary, with reference to FIG. 13, there may be a direct communication link between the UE and the D-User prior to using a UCM service. The D-user may have already obtained the possible UCM services it can provide and their UCM blueprints. The UE may request a UCM service from the D-User (1308) with a given UCM service type. The D-User may determine the blueprint associated with the UCM service type, by searching the blueprint storage. With the proper UCM service blueprint, the D-User may instruct a local function orchestrator to create new function(s) if required, according to the blueprint. The D-User can also configure the existing and the new functions (1314 and allocate resources. The D-User may also request the hosting network (DSM) to configure any required functions. The D-User can then inform the DSM and/or the UE (1228) of the UCM service establishment. UE or/and D-user can use the UCM service, by establishing associated communication sessions, using the UCM service identifier.

### 6.52.2. Case 2

In a second case, the D-User may be created by the hosting network (MNO) OAM. All the required NFs and interfaces may be established by the MNO, if the UCM service creation is done with the awareness of the MNO. If the UCM services are allowed to be established by the D-User-M, the D-User-M is provided with the authority to create the required functions and interfaces. For this purpose, the required AAA process may be established with the D-User prior to establishment of the UCM service as the request for the UCM service is directly received to the D-User-M and/or the D-User-M decides to create the UCM service by itself.

6.53. Starting a UCM service session

There may be different types of communications involving a D-User. Depending on which entity initiates the communications and the purpose for the communications, the message flow and what D-user has to do may be vary. Communication types can be categorized based on said message flow and the role of the D-User. After the creation of a D-User, but before the establishment of a UCM service, exemplary message types are described below.

6.53.1. Messages initiated by UE CPF to D-User CPF
6.53.1.1. AAA and Synchronization of user context initiated by UE:

Once a D-User is created, the hosting network may set up a sync channel between the D-User and the UE and the security keys may be transmitted so that the UE and the D-User can establish communication using their own security protocols (e.g., new key and new ID). Then the UE may inform the D-User of the type of user context to be transferred to the D-User and the frequency of data transfer, for example, and may send data to the D-User. The D-User may request separate data channels with specific QoS for that. If the amount of data to be transferred is small, the transfer may be done using a control plane channel.

Messages may be initiated by the UE DPF to the D-User UPF to initiate data sync by the UE. In some cases, the data transfer might be needed (updates on the environment etc.). Some of these channels may be temporary and invoked when there is a need. Some may be permanent or kept there as far as UCM service remain active. The message can also be initiated by the UE DPF to the D-User UPF to initiate a UCM service from the UE.

6.53.2. Messages initiated by the D-User CPF to UE CPF

Messages may be initiated by the D-User CPF to the UE CPF to initiate initial synchronization by the D-User or the AAA, to initiate the data sync by the D-User, to initiate a UCM service by the D-User, or to initiate a UCM service session. The messaging may depend on the type of UCM service, for example when processing a data packet received from the UE to a DN, in a specific way.

6.53.3. Synchronization of user context initiated by the UE

There may be several types of communications between a UE CPF and the D-User CPFs. Those may include:
Messages initiated by UE,
messages to initiate a UCM service session initiated by UE,
messages to initiate a UCM service session initiated by D-User, and
AAA and Synchronization of user context initiated by UE

Control messages between UE CPF and D-User CPF may be control messages from the UE to the D-User or from the D-User to the UE which can include messages to initiate a UCM service, AAA, or synchronization of user context, for example. For data synchronization or information sharing, control messages between the UE CPF and the D-User CPF may also be used, but it may be transmitted in the data plane by the UE UPF directly connecting to a D-User UPF under the control of CPF functions.

Messages from the UE UPF to the CN UPF may include the UE sending a data packet of a PDU session belonging to a UCM service. Depending on the UCM service, the packet may need to be processed differently by the network UPF. For example, the packet may be transmitted from the UE UPF to the CN UPF and to the DN when the packet has a D-User specified QoE field the network should try to meet. As another example, the packet may be transmitted from the UE UPF to the CN UPF and to the D-User UPF when the packet contains a specific field which indicates that it should be directed to a D-User UPF.

Messages from the D-User UPF to the CN UPF can be used when:
One type of data packets may be sent to a DN in the address field:
The packets received in the uplink from a UE (VIA a CN UPF) after sending to the D-User UPF for processing could be sent to the CN UPF to be sent to a DN.

The D-User has processed some data internally (stored data) may be sent to the DN via a CN UPF.

Another type of packets may be sent to the UE:
The packets received in the downlink from a DN after sending to the D-User UPF for processing could be sent to the CN UPF to be sent to the UE, or
The D-User has processed some data internally (stored data) may be sent to the UE via a CN UPF.

Messages from the CN UPF to the D-User UPF can be used when CN UPF receives a packet from the D-User to be sent to a DN.

Messages from the D-User to the CPF at AF can be used when the D-User starts a data session with the AF. Messages from the D-User CPF to the CN UPF may be required when the D-User requires to configure a hosting network function, for example, for controlling traffic or monitoring traffic. Messages from the D-User UPF to the AS (DN) may be needed for the D-User to send/obtain data from the application servers.

6.54. Additional considerations

In the present disclosure, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The memory may include any suitable type of non-transitory memory such as static random access memory (SRAM), dynamic random access memory (DRAM), synchronous DRAM (SDRAM), read-only memory (ROM), any combination of such, or the like. The mass storage element 602 may include any suitable type of non-transitory storage device, such as a solid state drive, a hard disk drive, a magnetic disk drive, an optical disk drive, a USB drive, or any computer program product configured to store data and machine executable program code. According to certain embodiments, the memory 604 or the mass storage 602 may have recorded thereon statements and instructions executable by the processor 601 for performing any of the aforementioned method operations described above.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Actions associated with the method described herein can be implemented as coded instructions in a computer program product. In other words, the computer program product is a computer-readable medium (a tangible, non-transitory computer readable medium or memory) upon which software code (instructions) is recorded to execute the method when the computer program product is loaded into memory and executed on the microprocessor of a wireless communication device, or a network device, or a user equipment device.

Further, each operation of the method may be executed on any suitable computing device, such as a personal computer, server, personal digital assistant, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a universal hardware platform. Based on such understandings, the technical solution of the present application may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. For example, although some embodiments of the disclosure provide for the D-User, instantiated inside the core network, the D-User may be instantiated inside RAN with similar functions in which case control plane and user plane functions used for the core network may be instantiated inside RAN with similar functionalities. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method for establishing User Controlled and Managed (UCM) services for a user using a digital representative of the user (D-User) inside a hosting network, the method comprising:
receiving a request for establishing a UCM service, the request comprising a UCM service type, the UCM service corresponding to a service provided by the hosting network using the D-User;
establishing the UCM service according to the UCM service type by configuring at least one function inside the D-User required for rendering the UCM service; and
informing a User Equipment (UE) of the user that the UCM service is established and that communication sessions related to the UCM service can be initiated.

2. The method of claim 1, wherein the D-User comprises at least one D-User function inside the D-User, the at least one D-User function comprising at least one of a control function or a data plane function, and wherein configuring the at least one function inside the D-User comprises configuring the at least one D-User function inside the D-User.

3. The method of claim 1, wherein the UCM service type is associated with a UCM service blueprint which indicates how to configure the at least one function.

4. The method of claim 3, further comprising:
creating one or more new functions and associated interfaces inside the D-User, the new functions being required to render the UCM service, and
configuring the one or more new functions according to the UCM service blueprint.

5. The method of claim 3, further comprising:
creating one or more new network functions and associated interfaces inside the hosting network outside the D-User, and
configuring the one or more new network functions according to the UCM service blueprint.

6. The method of claim 1, wherein the request is sent by the UE or by the D-User and is received by a control plane function of the hosting network.

7. The method of claim 6, wherein the hosting network verifies a subscription profile of the user or of the D-User to authorize the establishment of the UCM service.

8. The method of claim 7, comprising recording a UCM service subscription in the subscription profile of the user or of the D-User in the hosting network to enable the user or the D-User to obtain the UCM service from the hosting network.

9. The method of claim 4, wherein the D-User is hosted in a hosting platform (HOP) of the hosting network, at least some of the one or more new functions being created by a HOP function orchestrator.

10. The method of claim 4, wherein the D-User is hosted in a hosting platform (HOP) of the hosting network, at least some of the one or more new functions being created by the D-User.

11. The method of claim 1, further comprising instantiating the D-User in the hosting network, either when receiving the request or prior to receiving the request.

12. The method of claim 1, wherein the request is sent by the UE and is received by the D-User, a secure communication link already existing between the UE and the D-User prior to establishing the UCM service, the D-User already having access to UCM services that can be offered and corresponding UCM service blueprints.

13. The method of claim 11, wherein the D-User is hosted in a Trusted Execution Environment (TEE) isolated from the hosting network.

14. The method of claim 3, wherein the at least one function comprises an existing function inside the D-User, the method further comprising:
creating one or more new functions required for the UCM service and associated interfaces inside the D-User; and
configuring the one or more new functions according to the UCM service blueprint.

15. The method of claim 1, further comprising assigning a UCM service identifier (ID) to the UCM service so that the UCM service ID is comprised in packets exchanged between the UE and at least one of the hosting network or the D-User in communication sessions related to the UCM service.

16. The method of claim 1, wherein informing the UE that the UCM service is established comprises informing the UE of a data packet format to be used and software needed to operate the UCM service.

17. The method of claim 3, comprising preparing, by the hosting network, the UCM service blueprint, said preparing being performed prior to receiving the request and including:
determining UCM service functions required within the hosting network for the UCM services;
determining privacy requirements for the UCM service functions and associated data; and
determining configuration requirements for already existing network functions.

18. The method of claim 1, wherein the UCM services comprise at least one of:
home network, equipment, health and alarm control;
authentication of users for allowing service access;
authorization for using personal data;
privacy-preserving payment exchanges with 3^{rd} parties;
a capability to dynamically obtain special network features according to dynamic needs;
a capability to define special services;
UE traffic routing control within network user plane functions (UPFs);
service quality map acquisition;
advertisement and spam blocking;
Transmission Control Protocol (TCP) acceleration using a proxy;
local data caching and pre-fetching;
privacy-oriented source address and identification modification;
content or data sharing;
user traffic processing;
support for user equipment artificial intelligence (AI) applications;
providing network resources and services acquisition;
D-User AI services for providing interactions with UE;
networking AI services;
service acquisition from neighbouring UE; or
network support for Anything-as-a-Service (XaaS) services.

19. A non-transitory computer-readable storage medium having recorded thereon instructions that, when executed by one or more processors, cause the one or more processors to:
receive a request for establishing a User Controlled and Managed (UCM) service, the request comprising a UCM service type, the UCM service corresponding to a service provided by a hosting network using a digital representative of a user (D-User) inside the hosting network;
establish the UCM service according to the UCM service type by configuring at least one function inside the D-User required for rendering the UCM service; and
inform a User Equipment (UE) of the user that the UCM service is established and that communication sessions related to the UCM service can be initiated.

20. A system for establishing user controlled and managed (UCM) services for a user using a digital representative of the user (D-User) inside a hosting network, the system comprising:
one or more processors; and
at least one tangible, non-transitory memory storing instructions that, when executed by the one or more processors, cause the system to:
receive a request for establishing a UCM service, the request comprising a UCM service type, the UCM service corresponding to a service provided by the hosting network using the D-User;
establish the UCM service according to the UCM service type by configuring at least one function inside the D-User required for rendering the UCM service; and
inform a User Equipment (UE) of the user that the UCM service is established and that communication sessions related to the UCM service can be initiated.
